(19) United States
(12) Patent Application Publication
(10) Pub. No.: US 2025/0313329 A1
(43) Pub. Date: Oct. 9, 2025

(54) MACHINE AND APPARATUS FOR ULTRA-SHORT TAKE OFF AND LANDING FIXED WING AIRCRAFT

(71) Applicant: Sherpa Aircraft Group Inc., Shady Shores, TX (US)

(72) Inventors: Gary W. Robinson, Clackamas, OR (US); Wesley A. Gordon, Portland, OR (US); Dennis J. Haimerl, Loma, CO (US)

(73) Assignee: Sherpa Aircraft Group Inc., Shady Shores, TX (US)

(21) Appl. No.: 18/986,361

(22) Filed: Dec. 18, 2024

Related U.S. Application Data
(60) Provisional application No. 63/611,748, filed on Dec. 18, 2023.

(30) Foreign Application Priority Data
Dec. 11, 2024 (WO) PCT/US2024/59436

(51) Int. Cl. B64C 9/10; B64C 9/00; B64C 9/02; B64C 9/08

(52) U.S. Cl. CPC B64C 9/10; B64C 9/02; B64C 9/08; B64C 2009/005

(57) ABSTRACT

The present invention provides an extreme STOL airplane comprising: a fuselage and a wing having port and starboard wing sections. Each wing section has a body with top and bottom surfaces, leading and trailing edges, and a span, i.e., the distance between a wing section tip and root connected to the fuselage, and flap coves. Aerodynamic elements integrated into the wing sections include Fowler flaps, having leading and trailing edges and a span, flap tracks, wherein the flap tracks are external to the wing section body, extend aftward beyond the trailing edge of the wing section, and are configured to enable the Fowler flaps to rotate or deflect and to translate or extend and retract, Frise ailerons, wherein the Frise ailerons are located outboard of the Fowler flaps, and spoilerons located over the leading edge of the Fowler flaps when the flaps are in the fully extended position.

### CROSS REFERENCE TO RELATED APPLICATION

This application claims the benefit of, and priority to, U.S. Provisional Application Ser. No. 63/611,748, filed on Dec. 18, 2023, and PCT Patent Application PCT/US2024/59436, filed on Dec. 11, 2024, the disclosures of which are hereby incorporated herein by reference in its entirety and for all purposes.

### BACKGROUND OF THE INVENTION

### Field of the Invention

The embodiments of the present invention described herein generally relate to short takeoff and landing (STOL) fixed-wing aircraft having optimized flight parameters and characteristics, and more particularly to optimization of the four forces exploited and at work in generating flight, i.e., lift, weight, thrust, and drag, especially to enable takeoff and landing on short and unimproved runways.

### Description of Related Art

Sir John Cayley, an English engineer who first identified the four forces of flight, including lift 101, drag 102, thrust 103 and weight 104 (see FIG. 1 [Four Forces]), developed the first cambered airfoil section through detailed empirical research and experimentation. His three-part work, On Aerial Navigation, which published in 1809 and 1810, is often cited as the first description of what we today call an airplane.

The total drag of an airplane wing consists of two components, parasitic drag and induced drag. Parasitic drag (also known as profile drag) is produced by frictional resistance between a fluid and a surface moving through the fluid. Induced drag is the resulting drag from the production of lift, most notably by the wing. Convention is that the wing extends from tip to tip, e.g., a biplane has two wings. When referencing from the airplane centerline to a wing tip it is generally referred to as the “wing half”, and when referencing a portion of a wing half it is typically called a “wing panel”.

“Airfoil” is a relatively generic term, while “Airfoil section” is the more technically correct term when referencing 2-dimensional surface elements. “Wing section” is typically used when referencing the airfoil section of a wing. “Wing” is typically used when referencing the 3-dimensional object and “wing surface” when referencing the exterior boundary of the wing. As commonly understood, the wing section, or the airfoil section of the wing, is the primary lift generating element of the wing.

Generating aerodynamic lift is a complicated, active process that depends on a handful of physical laws regarding pressure and force. On a strictly mathematical level, engineers know how to design airplanes that will stay aloft. But their equations don't explain why aerodynamic lift occurs.

Two primary competing and/or complementary theories exist that elucidate the forces and factors of lift. Unfortunately, both are incomplete explanations and neither cures the deficiencies and defects of the other. Contemporary aerodynamics teaches, in “shorthand”, that the theories of Sir Isaac Newton (1642-1726) and Swiss mathematician Daniel Bernoulli (1700-1782) provide the detailed science that explains lift—and yet they do not, at least not fully.

While those laws are well understood, the basic problem is that neither theory completely explains real-world observations. Their application can leave us with gaps in our understanding that are difficult to fill without embracing the interactions they define, which are themselves dependent on those same physical laws. Aerodynamicists have recently tried to close these gaps in understanding, yet there remains no consensus.

The Bernoulli principle, depicted in FIG. 2 [Bernoulli], stipulates that the faster moving airflow on the top surface 107 of a cambered or curved wing experiences reduced/lowered pressure compared to the slower moving air flow beneath the wing 108, is correct but it fails to explain why it is correct and it also fails to explain inverted flight.

That's where Newton's second and third laws FIG. 3 [Newton Momentum] come into play and together describe how fixed wing aircraft can fly inverted and how angle of attack works. An airflow moving past a surface 112 oriented at some angle of attack will deflect downward 113, resulting in a force 114 pushing upwards against the surface. FIG. 4 [Angle of Attack] depicts angle of attack 118 being the angle measured between the relative wind 119 direction and the airfoil section reference line 120 of an airfoil section 121.

However, Newton's laws fail to include the necessary details from Bernoulli, as well as other factors. Even so, by simply taking into account Newton, Bernoulli, and Cayley, a working idea or model of how to build and fly an airplane is achieved. Nevertheless, merely combining the work of these three great scientists still fails to explain exactly why the air flow on the top side of the wing produces lower pressure than the air underneath it, only that it does.

The pressure difference, i.e., the lower pressure above the wing compared to the normal (and higher) air pressure below the wing, enables the higher pressure under the wing to push upward and contribute to the total lift produced by the wing. This lift, however, is only part of the lift that the wing experiences. At least part of the remaining lift produced by the wing is due to the vertical component of the momentum transferred to the wing by the air flow colliding with the bottom surface of the wing.

Various aircraft designs have attempted to maximize and/or optimize the amount of lift 101 produced by the shape of an airfoil section 121 by exploiting natural physical phenomena, including the well-known Bernouli principle and also the lesser known Coanda (“Coanda”) effect FIG. 5 [Coanda Effect], i.e., the tendency of a fluid 123 stream to follow an adjacent flat or curved surface 124 and to entrain fluid 123 from the surrounding areas so that a region of lower pressure develops until the flow can no longer remain attached and separation occurs 125.

Coanda dictates that the existence of an increasing velocity gradient present in the shear flow at the boundary layer at the top surface of the wing blows air particles away from that surface, thereby lowering the pressure there. Coanda seems to fill in some of the gaps and provide at least a partial explanation regarding why lower pressures are observed in faster air flows, as first identified by Bernoulli.

The Bernoulli principle and the Coanda effect are both explanations that help us understand how airplanes fly. As an airplane moves quickly through the air, generating a stream of air over and around the wings, the pressure near the top surface of the wing changes, i.e., decreases (Bernoulli's Principle), and the fast-moving air adheres or sticks to the wing convex curved surfaces (Coanda Effect), each making respective contributions to keep the plane in the air.

The Coanda effect has applications in various high-lift devices on aircraft, where air moving over the wing can be “bent down” towards the ground using flaps and an air sheet blowing over the convex curved top surface of the wing. In many of these designs, air moving over the wing is “bent down” towards the ground using flaps the air, i.e., a gaseous fluid, flowing over the curved surface of the wing (and downward bending flap) increases the amount of lift produced. In accordance with Newton, the downwards bending of this air flow via the Coanda effect results in further contribution to aerodynamic lift, additional to the Bernoulli pressure differential.

One thing to keep in mind when considering flight, in accordance with Newton, is that a typical horizontal tail, having a forward portion comprising a horizontal stabilizer and an aft portion comprising an elevator, is a symmetrical airfoil section mounted at an angle that produces a negative lift, i.e., a downforce or force directed downward and opposite to the wings, as a counterbalance to generate stability, in most flight conditions. The amount and direction of the counterbalance force will vary depending upon speed, configuration of the wing, and other factors. The aft surface of the horizontal tail (an elevator) is typically hinged to allow variations in camber.

Consequently, lift clearly works in multiple directions. And, aside from aviation, “inverted wings” are frequently used in Formula One (Formula 1 or F1) and other auto racing sports. For inverted wings the underside of the wing section is cambered and consequently forces the air flow traveling beneath the inverted wing to travel a greater distance in relatively the same or less time as the air flow traveling above the wing, thereby producing a downforce opposite to conventional lift produced by an aircraft wing, but subject to the same rules.

Coanda also applies to inverted flight and horizontal stabilizers, where the cambered, convex curved surface operates at the underside of the airfoil section and bends the air flow upwards. Consequently, the Coanda effect has important applications in various high-lift and high downforce devices on aircraft and on the racing car “wings”, or rather wing sections, where air moving over the wing can be adhered and “bent” over the curved surface of the wing section using flaps. The bending of the flow results in its acceleration and, in accordance with the Bernoulli principle, pressure is decreased, and aerodynamic lift or downforce is correspondingly increased.

Since all applications of a Coanda effect involve a fluid object flowing over a solid one, the science behind this effect is known as fluid dynamics. By way of illustration, a short sidebar into the world, physics and computational fluid dynamics (CFD) of Formula 1 car racing will prove worthwhile and valuable.

The following review of Mercedes 2022 Formula 1 CFD derived aerodynamic designs will illustrate how important insights developed and gained in F1 auto racing can be applied for the purposes of improving perspective and understanding for aviation and fixed wing aircraft applications. The Mercedes 2022 F1 car is a prime example of how the well-developed discipline of CFD remains incomplete and insufficient and helps to demonstrate how the field of aerodynamics is still a long way from being fully understood.

Mercedes-AMG Petronas had won eight consecutive Formula One World Championships through 2021. They previously spent about $400 to $500 million per year on the design of their cars and utilizing around 900 employees. The International Automobile Federation (FIA) introduced a new set of rules for the 2022 F1 racing season that required a complete redesign of the cars and a budget cap around $150 million for the design processes.

Due to FIA rules limiting wind tunnel and on track testing, Finite Element Modeling (FEM), which helps determine the stiffness of structures, and Computational Fluid Dynamic (CFD), which helps determine aerodynamic characteristics, are heavily relied upon while designing these cars. Even with the use of FEM and CFD it is important to demonstrate correlation between the models and reality as there are many ways model can be built that do not accurately represent the real world.

The 2022 racing season quickly revealed that despite all of the high-tech tools at their disposal, the Mercedes W13 chassis had major issues. Due to the money involved in F1 racing, teams are rather secretive about their designs making it challenging to know exactly what issues they were facing.

It was general knowledge among the Paddock (the F1 working area behind the pits) that the Mercedes cars were suffering from violent porpoising, i.e., the motion experienced by F1 cars when their under-floor aero stalls and the car is pushed away from the ground. Like a dolphin or porpoise moving through the water, up and down along the length of their body, so too do the Formula 1 cars.

Because F1 cars use their floor as a source of downforce, the car is pulled down. In addition, higher pressure generated above the chassis, pushes the car down and also contributes to downforce and improved traction.

FIG. 6 [Ground Effect Car] depicts venturi ducts 129 formed in the underside of an F1 car changing the airflow 112 underneath by creating a low-pressure area and increasing the air speed, which means more downforce 130 and a greater capability for high-speed driving around turns and corners due to the greater vertical load on and increased lateral friction experienced by the tires 131. And the faster the car, the more downforce it then creates.

Porpoising occurs when the suction pulls the car so close to the ground that the under-floor aero stalls. When that happens, the car raises away from the ground and, as it gets higher, the aero kicks back in, again pulling the car towards the ground. As the action and reaction continues, the car goes up and down in a porpoising motion.

Mercedes team lead, Toto Wolff, stated that his engineers were having a huge issue with drag in addition to the porpoising. Toto also stated that they were unable to point out which part of the design needs to be looked at as a priority to increase the car's performance. The general consensus is that elasticity of the underpan combined with the unique sidepod design may have caused erratic airflow beneath the car.

In airplanes there is a similar mechanism that can cause control surface “buzz” or even catastrophic flutter. From comments made by various team principals and the lack of Mercedes progress in correcting this issue, it was apparent that they weren't entirely sure of what specifically was causing it.

Mercedes has a significant amount of relevant data from previous years, and yet they could not find correlation between their design and reality. And due to the secretive nature of this sport, even if Mercedes figures out what went wrong, the general public will likely never know what caused the issues that kept the W13 chassis from competing well against the other elite teams.

Even when using the most sophisticated theories and software tools available, engineers are not always able to predict what will happen in nature. Aerodynamics can often be a fickle subject, and it is possible and maybe probable that the engineers will never fully understand what went wrong.

This is why commercial and military airplanes are required to undergo large amounts of flight testing. Even companies like Boeing, Airbus, and Lockheed frequently experience aerodynamics issues that are not expected or even anticipated as possibilities. Consequently, scientists and engineers continue to seek improvements in all areas of aircraft performance.

Recent military campaigns, for example, have demonstrated an increased need for improved short takeoff and landing (STOL) performance to allow aircraft to operate in environments where modern airports and other landing facilities may not be available. Therefore, it is desirable to create aircraft able to takeoff and land even on short and unimproved runways with even better STOL performance than current designs.

STOL technology for fixed wing aircraft is well known in the art, and there are numerous examples in general literature and in patent literature. The length of runway for such aircraft to take off and land varies among different designs and models of aircraft, and the technology enabling STOL also varies.

There are various reasons for providing aircraft capable of STOL, such as reduced cost for runway building and maintenance. In military applications STOL aircraft can use very short runways that are relatively easy to build and maintain in forward positions and in combat situations.

Helicopters have long been available to land and take off from reduced areas, such as helipads on rooftops, but helicopters have corresponding disadvantages of being significantly slower in horizontal flight as well as being much more expensive and dangerous to operate, with a significantly higher mortality rate than fixed wing aircraft.

STOL performance, with respect to general aviation, is typically defined as the ability of an aircraft to clear a 50-foot (15 meters) obstacle within 1,500 feet (450 meters) of commencing the takeoff. STOL aircraft must also be able to come to a complete stop within 1,500 feet (450 meters) after passing over a 50-foot (15 meters) obstacle in conducting a landing operation. One way to improve STOL performance is to increase the amount of lift produced by the aircraft.

For example, by increasing the lift capability of the wing, the aircraft can become airborne at a lower airspeed, thereby reducing the length of runway needed for takeoff. Aircraft that have successfully exploited the Coanda Effect for STOL purposes include the Boeing YC-14 and C-17 Globemaster III, as well as various types of unmanned aerial vehicles (UAVs) and the like.

Nevertheless, there remains a desire for aircraft designs with even better STOL performance. And yet, due to the uncertain nature of aerodynamic design, outcomes in line with objectives cannot be assured and the challenge at hand is not simply a problem of engineering a straightforward solution, as demonstrated by the experience of the Mercedes F1 team.

### SUMMARY OF THE INVENTION

The following summary of the present invention is presented to provide a basic understanding of some aspects of the invention and to facilitate an understanding of some of the innovative features unique to the disclosed embodiment, and it is not intended to be a full description. This summary is not intended to identify all key or critical elements of the invention or to delineate the entire scope of the invention.

The sole purpose of this summary is to present some concepts of the invention in a simplified form as a prelude to the more detailed description presented below. A full appreciation of the various aspects of the embodiments disclosed herein can be gained by taking the entire specification, claims, drawings, and abstract as a whole.

It is, therefore, one aspect of the disclosed embodiments of the present invention to provide an airplane comprising: a fuselage having a body, a nose and a tail, a wing comprising port and starboard wing sections, wherein each wing section further comprises a structure integrating aerodynamic elements. Such structure and aerodynamic elements include without limitation a wing section body, having a top surface and a bottom surface, a leading edge and a trailing edge, and a wing section span, or a distance between a wing section tip and a wing section root connected to the fuselage body, and flap coves.

Aerodynamic elements integrated into the wing further include Fowler flaps, having a leading edge and a trailing edge, as well as a span and an effective span, flap tracks, wherein the flap tracks are external to the wing section body and extend aftward beyond the trailing edge of the wing section, and wherein the flap tracks are configured to enable the Fowler flaps to rotate and deflect at an angle inclined compared to the top surface of the wing section body and to translate, or extend aftward out of the flap coves towards the tail and retract forward into the flap coves towards the nose, and wherein a flap gap or slot between the Fowler flap and the flap cove remains constant from an inboard end of a spoileron to an inboard end of the Fowler flap throughout all deployed positions.

Additional aerodynamic elements integrated into the wing further include Frise ailerons, each having an aileron hinge, a leading edge and a trailing edge, a span, and a mass balance, wherein the Frise ailerons are located outboard of the Fowler flaps, and also spoilerons, each having a leading edge and a trailing edge, and a span, wherein the spoilerons are located over the leading edge of the Fowler flaps when the flaps are in the fully extended position.

The present invention further comprises an airplane, wherein a fully retracted position of the Fowler flap puts the Fowler flap into a reflexed position, inclined with a negative angle of deflection compared to the top surface of the wing section body; and wherein the negative angle of deflection for the fully retracted Fowler flap is between minus (−) 1 degree to minus (−) 15 degrees, plus or minus (+ or −) 1 degree, and wherein the negative angle of deflection for the fully retracted Fowler flap is between minus (−) 1 degree to minus (−) 10 degrees, plus or minus (+ or −) 1 degree.

The present invention further comprises an airplane wherein the Frise aileron has a nose overhang ratio, i.e., a distance between the aileron leading edge and the aileron hinge compared to a distance between the aileron leading edge and aileron trailing edge, of at least 21%; and wherein the nose overhang ratio is at least 31%.

The present invention further comprises an airplane configured to be capable of executing precision landings and to touch down, within 5 to 15 feet of a target point, and come to a complete stop over not more than 110 to 150 feet of airstrip or runway, when flown at an airplane operating empty weight; and wherein such a precision landing includes the capability of touching down within 10 feet of a target point, over not more than 110 feet of airstrip or runway, when flown at the airplane operating empty weight.

The present invention further comprises an airplane having a cruise speed to lowest stall speed ratio of equal to or more than 6.0. The present invention further comprises an airplane wherein the tail is equipped with a variable incidence horizontal stabilizer that pivots just forward of an elevator hinge line allowing a leading edge of the elevator to move up and down by the actuation of a jackscrew.

The present invention comprises an airplane configured to experience an increase in angle of attack for a wing stall with flaps fully extended as compared to wing stalls with flaps fully retracted; and wherein the airplane is further configured to experience wing stall at a wing angle of attack of 17 degrees, plus or minus one degree (1°), with the Fowler flaps fully retracted, and wherein the airplane is further configured to experience wing stall at a wing angle of attack 19 degrees, plus or minus one degree (1°), with the fowler flaps fully extended.

The present invention further comprises an airplane wherein the effective span of the Fowler flap is at least 70% of the wing section span.

These and other aspects of the present invention are realized as shown and described in the following FIGs. and related description. Additional features and advantages of the invention will be set forth in the detailed description which follows, taken in conjunction with the accompanying drawings, which together illustrate by way of example, the features of the invention.

Other objects, advantages and new features of the invention will become apparent from the following detailed description of the invention when considered in conjunction with the accompanied drawings.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. The figures are provided for purposes of illustration only and merely depict typical or example embodiments. These drawings are provided to facilitate the reader's understanding and shall not be considered limiting of the breadth, scope, or applicability various embodiments.

Non-limiting and non-exhaustive features will be described with reference to the following figures, wherein like reference numerals within the detailed description refer to like parts throughout the various figures. The figures described below were not intended to be drawn to any precise scale with respect to size, angular relationship, or relative position. Various embodiments of the present invention are shown and described in reference to the numbered drawings wherein:

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

Various embodiments will hereinafter be described in conjunction with the following drawing figures, wherein like numerals denote like elements.

FIG. 1 [Four Forces] depicts the four forces acting on an airplane during flight; lift, weight, thrust, and drag.

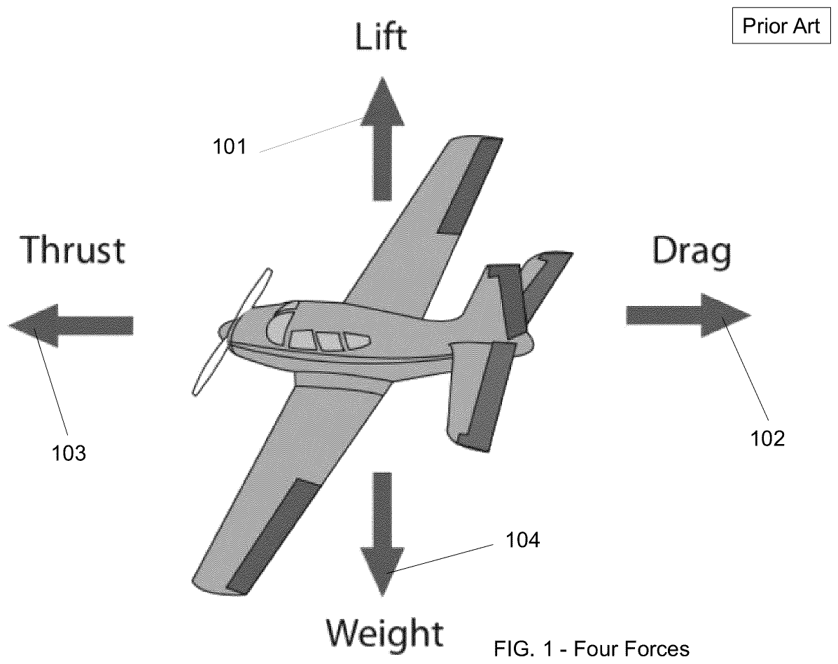

FIG. 2 [Bernoulli] depicts the air movement around a chambered airfoil section. The air moving beneath the section moves slower creating higher pressure, while the air moving above the section moves faster due to the longer transit distance and produces lower pressure.

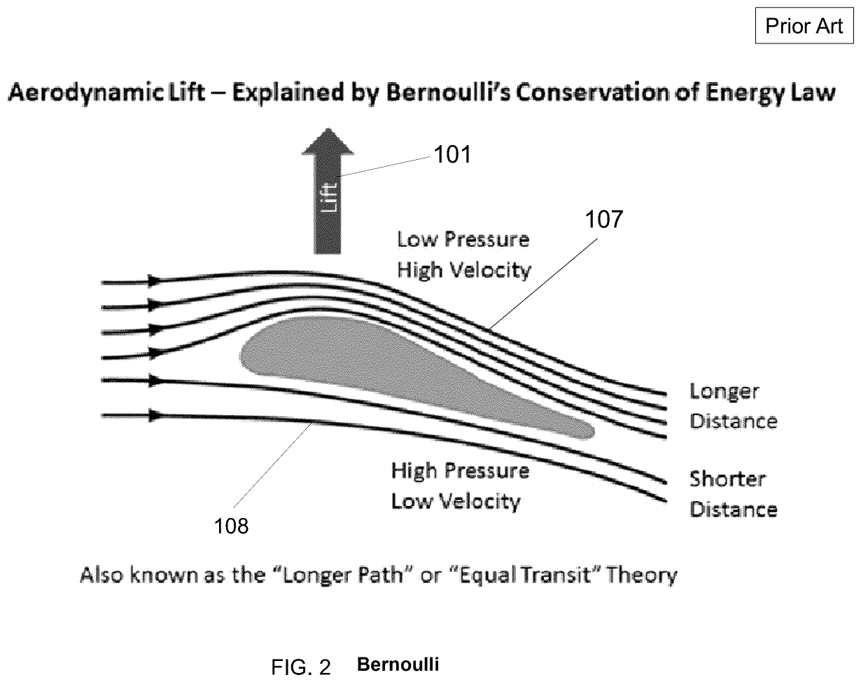

FIG. 3 [Newton Momentum] depicts the downward deflection of air moving past a surface at some angle of attack resulting in a force pushing the surface upward.

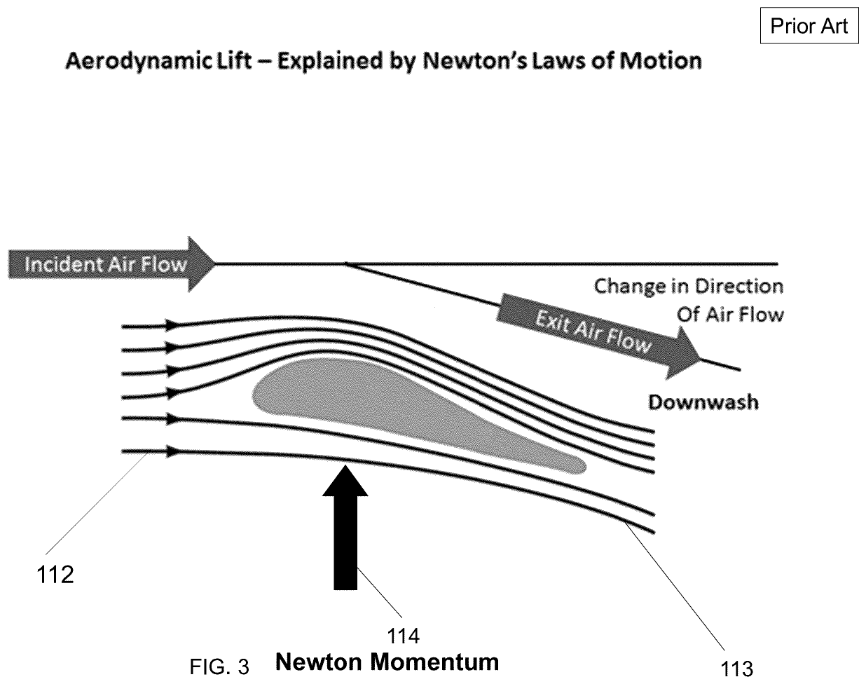

FIG. 4 [Angle of Attack] depicts the angle between the oncoming airflow (relative wind) and a chosen reference line usually extending from the leading edge of and airfoil section, or wing, to the trailing edge of the section.

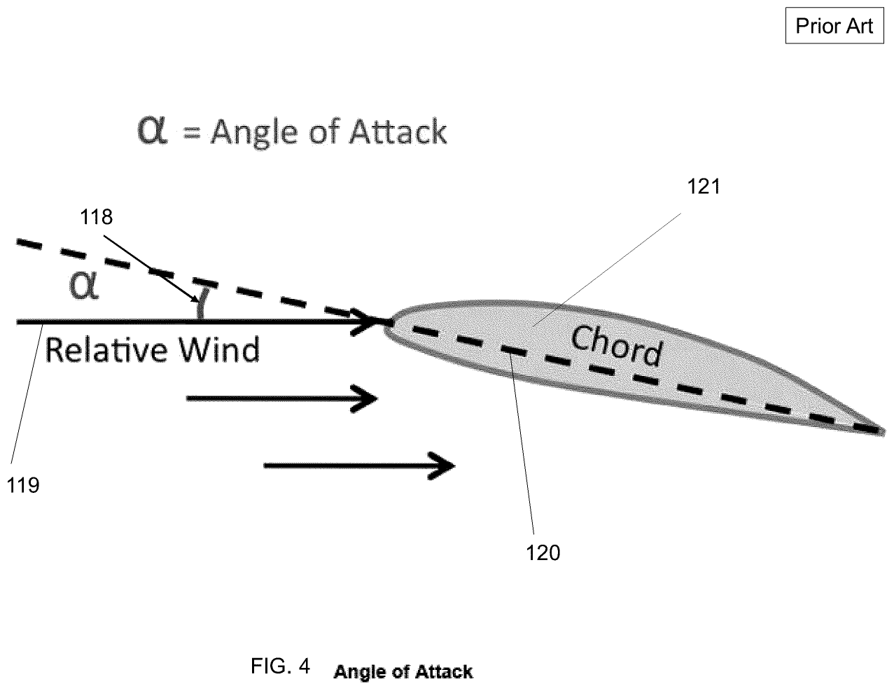

FIG. 5 [Coanda Effect] depicts the tendency of a fluid stream to follow the curved surface along the top of an airfoil section until the angle between the airflow and the section become too great (know as the stall angle) and the flow begins to separate from that surface.

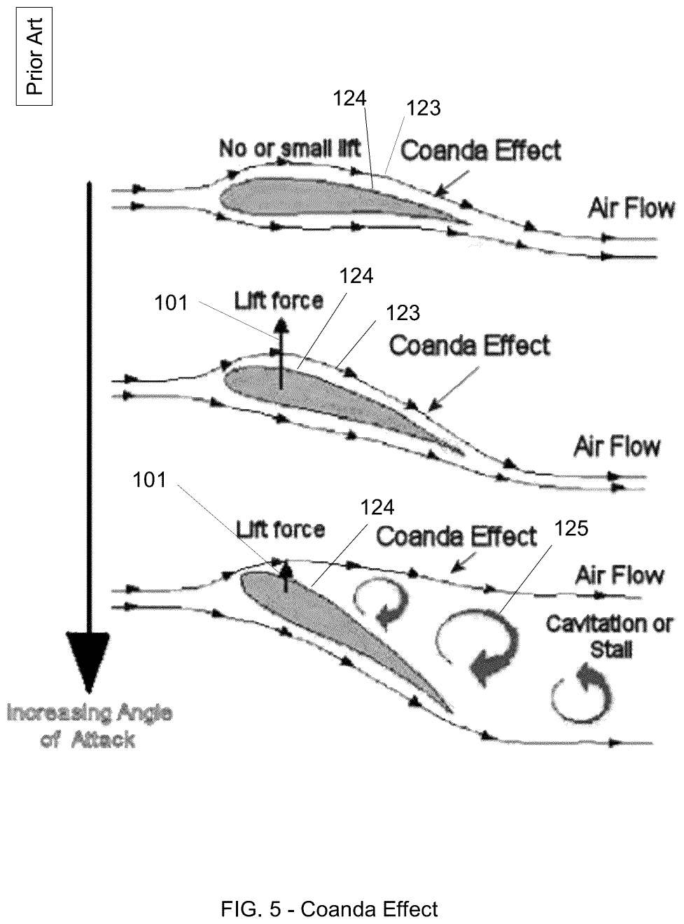

FIG. 6 [Ground Effect Car] depicts the underside of a race car being shaped like and inverted wing causing airflow to suck, or push, the car towards the ground.

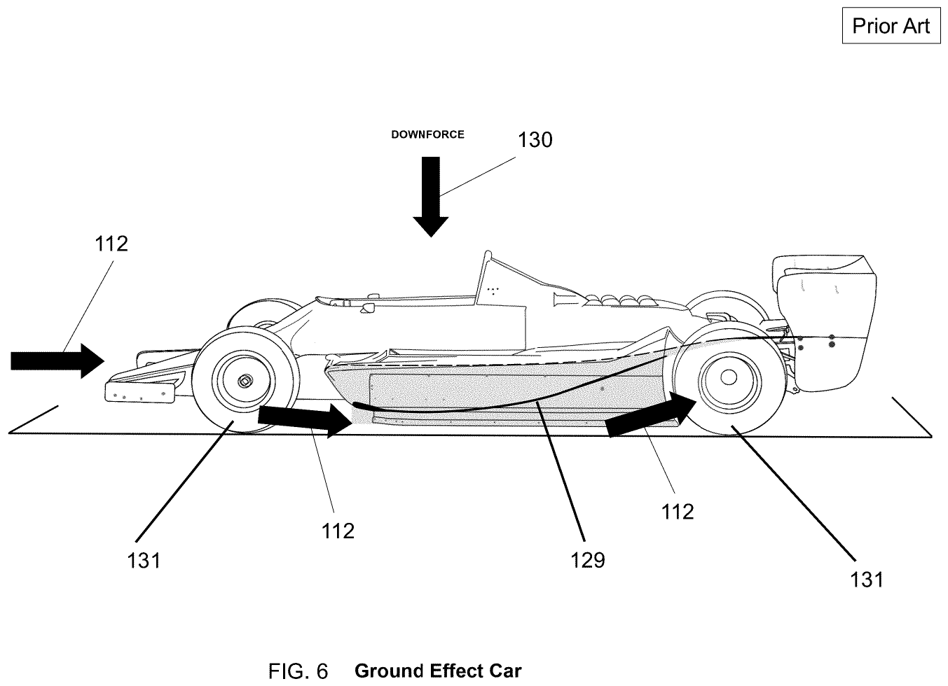

FIG. 7 [K-400 Profile View] depicts a profile drawing of the Sherpa Model K-400.

FIG. 8 [K-400 Top View] depicts a top view of the Sherpa Model K-400.

FIG. 9 [K-650T Profile View] depicts a profile drawing of the Sherpa Model K-650T.

FIG. 10 [K-650T Top View] depicts a top view of the Sherpa Model K-650T.

FIG. 11 [Power Curve] depicts a graph of the power required with respect to airspeed of a typical airplane.

FIG. 12 [AOA Stall Point] depicts the maximum lift coefficient occurring at the stall AOA in a graph referred to as a lift curve, or CL vs Alpha curve.

FIG. 13 [Wing Stall] depicts how increasing angle of attack will lead to the stalling of a wing section once the AOA becomes excessive and the airflow can no longer remain attached to the upper surface.

FIG. 14 [TE Flap Types] depicts four types of trailing edge flaps commonly used on light airplanes; split flap, plain flap, single slotted flap, and the Fowler flap.

FIG. 15 [LE Flap n Slat] depicts typical geometry of both a leading edge flap and a leading edge slat.

FIG. 16 [Flap Deflection vs CL] depicts how the lift coefficient and angle of attack is affected by the defection of a plain trailing edge flap.

FIG. 17 [Drag Polar] depicts the variation in drag coefficient with respect to the lift coefficient for airfoil sections with and without flap deployment.

FIG. 18 [Effects of Flaps on Lift Curve] depicts the increased in lift and variations in angle of attack when various types of flaps are deployed on a basic cambered airfoil section.

FIG. 19 [NASA MS(1)-0317 Airfoil] depicts a standard NASA MS(1)-0317 airfoil section associated with the Sherpa Model K-650T.

FIG. 20 [Modified NASA MS(1)-0317 Airfoil] depicts the modified NASA MS(1)-0317 airfoil section used on the Sherpa K-650T.

FIG. 21 [Cl_diag NASA MS Airfoil for K-650T] depicts the estimated maximum lift coefficient with respect to angle of attack in 3-dimensional flow for the K-650T wing geometry using a modified NASA MS(1)-0317 airfoil section.

FIG. 22 [Vortex Generators] depict how the presence of VGs attached to the upper forward portion of an airfoil shaped object mix high energy air from outside the boundary layer with boundary layer air to delay boundary layer separation.

FIG. 23 [Boundary Layer Control] depicts how applying suction to or blowing across the upper surface of an airfoil section can be used to delay boundary layer separation.

FIG. 24 [NACA 43015 Airfoil] depicts the a standard NACA 43015 airfoil section associated with the Sherpa Model K-400.

FIG. 25 [Modified NACA 43015 Airfoil n w_Cuff] depicts the modification applied to the original NACA 43015 airfoil section used on the K-400 and includes the addition of the leading edge cuff that was also used.

FIG. 26 [Cl_diag NACA Airfoil for K-400] depicts the estimated maximum lift coefficient with respect to angle of attack for 3-dimensional flow for the K-400 wing geometry using a modified NACA 43015 airfoil section.

FIG. 27 [NACA 43015 vs Modified Airfoil & Cuff] depicts the modifications made to the NACA 43015 airfoil section used on the Sherpa K-400 including the addition of a leading edge cuff.

FIG. 28 [Fixed Horz Stabilizer] depicts a typical horizontal tail utilizing a fixed horizontal stabilizer, elevator, and trim tab.

FIG. 29 [Elevator Deflection] depicts how the deflection of a trim tab affects the floating angle of an elevator when no force is being applied to the pitch control system.

FIG. 30 [Stabilator] depicts the rotation of a stabilator about a pivot axis and the deflection of an anti servo tab that causes the force required to deflect the elevator to increase providing feedback (“feel”) to the pilot.

FIG. 31 [Airflow Around a Wing] depicts the upward moving airflow (upwash) in front of a wing leading edge and downward moving airflow (downwash) behind the trailing edge of a wing that is producing lift.

FIG. 32 [Downwash Angle] depicts the angle of airflow behind the wing, referred to as the down wash angle, at low and high angles of attack with flaps extended and retracted.

FIG. 33 [H-Tail w_Jackscrew] depicts the ability of a jack screw to adjust the horizontal stabilizer for nose up and nose down trim with respect to the front of the airplane, and for cruise condition (low drag).

FIG. 34 [Elevator Boost Tab] depicts how the deflection of a linked (boost) tab affects the force required to move the elevator upward and downward.

FIG. 35 [Aileron_Spoileron Deployment] depicts a typical high wing light airplane with wing flaps extended and the differential deflection of the ailerons in combination with the deployment of only one spoileron causing the airplane to roll about its longitudinal axis.

FIG. 36 [K-400 vs K-650T Aileron] depicts a comparison of the Frise type ailerons used on the K-400 and K-650T with the ailerons in the neutral position as well as in the upward and downward deflected positions.

FIG. 37 [Mass Balance] depicts a weight (mass balance) placed at the leading edge of the aileron typically made of lead to prevent the onset of a catastrophic event referred to as aerodynamic flutter.

FIG. 38 [Nose Flap Chord Max Lift Effectiveness] depicts a graph presented in the USAF DATCOM showing how the lift effectiveness on a leading edge flap is affected by the flap chord ratio.

FIG. 39 [NASA MS(1)-0317 Original vs Modified Airfoil] depicts the modifications applied to the original NASA MS(1)-0317 airfoil section for use on the K-650T and includes the reflexed contours used near the trailing edge when the flap is fully retracted.

FIG. 40 [Fowler Flap c′_c] depicts the geometric relationship between the deployment of a Fowler flap and the basic wing chord.

FIG. 41 [Hap Track Comparison] depicts flap tracks used on the Sherpa models K-400 and K-650T extending further down and aft than those used on the Caravan and Kodiak. It also depicts the considerable difference in the flap slot geometry used that allows the Sherpa models to achieve extensive translation of their flaps.

FIG. 42 [K-400 Retracted n Extended Flap Positions] depicts the airfoil section used on the Sherpa K-400 when the flap is retracted and extended.

FIG. 43 [K-650T Retracted n Extended Hap Positions] depicts the airfoil section used on the Sherpa K-650T when the flap is retracted and extended.

FIG. 44 [K-400 Airfoil Spoileron n Aileron w_Retracted Flap] depicts the airfoil section used on the Sherpa K-400 when the flap is retracted and the aileron deflected fully downward with the spoileron in the neutral positions, and the aileron deflected fully upward with the spoileron deflected fully upward.

FIG. 45 [K-400 Airfoil Spoileron n Aileron w_Extended Flap] depicts the airfoil section used on the Sherpa K-400 when the flap is fully extended and the aileron deflected fully downward with the spoileron in the neutral positions, and the aileron deflected fully upward with the spoileron deflected fully upward.

FIG. 46 [K-650T Airfoil Spoileron n Aileron w_Retracted Flap] depicts the airfoil section used on the Sherpa K-650T when the flap is retracted and the aileron deflected fully downward with the spoileron in the neutral positions, and the aileron deflected fully upward with the spoileron deflected fully upward.

FIG. 47 [K-650T Airfoil Spoileron n Aileron w_Extended Flap] depicts the airfoil section used on the Sherpa K-650T when the flap is fully extended and the aileron deflected fully downward with the spoileron in the neutral positions, and the aileron deflected fully upward with the spoileron deflected fully upward.

FIG. 48 [Sealed Aileron] depicts a sealed type aileron that was used in the earlier Sherpa model using a flexible wiper (seal) that does not permit the air to flow between the upper and lower wing surfaces directly forward of the aileron.

FIG. 49 [Aileron Parameters] depicts various measurements required to define the characteristics of a Frise aileron.

FIG. 50 [K-400 Airfoil Spoileron n Flap] depicts the airfoil section used on the Sherpa K-400 when the flap is retracted and the spoileron deflected fully upward, when the flap is fully extended with the spoileron in the neutral positions, and when the flap is fully extended with the spoileron deflected fully upward.

FIG. 51 [K-650T Airfoil Spoileron n Flap] depicts the airfoil section used on the Sherpa K-650T when the flap is retracted and the spoileron deflected fully upward, when the flap is fully extended with the spoileron in the neutral positions, and when the flap is fully extended with the spoileron deflected fully upward.

FIG. 52 [Flap Gap_Spoileron Parameters] depicts various measurements required to define the characteristics of the gap between the fully extended flap and the spoileron.

FIG. 53 [Aircraft Comparison Geometry Sheet] depicts the comparison of basic wing geometry of the Caravan, Kodiak, and the Sherpa models K-400 and K-650T.

FIG. 54 [Aircraft Comparison Weight Sheet] depicts the comparison of basic weights used when in various flight condition for the Caravan, Kodiak, and the Sherpa models K-400 and K-650T.

FIG. 55 [K-400 Wing Planform] depicts a plan view of the various wing related components used on the Sherpa K-400.

FIG. 56 [K-650T Wing Planform] depicts a plan view of the various wing related components used on the Sherpa K-650T.

FIG. 57 [Caravan Wing Planform] depicts a plan view of the various wing related components used on the Cessna 208 Caravan.

FIG. 58 [Kodiak Wing Planform] depicts a plan view of the various wing related components used on the Kodiak 100.

FIG. 59 [Aircraft Comparison Performance Sheet] depicts the comparison of performance of the Caravan, Kodiak, and the Sherpa models K-400 and K-650T when in various flight condition.

FIG. 60 [Wing Planform] depicts the various spanwise measurements required to define the relationships between the flap, aileron, and the spoileron to the basic wing.

FIG. 61 [K-400 n K-650T Flap Track Overlay] depicts a comparison of the Sherpa K-400 flap track to the K-650T flap track.

FIG. 62 [K-400 n Caravan Flap Track Overlay] depicts a comparison of the Cessna 208 Caravan I flap track to the Sherpa K-400 flap track.

FIG. 63 [K-400 n Kodiak Flap Track Overlay] depicts a comparison of the Kodiak 100 flap track to the Sherpa K-400 flap track.

FIG. 64 [K-650T n Caravan Flap Track Overlay] depicts a comparison of the Cessna 208 Caravan I flap track to the Sherpa K-650T flap track.

FIG. 65 [K-650T n Kodiak Flap Track Overlay] depicts a comparison of the Kodiak 100 flap track to the Sherpa K-400 flap track.

FIG. 66 [Caravan & Kodiak Flap Support Arm Comparison] depicts the flap tracks and flap support arms used on both the Caravan and Kodiak.

FIG. 67 [K-650T Airfoil Aileron n Retracted Flap] depicts the inboard airfoil section used on the Sherpa K-650T when the flap is retracted, and the outboard airfoil section when the flap is retracted and the aileron and spoileron are in their neutral positions.

FIG. 68 [Typ Lam Flow Airfoil] depicts typical laminar flow airfoil sections developed by NACA and NASA.

FIG. 69 [K-650T Airfoil w_Flap] depicts the current K-650T airfoils section with the flap in the retracted position and the spoileron in the neutral position.

FIG. 70 [K-650T Airfoil w_Aileron] depicts the current K-650T airfoils section with the aileron in the neutral position as well as the upper wing surface features when the flap and spoileron are in their neutral positions.

FIG. 71 [Max Effect For LE Radius] depicts a graph presented in the USAF DATCOM showing how the size of the nose radius of a leading edge flap affects its ability to increase lift.

FIG. 72 [Airfoil Thickness Effect on Hap Lift] depicts a graph presented in the USAF DATCOM showing how the change in maximum lift is affected with respect to the thickness of an airfoil section and the type of flap used.

FIG. 73 [Lifting Effectiveness of Trailing Edge Flaps] depicts a graph presented in the USAF DATCOM showing how the change in lift provided when using a trailing edge flap is affected by the relationship between the flap chord and the wing chord, flap chord ratio (cf/c).

FIG. 74 [Kodiak Airfoil w_Flap] depicts the flap used on the Kodiak 100 in both retracted and fully extended positions.

FIG. 75 [Caravan Airfoil Spoileron n Flap] depicts the flap used on the Cessna 208 Caravan in both retracted and fully extended positions.

FIG. 76 [Flap Angle Correction Factor] depicts a graph presented in the USAF DATCOM showing how the change in maximum lift is affected with respect to the flap deflection angle, as well as the maximum deflection before airflow separation occurs for various types of flaps.

FIG. 77 [K-400 Intermediate Flap Positions] depicts the inboard airfoil section used on the Sherpa K-400 when the flap is in various intermediate positions.

FIG. 78 [K-650T Intermediate Flap Positions] depicts the inboard airfoil section used on the Sherpa K-650T when the flap is in various intermediate positions.

FIG. 79 [K-400 vs K-650T Flap n Spoileron] depicts the flaps in their fully deployed positions and their position with regard to their flap tracks for both the K-400 and K-650T. It also depicts the spoilerons in both the neutral and fully extended positions.

It will be appreciated that the figures are illustrative and do not limit the scope of the invention, which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity.

Similarly, not every embodiment need accomplish all advantages of the present invention. The figures are not intended to be exhaustive or to limit the embodiments to the precise form disclosed. It should be understood that various embodiments may be practiced with modification and alteration.

### DETAILED DESCRIPTION

The present invention comprises a system of devices, mechanisms and machines related to short takeoff and landing (STOL) fixed-wing aircraft, various embodiments of which are described more fully hereinafter with reference to the accompanying drawings, which illustrative various embodiments of the present invention, which is not limited or bound by any expressed or implied theory presented in the preceding technical field, background, summary, the drawings, or the following detailed description.

The drawings and following detailed description are exemplary of various aspects and embodiments of the present invention and are not intended to narrow the scope of the appended claims. The present invention can be embodied in many different forms and it should not be construed as limited to the embodiments set forth herein; rather, these embodiments are provided so that this disclosure shall be thorough and complete to fully convey the scope of the invention to those skilled in the art.

This detailed description describes the invention with reference to specific examples of its embodiments, and while it may indicate preferred embodiments of the present invention and specific details thereof, the described embodiments are merely exemplary and not intended to limit the scope of the present invention or its applications and uses.

These, and other, aspects and objects of the present invention may be better appreciated and understood when considered in conjunction with the following description with reference to the accompanying drawings. Many modifications, variations, alternatives, and changes may be made therein without departing from the broader spirit and scope of the present invention as set forth in the appended claims.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It is further understood that terms, such as those defined in commonly used dictionaries, should be interpreted as having a meaning that is consistent with their meaning in the context of the relevant art and should not be interpreted in an idealized or overly formal sense unless expressly so defined herein.

It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. As used herein, the singular forms “a,” “an,” and “the” are intended to include the plural forms as well, unless the context clearly indicates otherwise.

Reference throughout this specification to “one embodiment” or “an embodiment” means that a particular feature, structure, or characteristic described in connection with an embodiment is included in at least one embodiment of claimed subject matter. Thus, appearances of phrases such as “in one embodiment” or “an embodiment” in various places throughout this specification are not necessarily all referring to the same embodiment. Furthermore, particular features, structures, or characteristics may be combined in one or more embodiments.

As used herein, the word ‘comprising’ does not exclude the presence of other elements or steps than those listed in a claim. Moreover, the terms “nose,” “tail,” “front,” “forward,” “aft,” “aftward,” “back,” “top,” “bottom,” “over,” “under,” “port,” “starboard,” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in orientations and configurations other than those illustrated or otherwise described herein.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

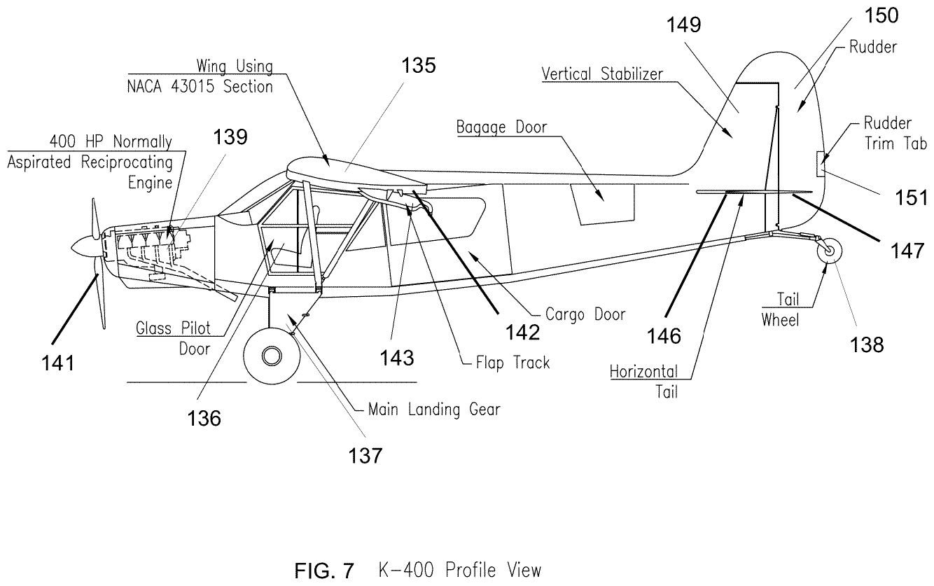

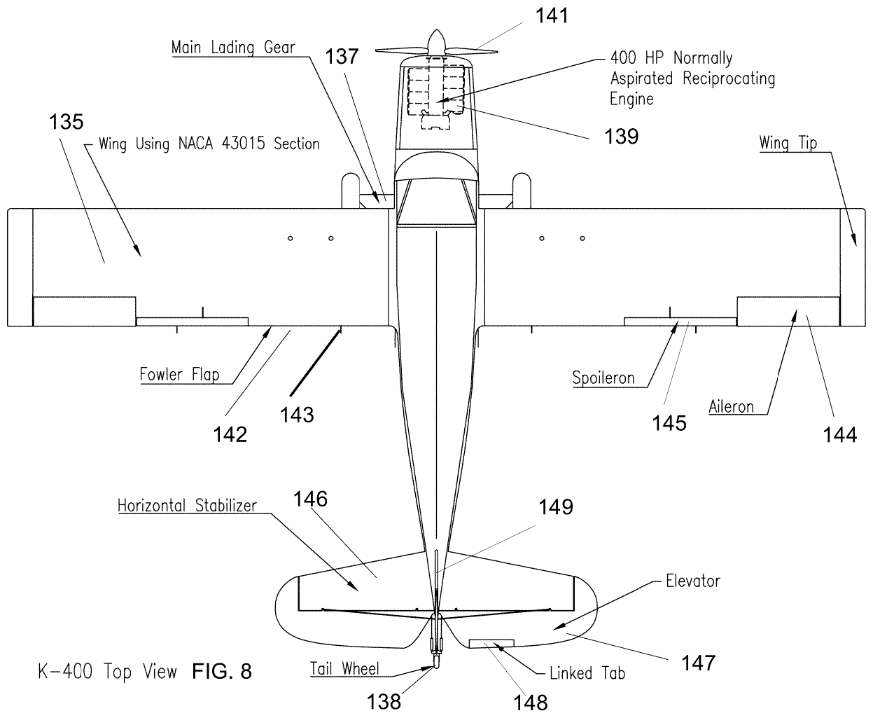

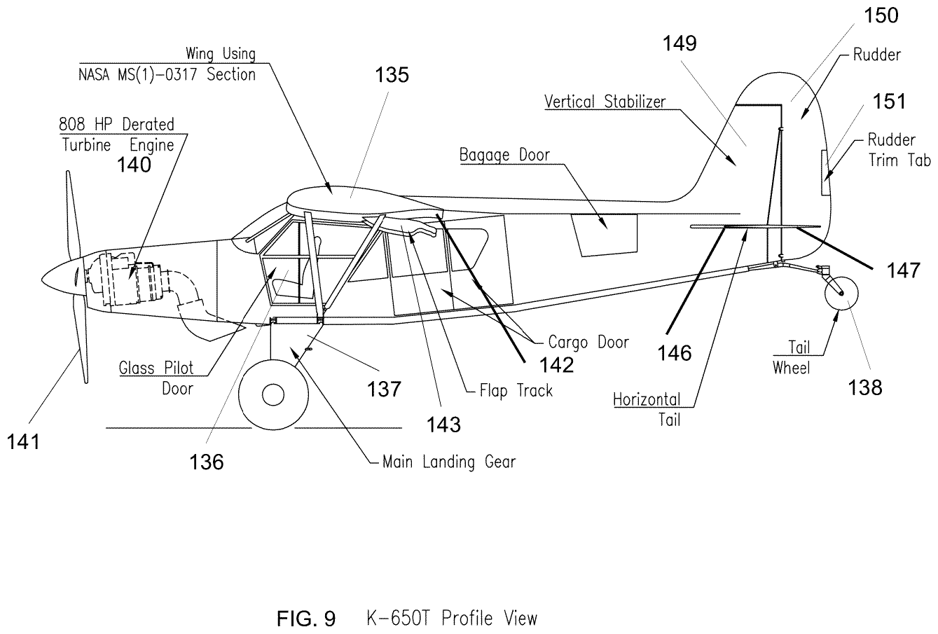

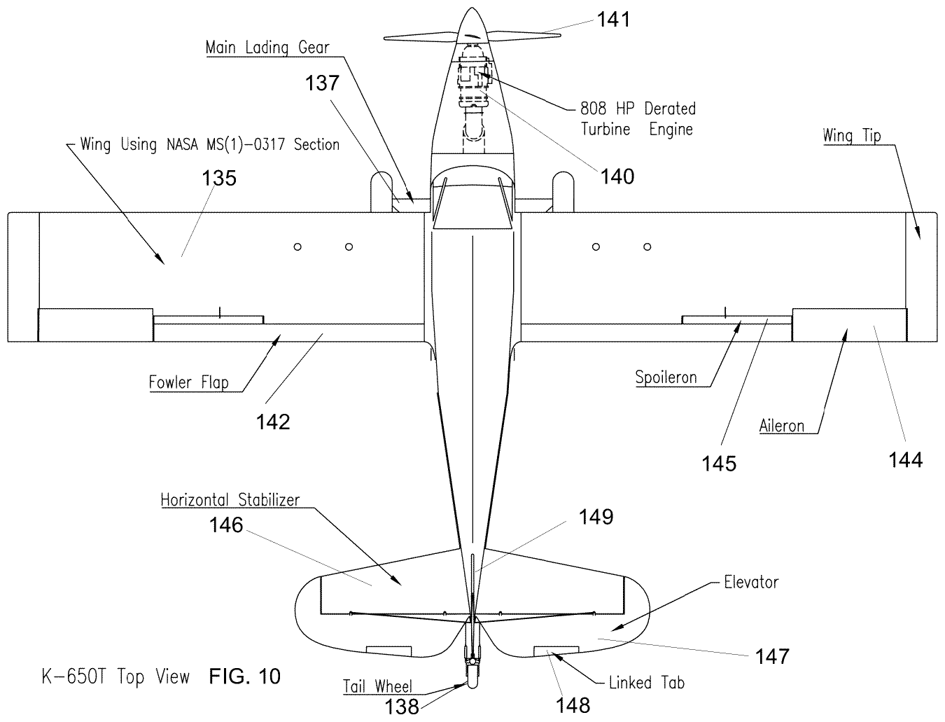

Transitioning now to describe more directly the invention, the driving objective for the Sherpa designs were to develop aircraft capable of operating with a significant load from very short, unimproved areas, while cruising at a respectable speed. FIG. 7 [K-400 Profile View], FIG. 8 [K-400 Top View], FIG. 9 [K-650T Profile View], and FIG. 10 [K-650T Top View] depict the basic layout of these aircraft. A high wing 135 design with large windows 136 was chosen for greater visibility of the ground and a convention main landing gear 137 and tail wheel 138 for durability. The reciprocating 139 and turbine 140 power plants were positioned in the tractor configuration driving a large diameter propeller 141. Both aircraft wings utilize a Fowler flap 142 translating about an external flap track 143 for increased lift during slow flight and landing and both ailerons 144 and spoilerons 145 for enhanced roll control at low speeds. A conventional tail consisting of a horizontal stabilizer 146, elevator 147 and linked tab 148, and a vertical stabilizer 149, rudder 150, and trim tab 151 were used.

Aviation and aerospace design always involves tradeoffs across a given configuration of desired ideal functionalities and capabilities. Durability in rough field operations along with ease of manufacturing, pilot workload, and repairability in remote locations were all important considerations.

Bernoulli's Principle and Conservation of Momentum Theory are required to form a basic understanding of the physics of airfoil section aerodynamics in generating lift. But, neither Bernoulli's Principle nor Conservation of Momentum Theory (Newton) are complete theories and, much like General Relativity Theory and Quantum Mechanics, they do not mesh well in a straightforward manner and rather are better utilized as different incomplete ways to observe the same phenomena.

Further, aerodynamics engineers and designers typically rely more on Computational Fluid Dynamic (CFD) models, which comprise more of a modular approach. Though, CFD even has its own specific challenges and limitations as demonstrated by the disastrous results of the 2022 Mercedes Formula 1 car design that costs tens of millions in USD to investigate unexpected aerodynamics results.

In all realms of flight any changes to airspeed or altitude require a change in the overall mix of potential and kinetic energies in the system, or an addition to the total energy available, i.e., increasing the throttle and power output by the engine(s). Simply put, to increase altitude requires input of additional energy or sacrifice of (i.e., decreasing) airspeed. Increasing airspeed requires input of additional energy or sacrifice of (i.e., decreasing) altitude.

Another way to frame this concept is that in cruise flight while using power to maintain a constant speed, pitch can control altitude; and when using pitch to maintain a constant altitude, power can control airspeed. Slow flight, or slow airspeed flight, is also known as the region on the back side of the power curve, and anytime an airplane flies at an airspeed between the best endurance speed and the stalling speed it is operating within this region. Operating in the region on the back side of the power curve, or “behind the power curve”, presents a flight regime whereby drag and thrust requirements are inverted with respect to normal, front side of the power curve cruise flight.

In slow flight while using power to maintain a constant altitude, pitching the aircraft upward increases the angle of attack (AOA) and induced drag, resulting in slowing airspeed (which taken to the extreme, will result in a stall and a rapid loss of altitude). Conversely, pitching the aircraft downward increases airspeed. While using pitch attitude to maintain a constant speed, increasing power will result in an increase of altitude, while decreasing power will result in a loss of altitude. In slow flight (on the back side of the power curve) pitch essentially controls airspeed and power basically controls altitude.

Practicing slow flight develops the ability of pilots to recognize changes in aircraft flight characteristics and effectiveness of controls at critically slow airspeeds in various configurations. While pilots may perform slow flight aloft, e.g., for training or to loiter over an area during flight, it is most often performed incidental to takeoff and landing.

Minimum controllable airspeed and speed instability are also important factors in slow flight. Flying slower or faster than minimum drag speed (L/D-Max), more power will be required, due to the total drag curve. Disturbances such as turbulence will cause variations in airspeed.

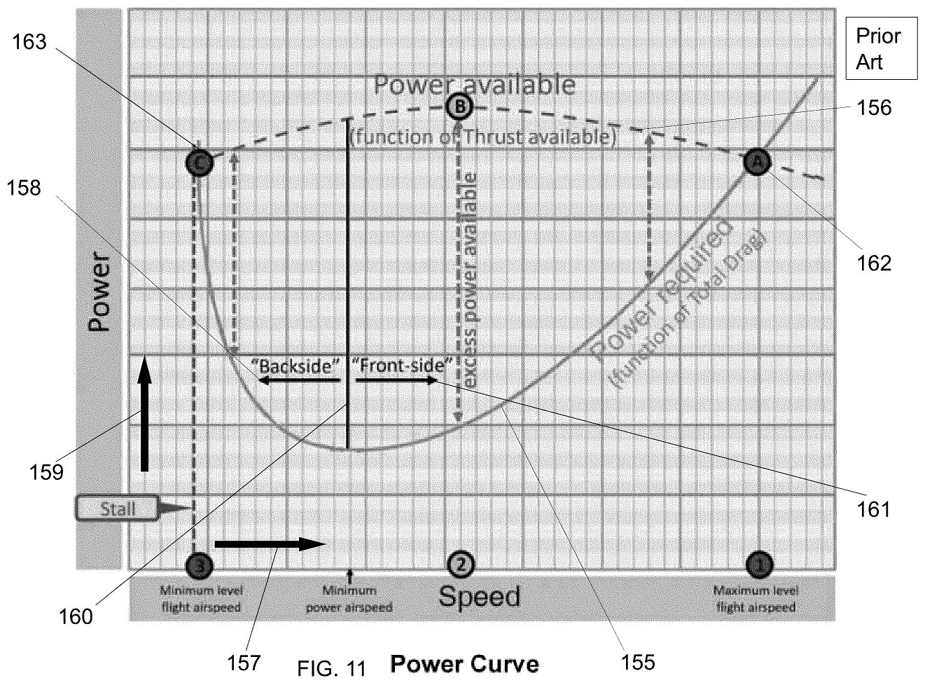

As shown in FIG. 11 [Power Curve], depicting a graph of the power required 155 (a function of drag) and power available 156 (a function of horsepower and propeller efficiency) with respect to airspeed 157. When flying within the region on the back side of the power curve 158, as airspeed slows more power 159 is needed to maintain altitude. If required power is not maintained, the increase in drag can be insidious leading to a stall. This is a contributing factor to the higher accident rate during final approach to landing.

The region on the back side 158 of the power curve is so named due to the relationships exemplified in the Power versus Speed diagram (see FIG. 11 [Power Curve]). To the left of the best endurance speed 160 is the region behind the power curve, aka “the backside of the power curve”. To the right is the front side 161 of the power curve and the region of normal command.

In the region on the back side of the power curve 158, the slower the speed of the airplane the more power is required to maintain a specific altitude. This is the reverse of flight on the front side 161 of the power curve, where the slower the speed of the airplane, the less power required to maintain a specific airspeed.

For example, if the aircraft weighs 4,000 pounds, the lift produced by the aircraft must be 4,000 pounds. When lift is less than 4,000 pounds, the aircraft is no longer able to sustain level flight, and consequently descends. During intentional descents, this is an important factor and is used in the total control of the aircraft.

However, because higher lift coefficients are required to achieve lower flight speeds and is characterized by high angles of attack, flaps or other high-lift devices are often used to either change the camber of the airfoil section, or delay boundary layer separation, or both. Plain and split flaps are most commonly used to change the camber of an airfoil section, and when using these types of flaps the aircraft will stall at a lower angle of attack, or AOA.

Most general aviation wings stall around 100 to 140 with flaps retracted and 7° to 9° with flaps deflected when utilizing plain or split flaps (without slipstream effect from the propeller). If a wing stalls at 14° with flaps retracted, with the extension of plain trailing edge flaps, the maximum Coefficient of Lift (CL-Max) increases and the new AOA at which point the aircraft will stall decreases to 9°. Due to the wing aspect ratios (relationship between the wingspan and wing chord) and high-lift airfoil sections chosen for the Sherpa wing of the present invention, the Model K-400 and K-650T wings will stall at around 230 and 17°, respectively, with flaps fully retracted. And, because the Fowler flaps are so much more efficient and extend so far aft, with the flaps fully deflected the Model K-400 and K-650T wings will stall at around 250 and 19°, respectively—opposite to the typical convention of a decreased AOA for stall with plain flaps fully deflected or a Fowler flap that is only partially translated when at full deflection.

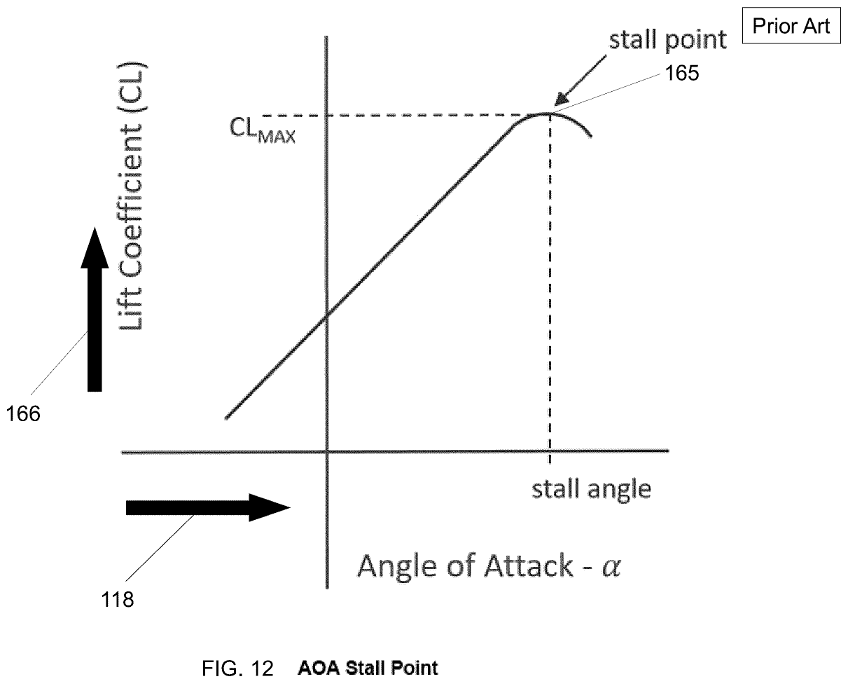

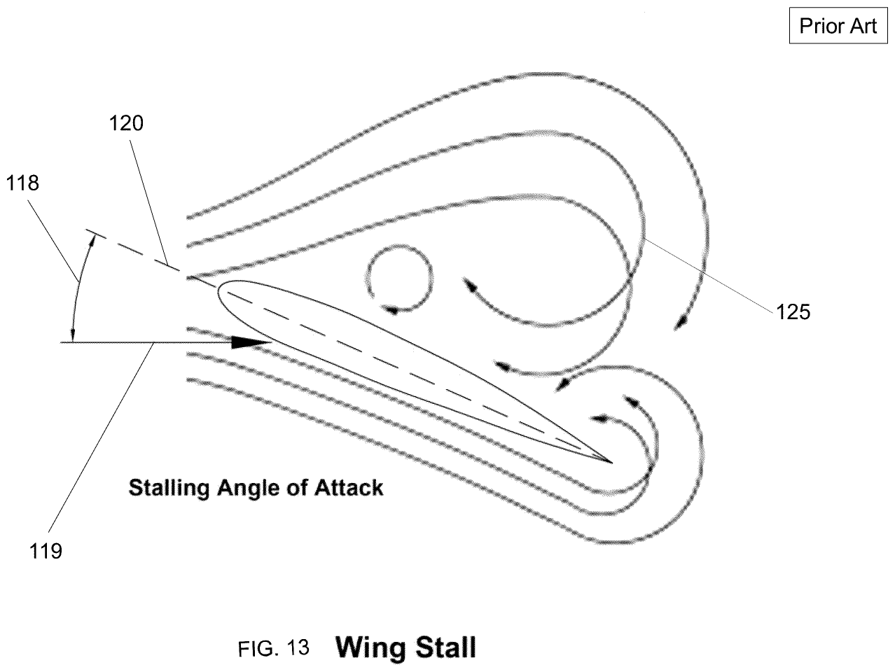

As shown in FIG. 12 [AOA Stall Point] and FIG. 13 [Wing Stall], the stall 165 of the wing section occurs at the highest lift coefficient 166 and highest angle of attack 118 when the airflow can no longer remain attached to the upper surface of the wing section and separates 125 from the upper wing surface. If the airflow were to first start separating at the leading edge of the wing, this will create a very abrupt and dangerous deep stall. Consequently, wings are designed so that the airflow boundary layer separation begins to occur at the trailing edge of the wing, near the fuselage. This is how boundary layer separation works, when the Coanda effect can no longer keep the airflow adhered to the upper surface of the cambered wing section.

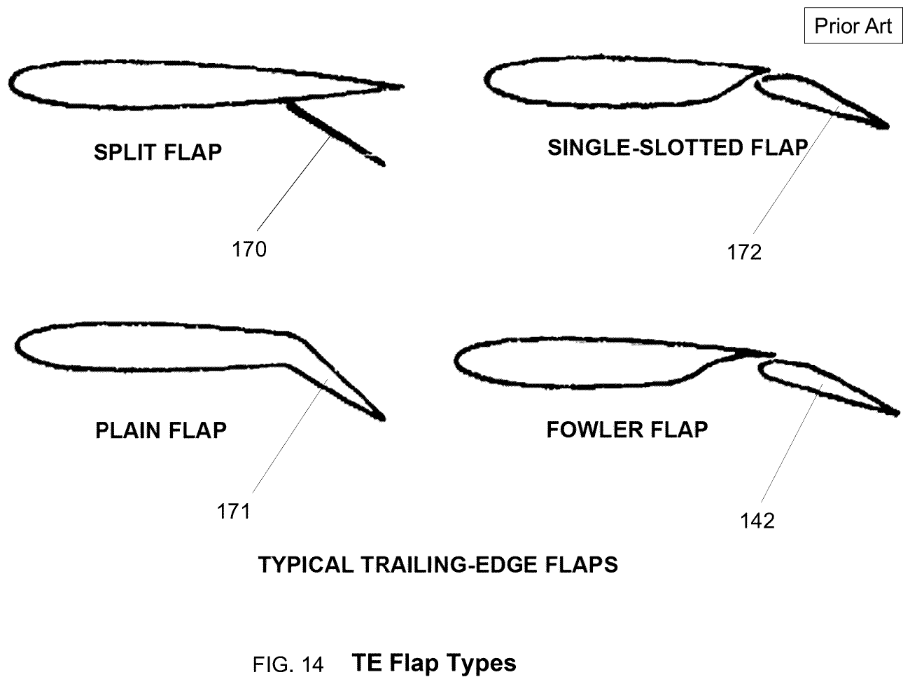

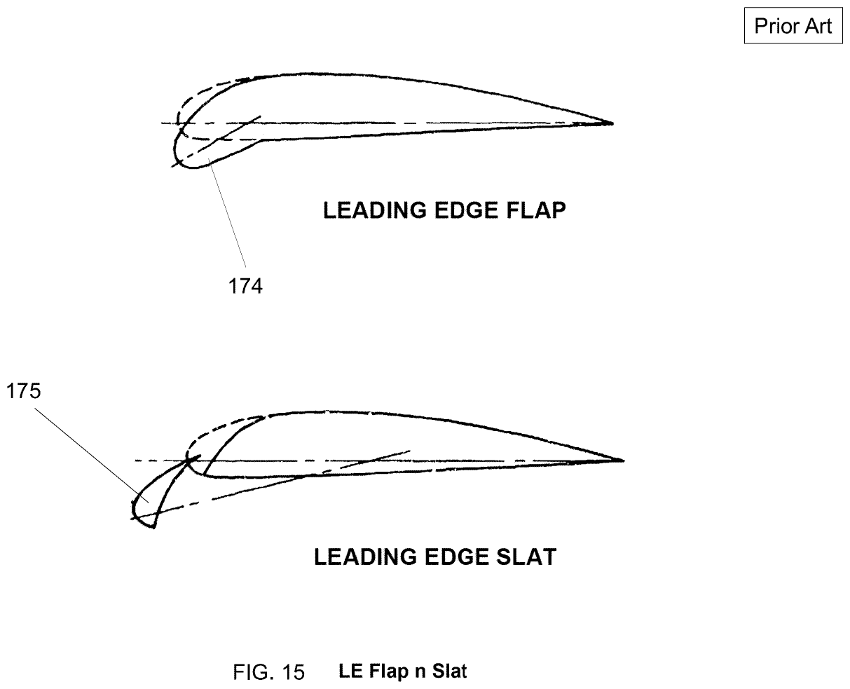

To delay the stall to a higher lift coefficient, most airplanes are equipped with flaps (on the wing section trailing edge) designed to increase the wing section chamber by deflecting downward to generate more lift. FIG. 14 [TE Flap Types] depicts the four types of trailing edge flaps commonly used on wings to produce increased lift; split flap 170, plain flap 171, single slotted flap 172, and the Fowler flap 142. The Fowler flap 142 is a specific type of flap (invented by Harlan Fowler in the 1920's) that translates aft as it deflects, increasing both the wing section camber and the effective wing area to generate greater lift. FIG. 15 [LE Flap n Slat] depicts leading edge flaps 174 or and slats 175 (on the wing section leading edge) that some designs use to further lower the stall speed, though this can significantly increase the stall AOA and wing drag.

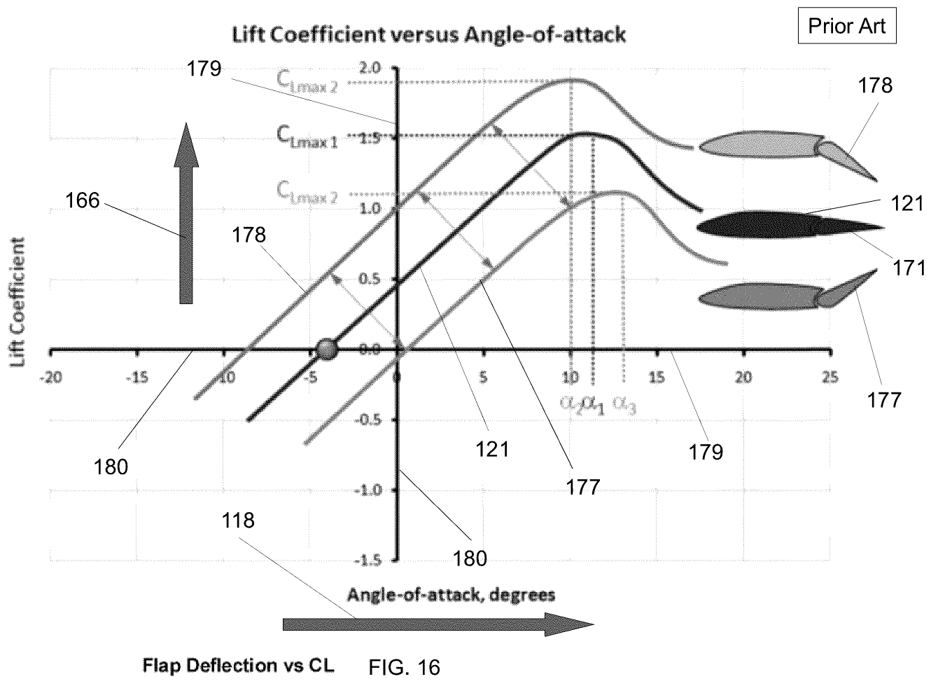

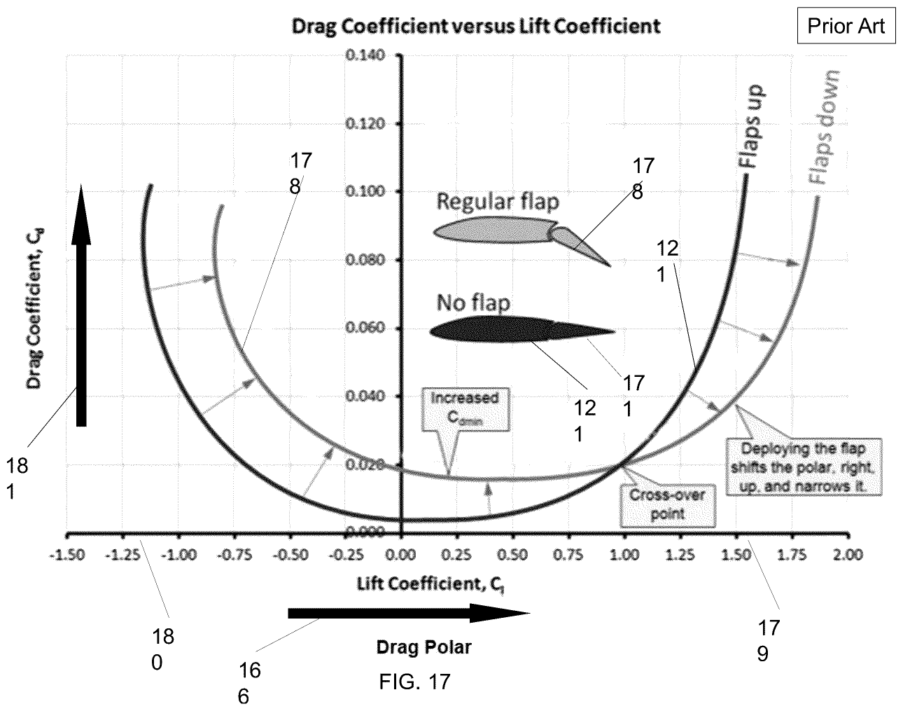

FIG. 16 [Flap Deflection vs CL] illustrates the use of an upward 177 and downward 178 deflecting plain flaps 171 and positive 179 and negative 180 AOA 118 to modify and increase or decrease the lift coefficient 166 produced by an airfoil section 121. FIG. 17 [Drag Polar] depicts how positive 179 and negative 180 lift coefficients 166 affects the drag coefficient 181 of an airfoil section 121 equipped with a plain flap 171 in the neutral position and when deflected downward 178 to increase lift.

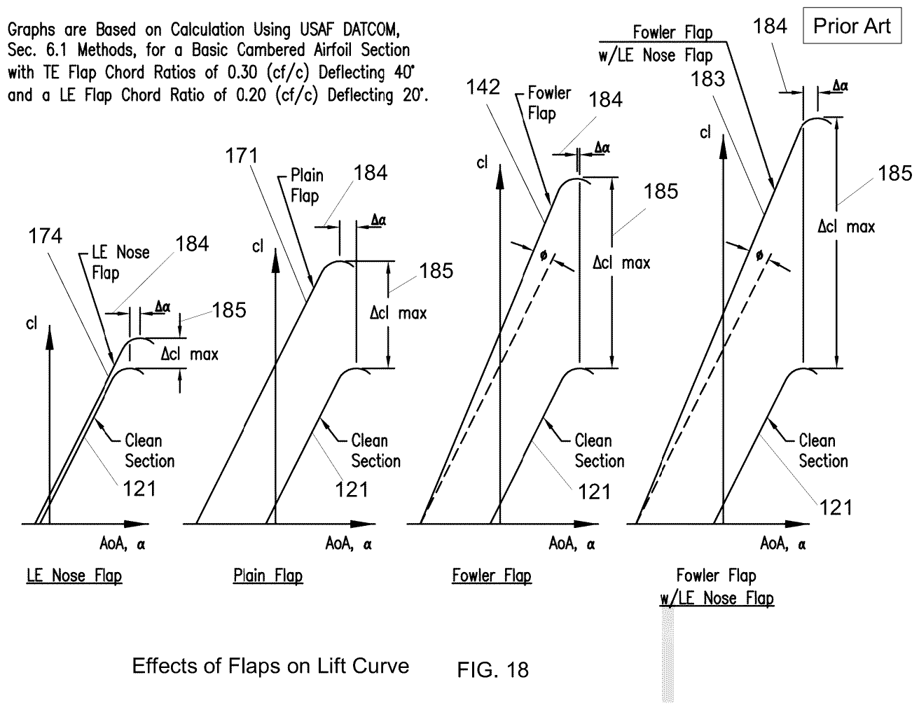

FIG. 18 [Effects of Flaps on Lift Curve] depicts the effects of a leading edge nose flap 174, plain flap 171, Fowler flap 142, and a leading edge nose flap and Fowler flap combination 183 have on the lift curve of a basic chambered airfoil section 121. Most airfoil sections stall at an angle of attack 118 around 10° to 14° while achieving a maximum lift coefficient around 1.4 to 1.6 without the presents of flaps. When deflecting a leading edge flap with a 20% chord ratio to 20 degrees with no other flaps being deployed the stall angle of attack will increase (Δα) 184 by about 1.5 degrees while the maximum lift coefficient increases (Δcl_max) 185 by around 0.3 or 20%. Using a plain trailing edge flap 171 of 30% chord deflecting 40 degrees the stall angle of attack will decrease (Δα) 184 by about 2.5 degrees while the maximum lift coefficient increases (Δcl_max) 185 by around 1.1 or 70%. When translating the leading edge of a Fowler flap 142 nearly to the airfoil section's trailing edge the change in stall angle of attack (Δα) 184 will be nearly the same as that of the basic airfoil section 121 while the maximum lift coefficient increases (Δcl_max) 185 by over 2.0 or 200%. When combining the Fowler flap with the leading edge flap 183 the stall angle of attack will increase (Δα) 184 by about 2 degrees while the maximum lift coefficient increases (Δcl_max) 185 by around 2.6 or 260%.

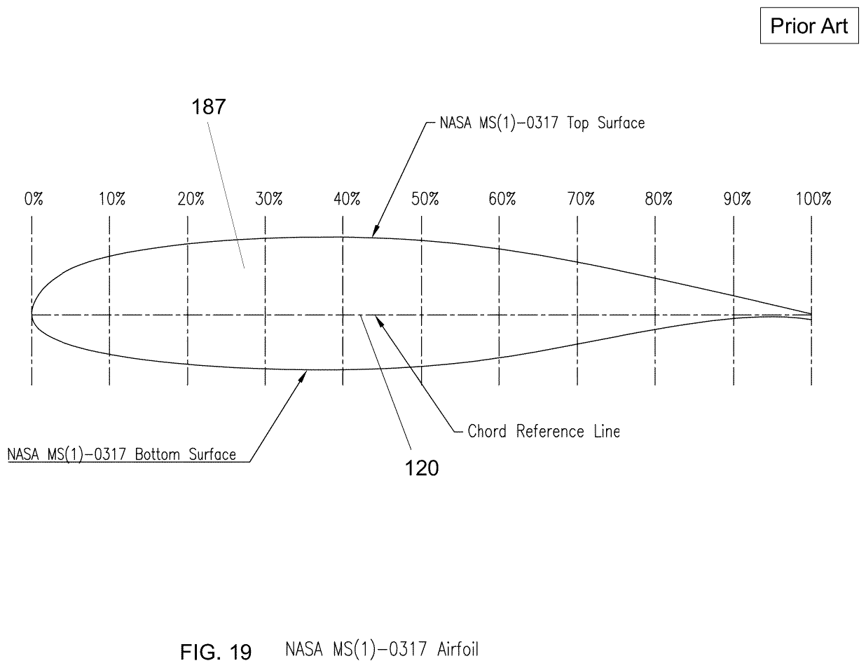

The lift coefficient can thus be effectively doubled in some cases with relatively simple devices (flaps and slats) when attached across the full wingspan, i.e., in this case, the span or lateral extent of each wing panel. However, for small/light airplane design it is usually undesirable to use leading edge slats due to complexity and weigh consideration or full span flaps due to roll requirements at low airspeeds. It was determined that a NASA MS(1)-0317 187 airfoil section could be modified to achieve the desired requirements for use on the Sherpa Model K-650T. FIG. 19 [NASA MS(1)-0317 Airfoil]

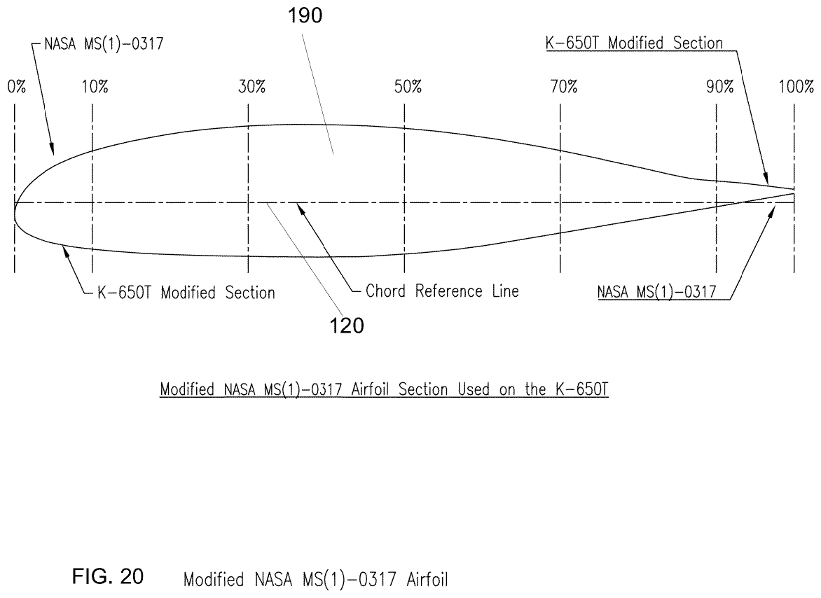

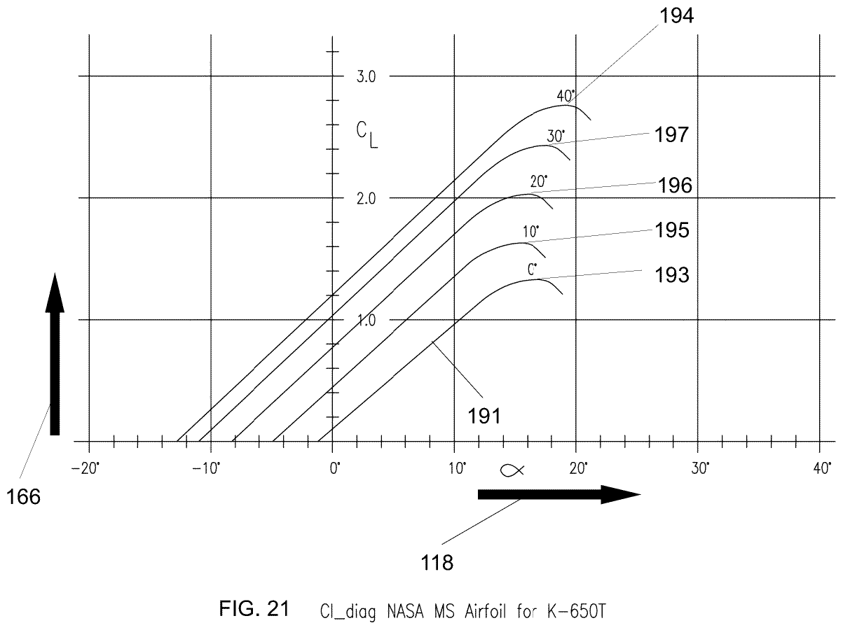

FIG. 20 [Modified NASA MS(1)-0317 Airfoil] and FIG. 21 [Cl_diag NASA MS Airfoil for K-650T] depicts the Modified NASA MS(1)-0317 190 airfoil section used on the Sherpa Model K-650T and its lift curve 191 exhibiting an estimated maximum lift coefficient 193 in 3-dimensional flow, with no power effect and the flap in the retracted (reflexed) position, of about 1.3, and when deploying the flap to the maximum position a maximum coefficient 194 of about 2.8, more than doubling the lift. Maximum lift coefficients for intermediate flap deployments of 10 degrees 195, 20 degrees 196, and 30 degrees 197 of about 1.6, 2.0, 2.4, respectively, are also shown and occur at various angles of attack 118. Calculated coefficients based on flight data during landing are higher due to the effects of operating the powerplant at higher power settings, especially when the flaps are fully deployed due to the blown flap (or jet flap) effects.

VS0 is the stalling speed or the minimum steady flight speed in the landing configuration. Most small airplanes must maintain a speed in excess of 1.3 times VS0 on an instrument approach. An airplane with a VS0 of 50 knots has a normal approach speed of 65 knots. However, this same airplane may maintain as high as 90 knots (1.8 VS0) during portions of an instrument approach. Speeds higher than 1.8 VS0 could exceed the structural flap extension speed in some designs.

Pilots typically select a maximum flap setting for the final phase of a landing approach. The approach should be stabilized at this phase; if not, the pilot should execute a “go-around” (climb back to pattern altitude).

At the maximum level flight airspeed (see point A 162, FIG. 11 [Power Curve]), the airplane has good positive speed stability. Flying in this regime permits the pilot to make slight pitch changes without changing power settings, and accept minor speed changes, knowing that when the pitch is returned to the initial setting the speed will return to the original setting. This reduces the pilot's workload.

Light aircraft are usually slowed to a normal landing speed when on the final approach just prior to landing (short final) when flying visually. Approaches differ somewhat depending on type of aircraft, visibility (VFR vs IFR), length of landing field, etc. When slowed to 65 knots, (1.3 VS0), the airplane will be approaching point C 163, in FIG. 11 [Power Curve]. At this point, precise control of the pitch and power becomes more crucial for maintaining the correct speed.

Precise speed control is necessary throughout the approach. It may be necessary to temporarily select excessive, or deficient thrust in relation to the target thrust setting in order to quickly correct for airspeed deviations. In addition to the need for more precise airspeed control, the pilot normally changes the aircraft's configuration by extending flaps to the landing configuration.

This configuration change means the pilot must be alert to unwanted pitch changes at a low altitude since the airplane is flying on the back side of the power curve. If allowed to slow several knots, the airplane could enter the extreme back side of the power curve, where the power required curve becomes very steep as stall is rapidly approached. At this point, the airplane could develop an unsafe sink rate and continue to lose speed unless the pilot takes prompt corrective action.

Extending flaps usually decreases L/D-Max, thus glide angle, and decreases speed for L/D-Max (best glide speed). A pilot on an instrument approach with the aircraft configured for landing at a desired speed of 1.3 VS0, a speed near L/D-Max for flaps fully extended (if so equipped), knows that a specific power setting will maintain that desired speed.

If the airplane slows several knots below the desired speed due to a slight reduction in the power setting, the pilot may correspondingly increase the power slightly, in response to which the airplane will begin to accelerate, but only at a slow rate. This is because the airplane is still in the “flat part” of the drag curve, and slight increases in power will not cause a rapid return to the desired speed.

The pilot may need to increase the power more than normally required to maintain the new speed, enabling the airplane to accelerate appropriately to timely/rapidly achieve the desired speed, and then reduce the power setting to maintain the desired speed.

Various innovations exist to help increase the CL-Max and improve lift and control, especially for operating in the region on the back side of the power curve or behind the power curve. Delaying the boundary layer separation is another way to increase CL-Max.

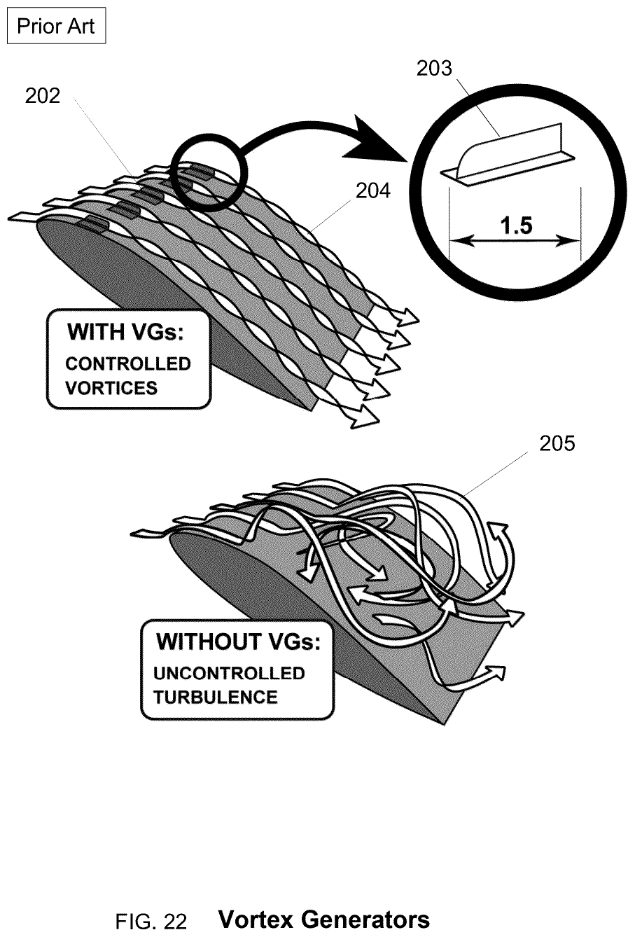

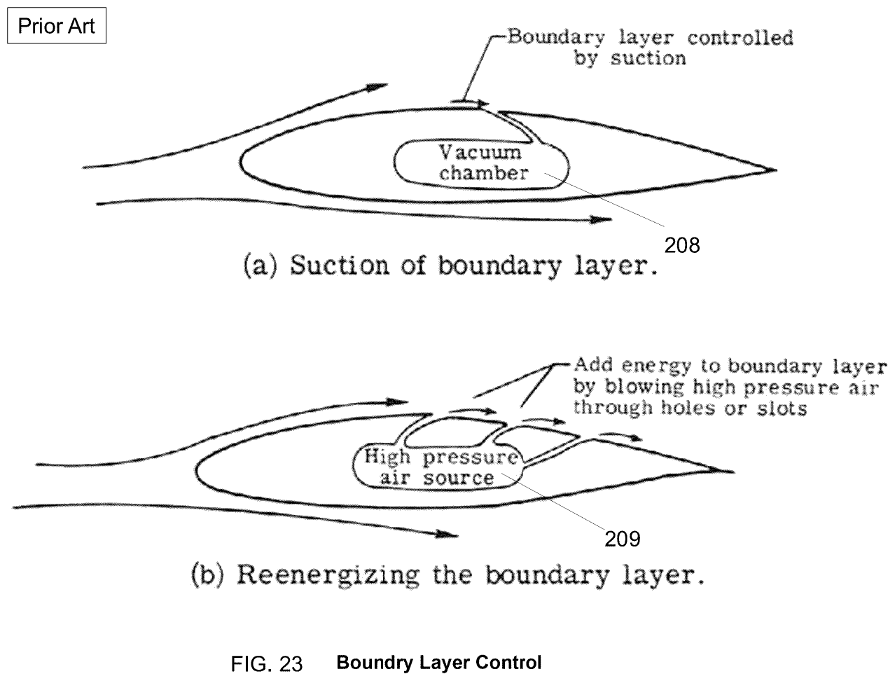

Several methods can be employed to delay boundary layer separation (such as suction and use of a blowing boundary layer control), but the most common device used on general aviation light aircraft shown in FIG. 22 [Vortex Generators] is the vortex generator 202 (VGs). Small strips of metal 203 placed along the wing (usually near the leading edge to increase lift and in front of the control surfaces to enhance control effectiveness) to create controlled turbulence 204 in place of uncontrolled turbulence 205. The turbulence in turn mixes high energy air from outside the boundary layer with boundary layer air. The effect is similar to that achieved by other boundary layer devices shown in FIG. 23 [Boundary Layer Control] using suction 208 or blowing devices 209.

As previously mentioned, wing slats are another way to increase the effective lift provided by a wing section. However, many of these innovations are unsuitable for one reason or other. For instance, vortex generators (VGs) and wing slats can also increase drag, which can be counterproductive to the overall objectives of the airplane. Further, depending on the type of device used and the design specifics, this can greatly increase the required angle-of-attack, thereby also increasing the deck angle of the airplane to a point where pilot visibility of the landing zone is completely obscured.

Takeoff and landing operations naturally require the airplane to transition through the region on the back side of the power curve. Further, in flight agricultural application pilots using lower powered aircraft are very often required to fly at airspeeds below best endurance speed, particularly in turns during the first few swaths of a field application. The airplane is typically at maximum weight when initiating the first turns around the field using the standard 450 bank angle which results in a 1.4 g load. The increased g loading combined with the high weight produces a significant increase in induced drag.

In addition, pilots that are new to a particular aircraft/airframe are especially susceptible to inadvertently entering the region on the back side of the power curve, particularly on final approach for a normal landing, on the initial part of a go-around, and during slow flight maneuvers.

When working with a new airplane airframe, pilots should always practice slow flight at altitude as part of any new aircraft transition. This gives a first-hand experience of how the airplane performs, and how the controls feel on the transition into the region on the back side of the power curve.

Once an airplane decreases its airspeed below best endurance speed it begins to enter the region on the back side of the power curve, which requires pilots to be very good at ‘stick and rudder’ flying with a high level of pilot awareness concerning the aircraft flight performance characteristics in this region.

The region on the back side of the power curve is also often associated with agricultural flying and other types of aviation field work (e.g., hyperspectral photogrammetry, aerial surveying, etc.). Another type of airplane that must especially consider factors of operating in the region on the back side of the power curve are airplanes designed specifically to suit short takeoff and landing (STOL) requirements. These airplanes operate at the extreme end of this region during STOL operations.

To be practical, a STOL aircraft must be able to fly at very low speeds and also offer acceptable cross-country (cruising speed) performance. The big challenge is to design a wing section with a high lift coefficient so that the wing area can be optimized to be as small as possible, while supporting the slowest possible takeoff and landing speed.

Relatively shorter wings also make these aircraft easier to taxi, especially when operating in off-airport environments with obstructions, and require less space for hangaring, while being stronger (less weight and wingspan to support). A downside to shorter wings is that they typically limit the climb performance and service ceiling of airplanes which is a detriment when flying from high altitude locations.

Service ceiling from an engineering perspective is the altitude at which an airplane can no longer maintain a minimum 100 fpm climb rate following takeoff at gross weight and climbing directly to that altitude. There are cases when the service ceiling is placarded below this altitude for regulatory reasons. Absolute ceiling is the highest altitude an airplane can obtain.

Wingspan loading (not aspect ratio) will determine the climb performance of an airplane. Lower weight per unit of wingspan (lb/ft) increases climb capability. The vast majority of Sherpa aerodynamic design was based on classical equations modified by empirical factors, rather than detailed theories that are incomplete. Two components critical to achieving the mission statement were a high-lift wing and a roll control system responsive at low airspeeds.

The basic aerodynamics of the Sherpa models were largely developed by interpolating existing wind tunnel data combined with the use of fundamental mathematical computations. Once the basic design was established, improvements were made based on analyses of flight testing. This technique was used to maximize the wing design yielding the desired extreme low speed characteristics coupled with high speed performance.

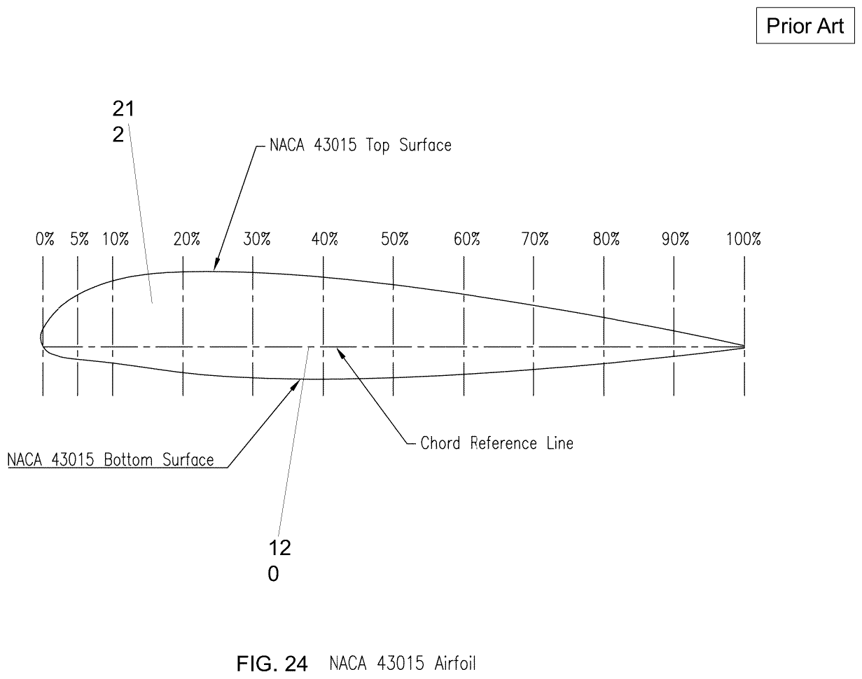

The airfoil section chosen for the Sherpa Model K-400 was based on a NACA 43015 212 5 digit series airfoil section that exhibited high lift values while maintaining a low pitching moment and was well suited for the attachment of high-lift devices. FIG. 24 [NACA 43015 Airfoil]

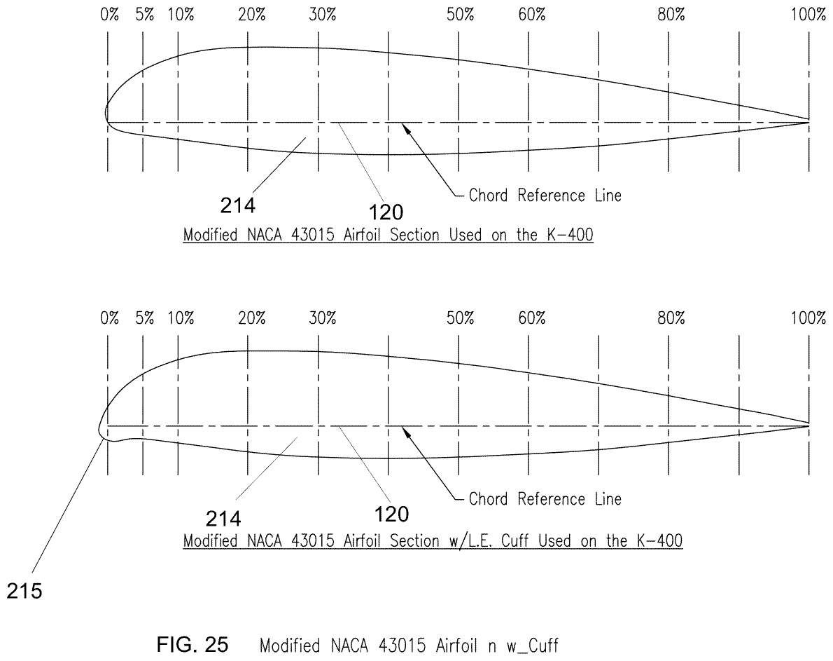

The original K-400 modified NACA 43015 airfoil section 214 shown in FIG. 25 [Modified NACA 43015 Airfoil n w_Cuff] was lofted with changes made to the forward lower surface and to both the upper and lower aft surfaces. It was later discovered that an issue arising with the lack of ability for the wing to achieve angles of attack as high as expected. It was eventually determined that this was related to part of the change made to the forward lower surface. The airplane was flown with a new section that corrected the issue and also flown with the addition of a leading edge cuff 215 that allowed the wing to achieve a slightly higher angle of attack 118 than without the addition. A leading edge cuff is similar to a leading edge flap 174 with a short flap chord ratio (cf/c) and is deflected to a fixed position.

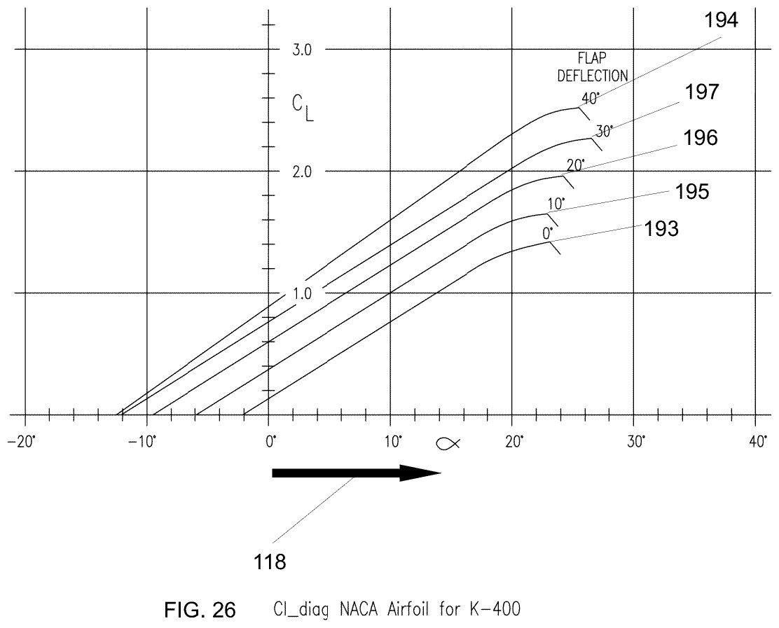

The new wing section used on the K-400 is a modified version of a NACA 43015 airfoil section 214. These modification were completed mostly to provide additional room for installation of the wing spars and to better blend with the Fowler flap. When using this modified NACA 43015 airfoil section 214 on the Sherpa Model K-400, FIG. 26 [Cl_diag NACA Airfoil for K-400], an estimated maximum lift coefficient 193 in 3-dimensional flow, with no power effect and the flap in the retracted position, of about 1.4, and when deploying the flap to the maximum position a maximum coefficient 194 of about 2.5, nearly doubling the lift. Maximum lift coefficients for intermediate flap deployments of 10 degrees 195, 20 degrees 196, and 30 degrees 197 of about 1.6, 2.0, 2.3, respectively, are also shown and occur at various angles of attack 118. Calculated coefficients based on flight data during landing are higher due to the effects of operating the powerplant at higher power settings, especially when the flaps are fully deployed due to the blown flap (or jet flap) effects.

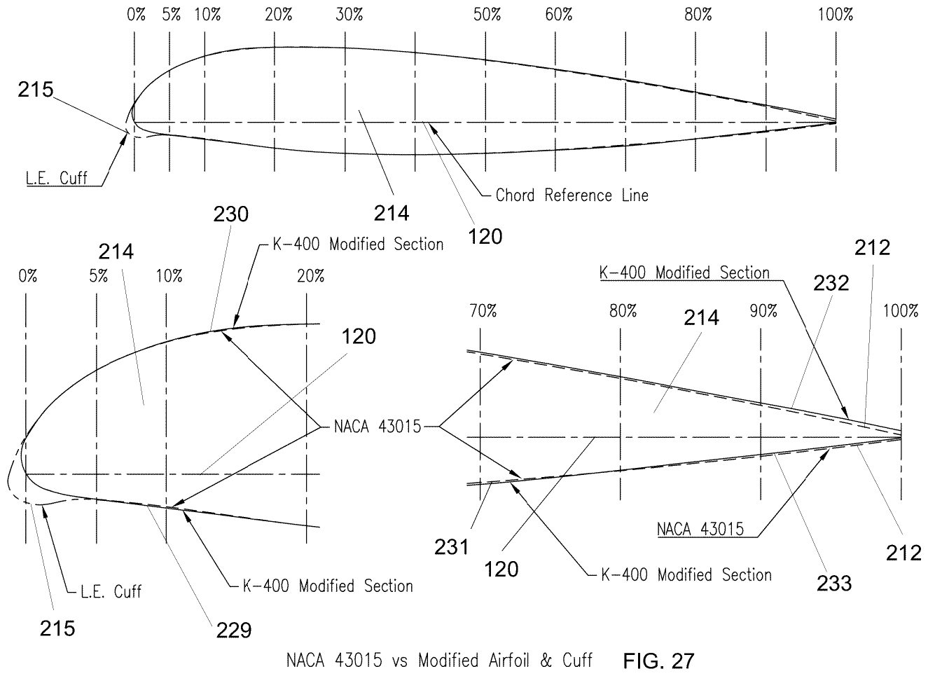

As shown in FIG. 27 [NACA 43015 vs Modified Airfoil & Cuff] in order to provide greater depth for the front spar the under cusp on the bottom surface between 5% and 20% chord locations 229 was removed and the top surface between 10% and 20% locations 230 was moved upward. The bottom surface was gradually lowered between the 60% and 80% chord locations 231, while the top surface was moved upward starting at 50% and continuing to the 100% location 232 to increase the overall depth to accommodate the aft spar and the design of the flap.

The bottom surface was moved upward starting from 80% and continuing to the 100% location 233 to be coincident with the lower surface of the flap airfoil section. These differences between the NACA 43015 airfoil section 212 and the modified section 214, along with a depiction of the leading edge cuff, are shown in FIG. 27 [NACA 43015 vs Modified Airfoil & Cuff].

When developing the Sherpa Model K-650T, it became necessary to design a new wing section, FIG. 20 [Modified NASA MS(1)-0317 Airfoil], due to the significant increase in load capacity and greater fuel capacity. Consequently, this lead to development of a highly modified version of a NASA MS(1)-0317 airfoil section 190.

Though exhibiting a significantly higher pitching moment, it provided a larger cross-sectional area for increased fuel capacity, developed higher lift with lower drag, and allow the aft spar to be lighter and stronger due to the significantly thicker aft body. In addition, the NASA MS(1)-0317 airfoil section was modified to simulate the effect of a wing “cuff” 215 or drooped leading edge, also referred to as a leading edge flap. The modifications effectively changed the camber line in a manner that allows the airfoil section to operate at a higher angle-of-attach before stalling.

The design philosophy of the high-lift and roll control devices for both Models was unchanged, though the dimensional details to achieve the desired outcome are somewhat different. A single slotted Fowler flap was chosen due to simplicity of design and ability to develop large amounts of lift without requiring an excessive angle-of-attack.

The flap was designed to translate as far aft as possible to maximize lift while maintaining a low aircraft deck angle for greater visibility during landing. A large flap wingspan ratio was used to further enhance lift during low speed flight.

An external flap track design was used to facilitate the large amount of flap translation, while maintaining simplicity of maintenance and reducing design complexity and weight. The large pitching moments that accompany this type of arrangement required the incorporation of a variable incidence horizontal stabilizer.

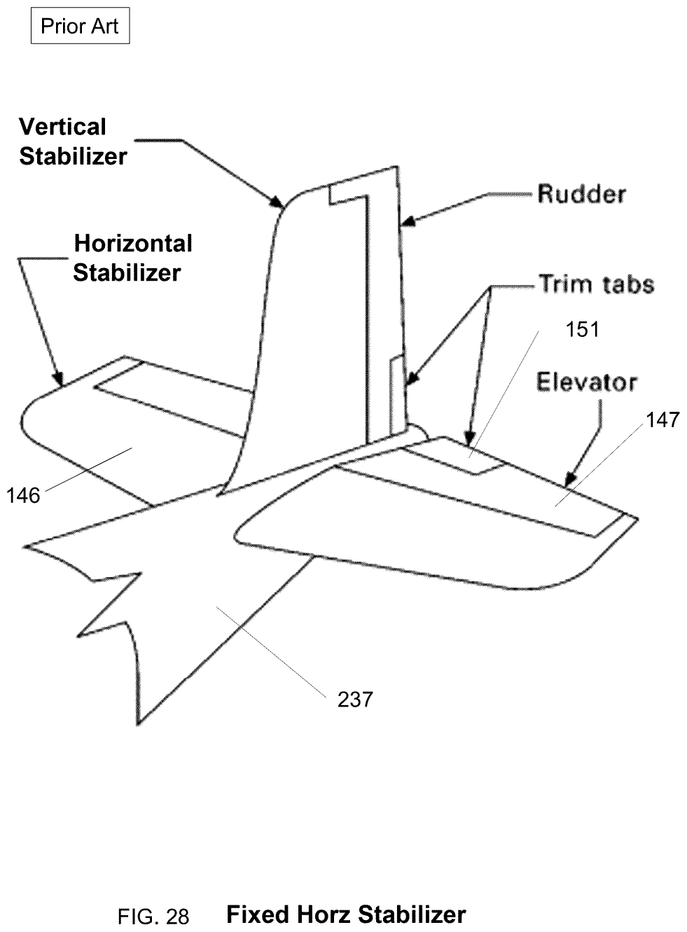

As shown in FIG. 28 [Fixed Horz Stabilizer] most light airplanes attach the horizontal stabilizer 146 to the fuselage 237 at a fixed angle to provide the balancing force required for stable flight at cruise speed. As the speed and/or airplane configuration changes, e.g. flaps are extended, the required balancing force changes. To compensate for the changing balance force in flight a plain flap referred to as an elevator 147 is attached to the trailing edge of the stabilizer that can deflect both upward and downward. This deflection changes the chamber of the horizontal tail; therefore, changing the balance force. The drag produced by the tail using this method can only be optimized for one speed, i.e. cruise speed. This combination of horizontal stabilizer, elevator is referred to as the horizontal tail and is normally comprised of a symmetrical airfoil section when used on light aircraft.

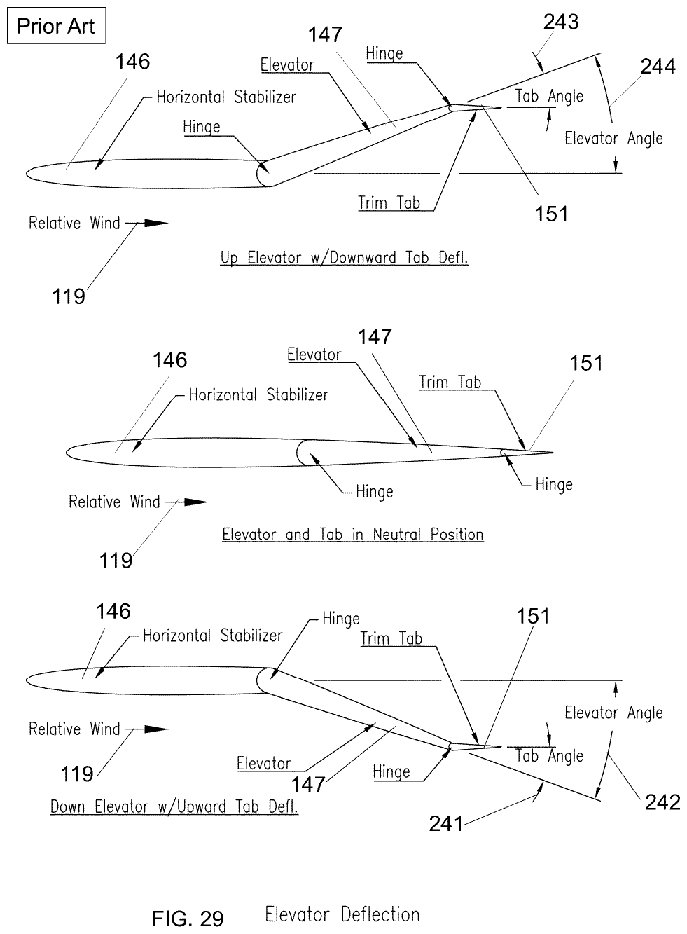

The common method used to reduce pilot load produced when the elevator 147 needs to be deflected for long periods is to attach a trim tab 151 (a small plain flap) to the trailing edge of the elevator, as shown in FIG. 29 [Elevator Deflection], that can deflect both upward 241 causing the elevator to rotate downward 242 and downward 243 causing the elevator to rotate upward 244. The moment about the elevator hinge produced by deflecting this tab will cause the elevator to move, thus changing the position (angle) of the elevator and the total load on the tail. The position of the trim tab is controlled by the pilot.

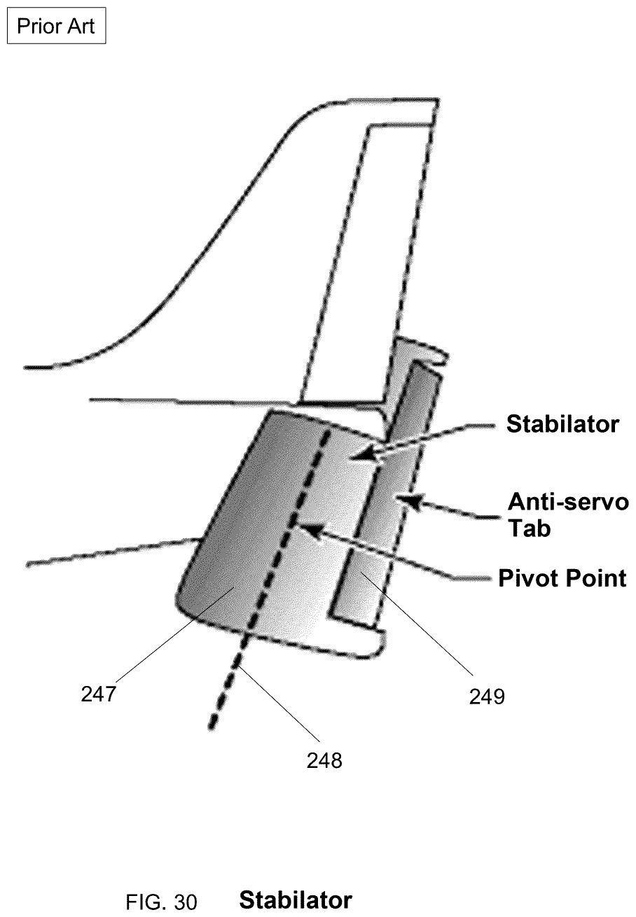

Another method is to use a flying tail sometimes referred to as a stabilator 247. FIG. 30 [Stabilator] Rather than consisting of a stabilizer 146, elevator 147, and trim tab 151, this method relies on the use of an airfoil section (usually symmetrical), similar to a small wing that pivots about an axis 248 near its aerodynamic center. Forces required to move the stabilator are small so a tab, known as an anti servo tab 249, is normally located at the trail edge to provide feedback (“feel”) to the pilot.

The anti servo tab is mostly controlled by the position of the stabilator by mechanical means while the position of the tab can also be controlled by the pilot to a much lesser extent to act like a trim tab. While this method optimizes the drag at any speed, it tends to not be as powerful in producing balancing forces.

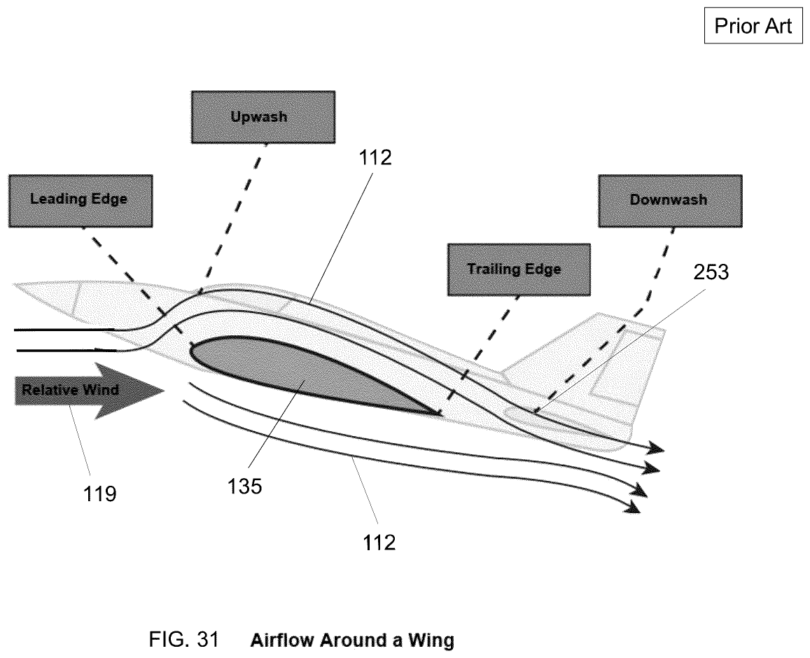

FIG. 31 [Airflow Around a Wing] depicts the airflow 112 around a wing 135 operating at a positive angle of attack 118 with respect to the relative wind 119. As speeds change, the wing AOA changes as does the relative wind direction at the tail 253 (downwash).

The previous methods work fine when the change in downwash angle is reasonable small. When the downwash angles become large the first method tends to be prone to leading edge stalling, which typically leads to complete and dangerous loss of tail balance forces. The second method somewhat alleviates this condition; however, it typically cannot produce as large a balancing force as the first method.

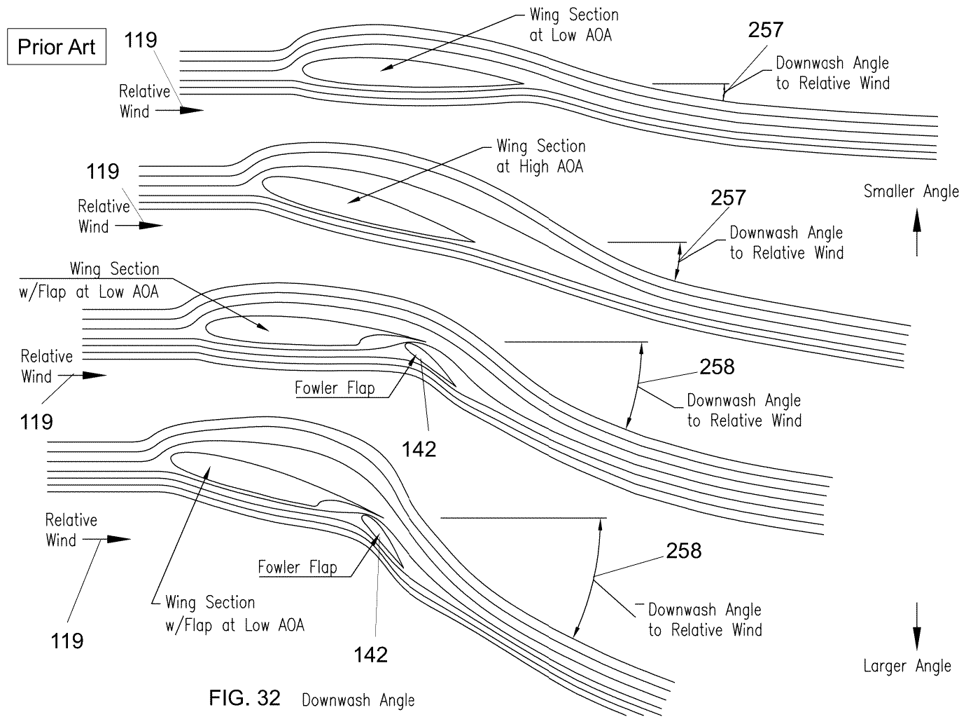

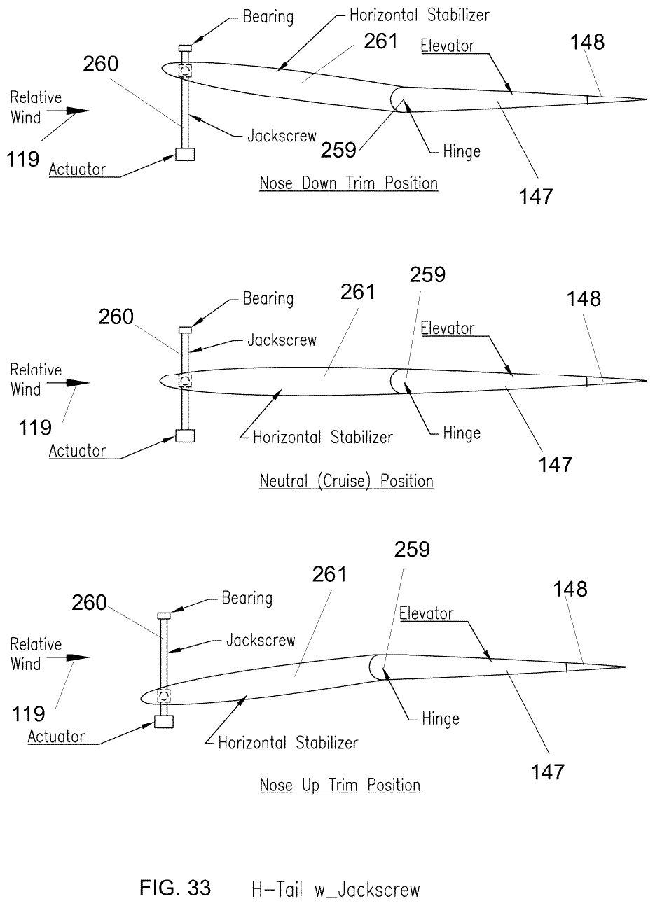

FIG. 32 [Downwash Angle] depicts how downwash angles are affected by angle of attack 118 and flap deflection. As the wing angle of attack increases the downwash angle 257 behind the wing increases. Because large Fowler flaps 142 with large translations produce large downwash angles 258 when fully extended, the Sherpa utilizes a variable incidence horizontal tail that pivots about a point just forward of the elevator hinge line 259 and has characteristics similar to both of the aforementioned methods. The Sherpa uses a jackscrew 260 to adjust the leading edge of the variable incidence horizontal stabilizer 261 allowing the angle of the stabilizer to adjust more optimally to the relative wind 119 when operating under high downwash conditions. FIG. 33 [H-Tail w_Jackscrew]

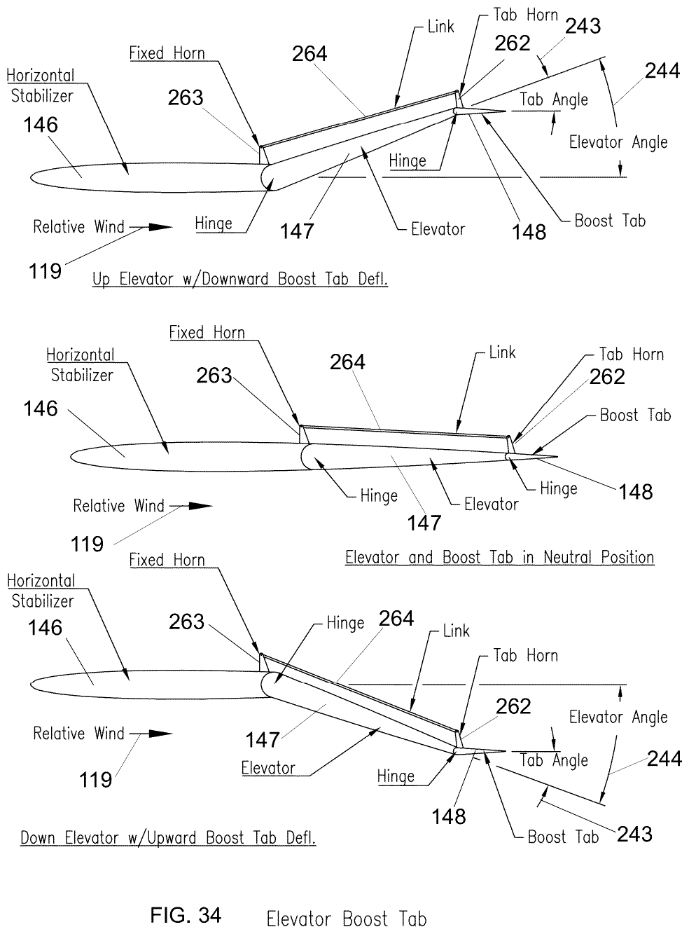

Changing the position of the variable incidence horizontal stabilizer 261 with the jack screw 260 provides a similar effect as the trim tab 151 in that this will also change the total load on the tail providing long duration reduction in pilot load requirements. The Sherpa also uses a small tab 148, shown in FIG. 34 [Elevator Boost Tab] attached to the trailing edge of the elevator 147, properly know as a linked or boost tab, (note that many technologists and engineers in this field incorrectly refer to this tab as a servo tab) that can deflect both upward and downward, but for a different reason. It is used to assist the pilot when deflecting the elevator and is controlled mechanically by the amount of elevator deflection.

A control horn 262 is attached to the linked tab 148 just aft of its hinge and another control horn 263 is attached to the horizontal stabilizer just forward of the elevator hinge and are connected by a connecting link 264. When the elevator is moved upward the link forces the linked tab to move downward producing an upward aerodynamic force acting near the trailing edge of the elevator reducing the amount of force required by the pilot to move the elevator. When the elevator is moved downward the link forces the linked (boost) tab to move upward producing a downward aerodynamic force acting near the trailing edge of the elevator, also assisting the pilot in moving the elevator more easily.

Larger balancing loads can be produced by the stabilizer and elevator using this combination. Also, horizontal tail trim drag can be reduced throughout the speed range. The use of this type of horizontal tail allows the Sherpa design to maximize the lift capability of its wing. This is a much more effective method in STOL operations. Large jets such as the Boeing 737 that utilize large flap translation and deflection use similar horizontal tail arrangements; though, there are differences in details due to the need to operate near and sometimes into the transonic flight envelope.

Of the four common types of trailing edge flaps used split flaps 170 are a type of flap where only the lower surface of the aft portion of wing is deflected about a single hinge line located near the lower surface. A plain flap 171 deflects the complete aft portion of the wing section aft of a hinge line that is typically located within the contours of the wing or just outside of the lower wing surface and is somewhat more efficient than a plain flap.

Single slotted flaps 172 are airfoil shaped sections that can fit within the contour of the aft wing and is deflected about a hinge line that located some distance below the lower wing surface. As this flap is deployed a gap (slot) is developed between the lower wing surface and the upper flap surface, creating a high velocity airflow that postpones the separation of air from the upper flap surface. This type of flap can be optimized for only one specific amount of deflection. Occasionally a slotted flap is added in front of the main slotted flap and in some cases a plain or slotted flap is added to the aft end of the initial slotted flap for increase performance; though, this increases mechanical complexity to the design.

The fourth type of flap is a Fowler flap 142 which is similar to a slotted flap with the exception that it translates as it rotates rather than deflecting about a single hinge line. This action allows for optimization of all intermediate flap deflections. However, the Fowler flap translates or slides forward and aftward (i.e., thereby respectively decreasing and increasing the surface area of the wing and therefore also respectively decreasing and increasing lift), in addition to pivoting or deflecting at full deployment. Similar to the single slotted flap additional configurations of plain and slotted flaps have been added to Fowler flaps in complex designs.

Pivoting or deflecting the trailing edge of the flap at a downward angle during the translating deployment further increases lift. To avoid flow separation from the upper surface of the flap, Fowler flaps are limited to a maximum deflection of 40°. This limitation reduces the potential loss of horizontal tail effectiveness due to flow interference (turbulence). Many high performance turbine powered airplanes and business jets utilize Fowler flaps. Large jet aircraft typically used by air carriers in operating airlines use complicated combinations of Fowler, slotted, and plain flaps.

Ailerons 144 are a type of plain flap placed near the trailing edge of a wing and placed equidistant on opposite sides of the airplane centerline. They typically are the primary means of roll control for most light airplanes and deflect in opposite directions in operation. The downward deflecting aileron adds lift to one side of the wing while the upward deflecting one reduces lift on the opposite side creating an unbalanced moment about the airplane centerline, causing the aircraft to roll.

Spoilers are used to reduce (kill) lift over a wing and increase drag. The best way to accomplish this is for the spoiler to be positioned near the maximum thickness of the airfoil section and protrude perpendicular to the airstream as is commonly seen on sailplanes.

When using a spoiler for roll control (spoileron), it is necessary for the spoiler in each wing panel to be operated independently to develop an asymmetry in lift about the center axis of the airplane to produce a rolling moment. The spoileron was also moved closer to the trailing edge of the wing to reduce undesirable time lag.

Though not all airplanes use spoilerons 145 to augment and improve roll of the aircraft, spoilerons, when used in combination with flaps, provide basic roll control by modifying the airflow over their respective sections of, or extensions across, the flaps as they open, thereby reducing lift and augmenting roll. Spoilerons are typically used on aircraft that incorporate large span flaps into their designs.

Some advanced aircraft jets like DC-10, 737 Max and L1011 use spoilers to maintain optimal pitch attitude in landing configurations. This type of system is automated to assist the pilot in these airplanes during the final phase of landing. The phenomenon is mostly present in heavy airplanes that are slow to react in pitch due to their large inertia. The Sherpa exhibits no noticeable pitch change due to spoileron activation and does not require such a system.

Commercial airlines use spoilers in advanced airplanes to serve three main purposes: 1) used independently, right side from left side, they provide roll control in conjunction with the use of relatively small ailerons, 2) both sides can be deployed simultaneously at both high and low speeds to control descent rates and reduce speed, and 3) they are deployed to maximum extension after touchdown to drastically reduce lift to help keep the airplane on the ground and to slow the airplane in conjunction with thrust reversers and wheel brakes. Each wing panel has multiple spoilers that can operate in stages independently of one another.

The following is specific to the use of spoilerons 145 in conjunction with single-slotted 172 and Fowler flaps 142. As flaps are extended the effectiveness of the spoileron increases. Once the flap reaches full extension, the air velocity through the developed slot is high to achieve maximum lift. This creates a low pressure region on the lower side of the spoileron making it difficult to initially deploy. The result is an undesirable condition referred to as a high break-out stick forces. Once the spoileron begins to deploy, this condition is self-correcting.

The gap (slot) between the flap and flap cove on the Sherpa remains constant from the inboard end of the spoileron to the inboard end of the flap throughout all deployed positions. The size of the gap used on the Sherpa was increased to lower the velocity, reducing the amount of low pressure present on the lower side of the spoileron while still allowing an adequately high velocity airflow through the slot to keep the air on the upper surface of the flap from separating. Finding the correct relationship was difficult.

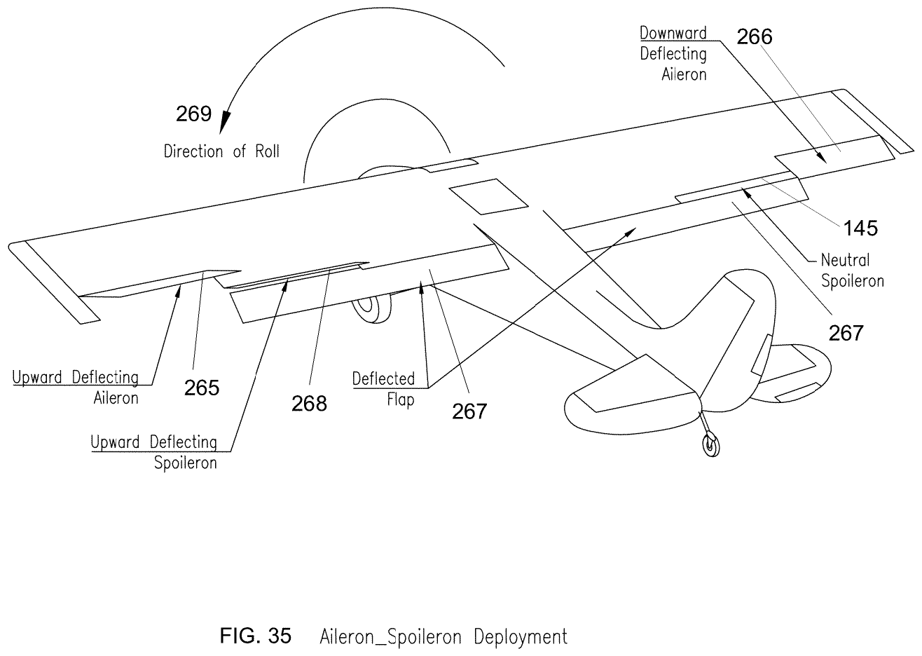

The spoileron 145 is located near the wing trailing edge and over the flap. This location was chosen both to reduce control system lag and to provide greater effect at low speed. Activation of the spoileron is synchronized with the aileron 144, FIG. 35 [Aileron_Spoileron Deployment]. Both the aileron and spoileron are in a neutral position during level flight.

The size of gap between the flap and trailing edge of the spoileron is critical to achieve desired stick force gradients. Location of the flap nose with regard to the spoileron trailing edge is also critical to reducing the force required during initial deployment.

For a variety of reasons spoilerons used to enhance roll are usually fabricated more like a flap that is parallel to the airstream when not deployed. When actuated, the spoileron moves into the airstream similar to an upward deflecting flap and somewhat proportionally with the upward traveling aileron. With the flaps retracted the spoileron used on the Sherpa has minimal effect on the total roll control of the airplane. When the flaps are fully deployed 267 the upward deflecting spoileron 268 has a significant effect in assisting the ailerons to produce a rolling moment.

Only the spoileron 145 on the same side of the aircraft centerline as the up moving aileron 265 is deployed, while the spoileron on the side near the down moving aileron 266 remains in its neutral position. This causes an additional reduction of lift on the side of the deployed spoileron assisting the upward moving aileron in reducing lift, generating a rolling motion 269 in the direction of the upward moving aileron.

When flying the Sherpa in level flight with flaps deployed the optimized gap between the flap and flap cove remain approximately the same spanwise from the wing root (the location where the wing joins the fuselage) to the outboard end of the spoileron. As the spoileron deploys the size of the gap increases, causing the effectiveness of the flap to decrease and the wing to lose lift along the spoileron span.

Design choices aimed to maximize lift and minimize drag generated by the flap, and to minimize pitching moment effect on the spoileron, were made to optimize the performance of both the flap and the deploying spoileron. Consequently, the size of gap between the flap and flap cove (the location where the flap resides when fully retracted) becomes critical to maintaining the ideal performance.

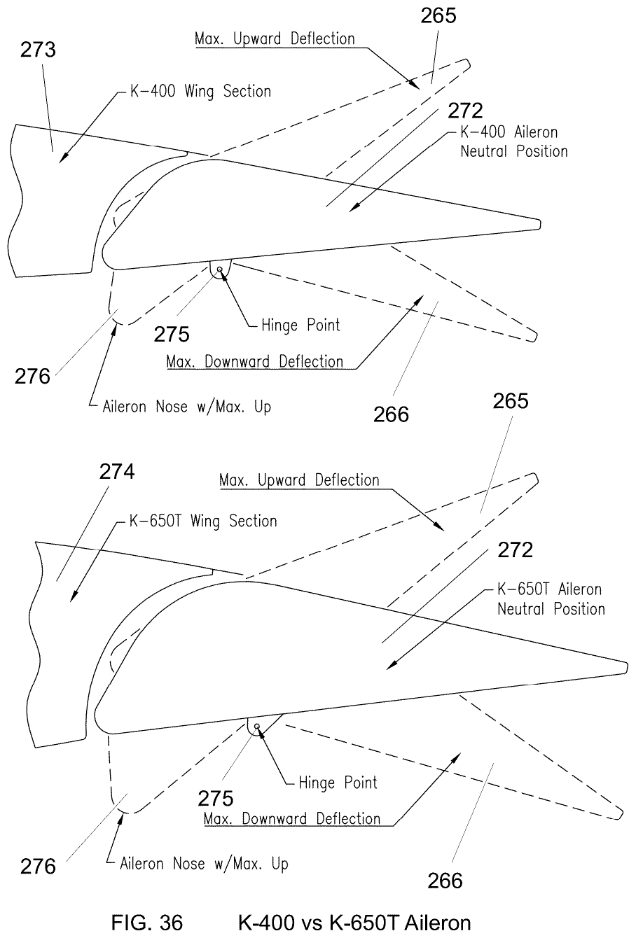

Roll control on the Sherpa is maintained by combining a Frise type aileron 272 and an aft mounted spoileron. The aileron was designed to reduce the stick force felt by the pilot and the amount of adverse yaw introduced when deflected. FIG. 36 [K-400 vs K-650T Aileron] depicts a comparison of the K-400 273 and K-650T 274 aileron movement. The spoileron was incorporated to increase the rolling moment when operating at low speeds, while having minimal effect during cruise flight.

Adverse yaw is a tendency of an airplane to turn in the opposite direction intended when initiating roll. This is due to the difference in both parasitic drag (profile drag) and induced drag (drag due to lift) about the airplane centerline when deflecting ailerons by the same amount. This difference is caused by the upward deflecting aileron 265 moving into lower pressure air and reducing lift, while the downward deflecting one 266 moves into higher pressure air and increases lift.

When the aileron is deflected upward the corresponding spoileron also deflects upward. If the aileron is deflected downward the spoileron remains approximately in the neutral position during this deflection. With the flap in the retracted position deployment of the spoileron produces minimal effect. Maximum rolling moment effectiveness is reached when the flap is in the fully extended position and the spoileron is full deployed. This greatly increases the rolling moment during low speed flight.

The location of the Frise aileron hinge line 275 is critical to reduce the stick force produced when deflecting the roll control surfaces and in producing an acceptable stick force gradient. A simplification of this interrelationship between the vertical and horizontal location of the hinge line would be to assume the portion of aileron forward of the hinge line reduces the hinge moment, and hence also stick force. Lowering the vertical location of the hinge causes the nose of the aileron 276 to protrude further into the airstream assists in reducing hinge moment during initial deployment and will assist in reducing adverse yaw.

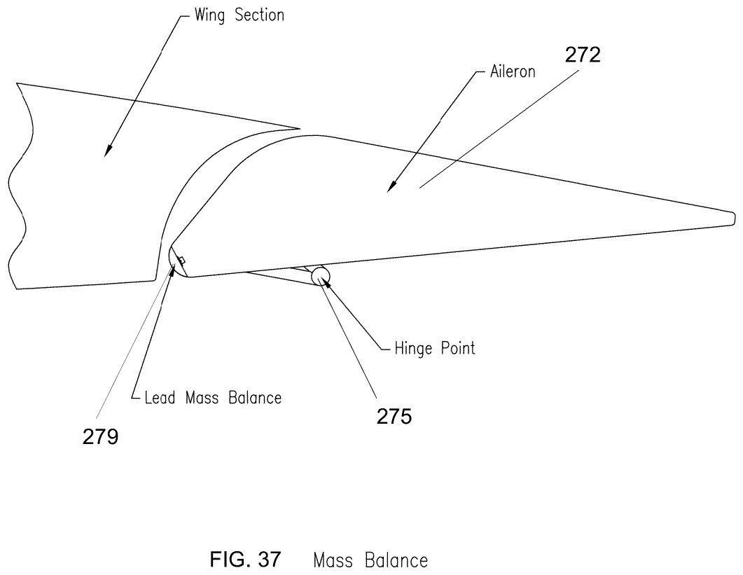

It should be noted that mass balancing of an aileron 272 is usually necessary to prevent flutter and all Sherpa models incorporate such a balance. FIG. 37 [Mass Balance] This can be accomplished by adding a concentrated mass 279, usually lead, in the aileron forward of the hinge line 275. Inadequate balancing can cause catastrophic failure, while over balancing will result in undesirable control stick stability (stick hunting).

The location of these devices across the wingspan is also a tradeoff between wing lift, control effectiveness and stick force requirements. The aileron hinge point's relationship to the wing and its relationship to the aileron are critical to achieve the specified design parameters.

To enhance the performance and load carrying capability of the Sherpa K-400, the Sherpa K-650T was developed. The original K-400 was fitted with a certified experimental 450 HP twin turbocharged reciprocating engine, then later changed to a normally aspirated 400 HP engine due to availability issues. All K-400 performance values herein are based on this 400 HP normally aspirated reciprocating engine. While the K-400 has a gross weight (GW) of 5500 lbs and currently utilized the 400 HP normally aspirated reciprocating engine, the K-650T has a gross weight of 6500 lbs and was fitted with a turbine engine derated to 808 HP. This document will primarily focus on differences in the wing aerodynamic design between the models. The accompanying drawings and aircraft comparison data details many of the geometric and numeric differences in the wing designs.

To achieve the desired speed performance the wing was enlarged and the wing section was changed. The wing area increased from 264 sq. ft. to 318 sq. ft. and to keep the wing aspect ratio approximately the same the wingspan was change from 44 ft. to 47.7 ft. and the wing cord increased from 72 in. to 80 in.

The increase in wingspan was used to maintain similar climb and service ceiling values. In addition to the increased wing area the effective flap span ratio was kept similar as was the aileron span ratio to maintain similar low speed characteristics. The K-400 has a similar wingspan as the Kodiak (meaning the Quest/Daher Kodiak 100), while the K-650T is closer to the larger span of the Caravan (meaning the Cessna Caravan I). Wing area of the K-400 is similar to the Caravan and Kodiak, while the K-650T has a larger area.

In order to provide significantly more room for fuel storage and to increase lift for low speed flight, a new wing section was developed. The shape of the section allows for more fuel storage and the deeper aft section allows for a taller spar to carry more load while being lighter.

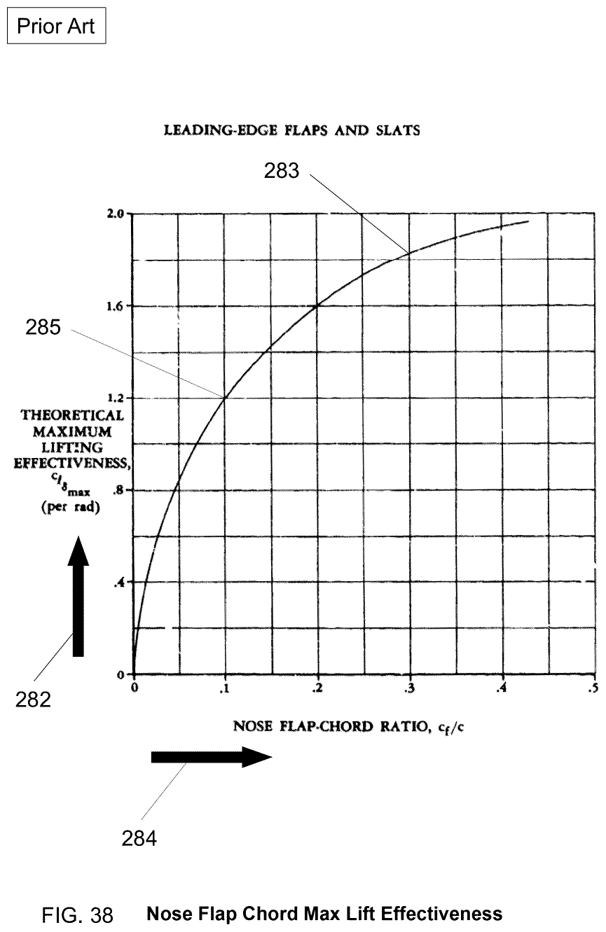

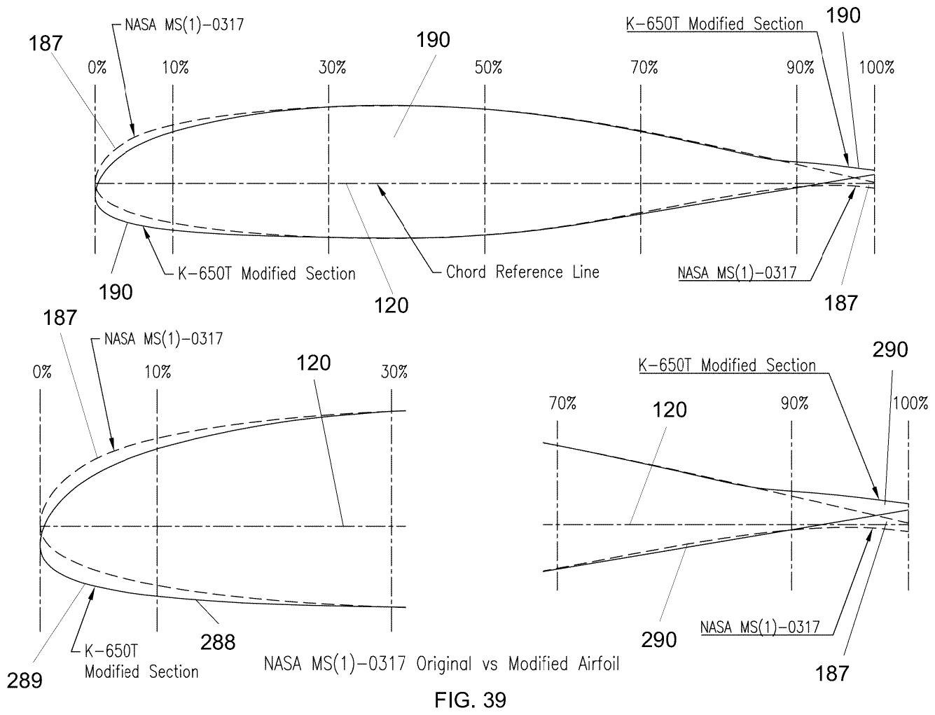

Effectiveness of leading edge flaps 282 is partially dependent on the chord of the flap with respect to the chord of the airfoil section. FIG. 38 [Nose Flap Chord Max Lift Effectiveness]A more rapid decrease in effectiveness 283 occurs once the leading edge flap chord ratio 284 exceeds 0.30 (30%) and a very rapid increase in effectiveness 285 occurring at chord ratios of less than 0.10 (10%). The wing section used on the K-650T 190 is a highly modified version of a NASA MS(1)-0317 airfoil section 187. FIG. 39 [NASA MS(1)-0317 Original vs Modified Airfoil] Simply speaking, the nose of the airfoil section was changed in a way similar to adding a slightly deflected, dual stage leading edge flap 288 starting around 30% of the airfoil section chord, then becoming more pronounced forward of 10% 289.

The aft portion of the airfoil section, starting around the 50% chord location, was modified to enhance pressure recovery. Starting at 70% chord the airfoil section coincident with the flap span was highly modified 290 to be coincident with the flap chord to rectify issues that developed with the deployment of the wing flap. Significant improvements in increasing lift were accomplished with these changes while maintaining relatively low drag.

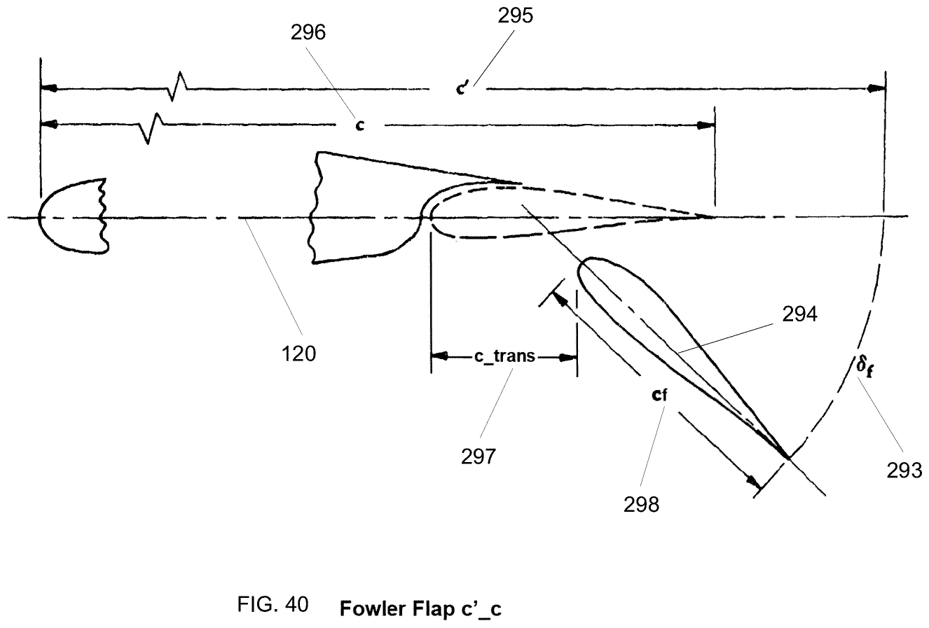

In addition to the above advantages, the new airfoil section provided room for a taller aft wing spar that allowed the spar to be stronger and lighter. It also allowed for the incorporation of a thicker Fowler flap with a larger chord ratio, being the ratio of flap chord 298 with respect to wing chord 296, producing more lift than the original Fowler flap used on the K-400. The translation of a Fowler flap can be thought of as a way to increase wing area. FIG. 40 [Fowler Flap c′_c] Deflection of the flap 293 measured by the angle between the wing chord reference line 120 and the flap chord reference line 294 as well as increasing wing area increases lift and lowers stall speeds.

Single slotted flaps can only be optimized for one specific deflection angle, normally full deflection. Fowler flaps allow for larger flap translation 295 with respect to the wing chord 296 (c′/c increase) than is practical with the simpler single-slotted flap designs. A more generic way of referring to flap translation sometimes used is c_trans/cf, being the ratio of translation of the flap leading edge 297 (c_trans) in percentage of trailing edge flap chord 298.

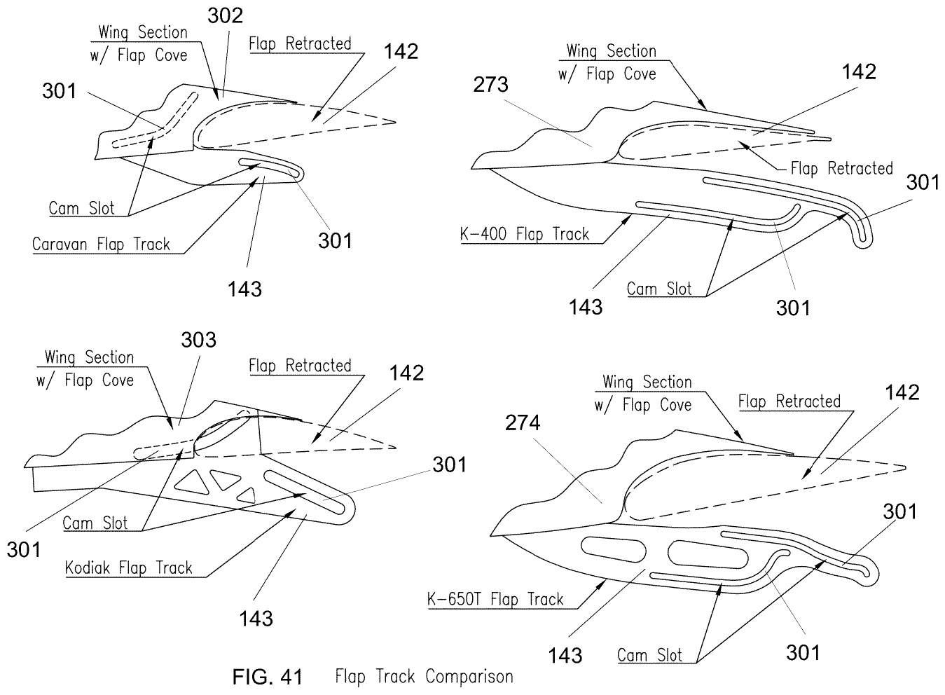

The fully external flap tracks 143 used on the Sherpa models are somewhat unique. Most light aircraft Fowler flap cams 301 are mostly or entirely within the contours of the wing section. FIG. 41 [Flap Track Comparison] shows the difference between the Caravan 302 and Kodiak's 303 partially exposed flap track cam system and the fully exposed cam system used on the Sherpa model K-400 273 and K-650T 274.

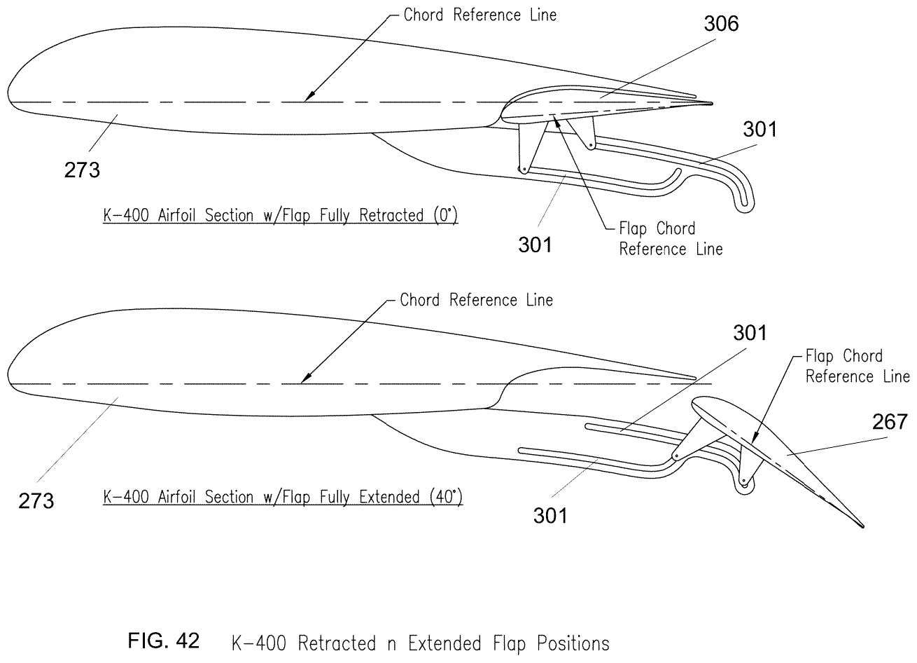

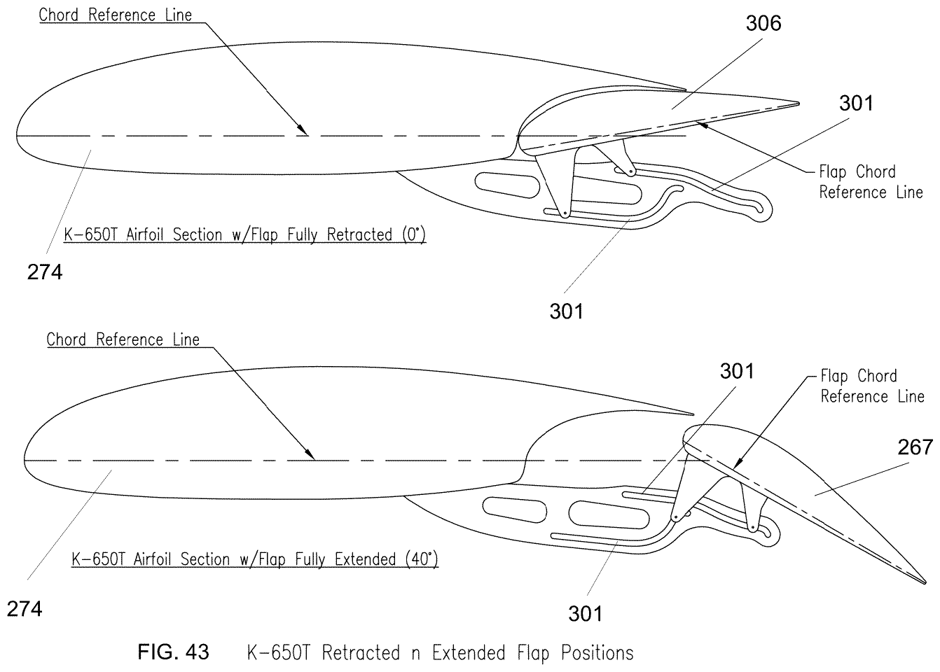

Sherpa uses this external design to allow for larger flap translations from fully retracted 306 to fully extended 267 without the complex mechanisms used on large transport aircraft. FIG. 42 [K-400 Retracted n Extended Hap Positions] To optimize the flap deployment, flap track cams 301 used on the K-650T 274 were modified due to the difference in airfoil section design compared those used on the K-400 273. FIG. 43 [K-650T Retracted n Extended Flap Positions]

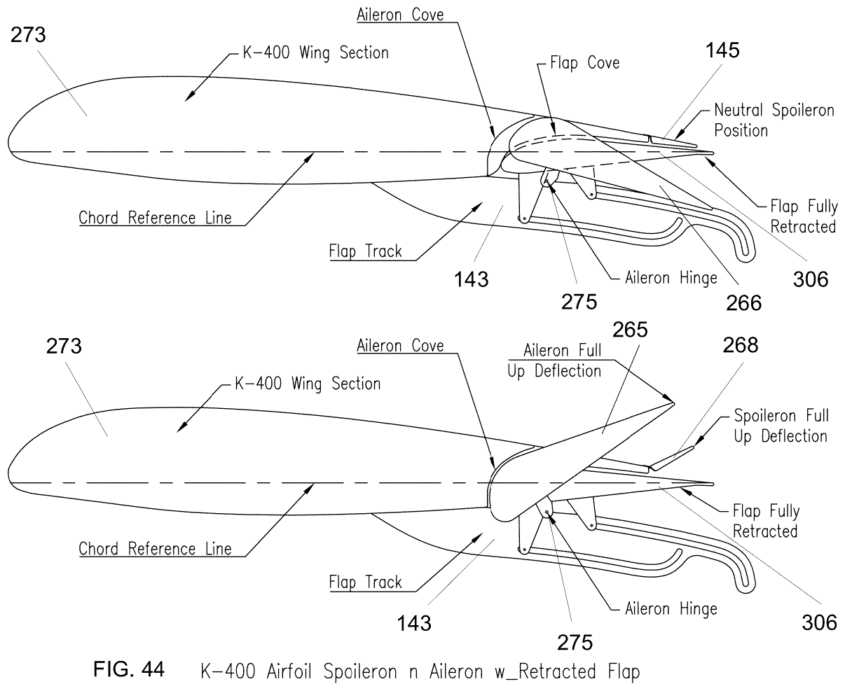

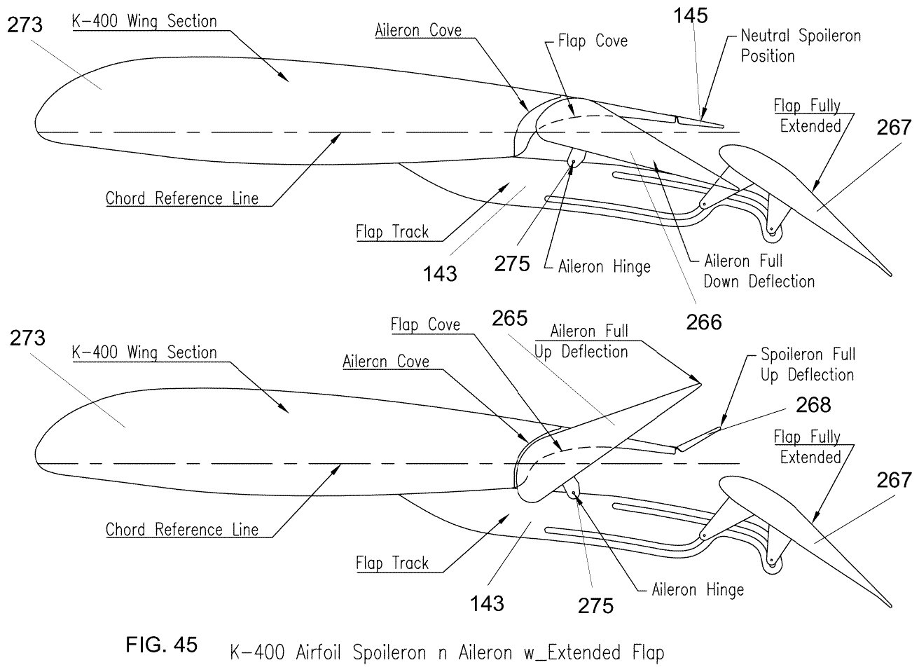

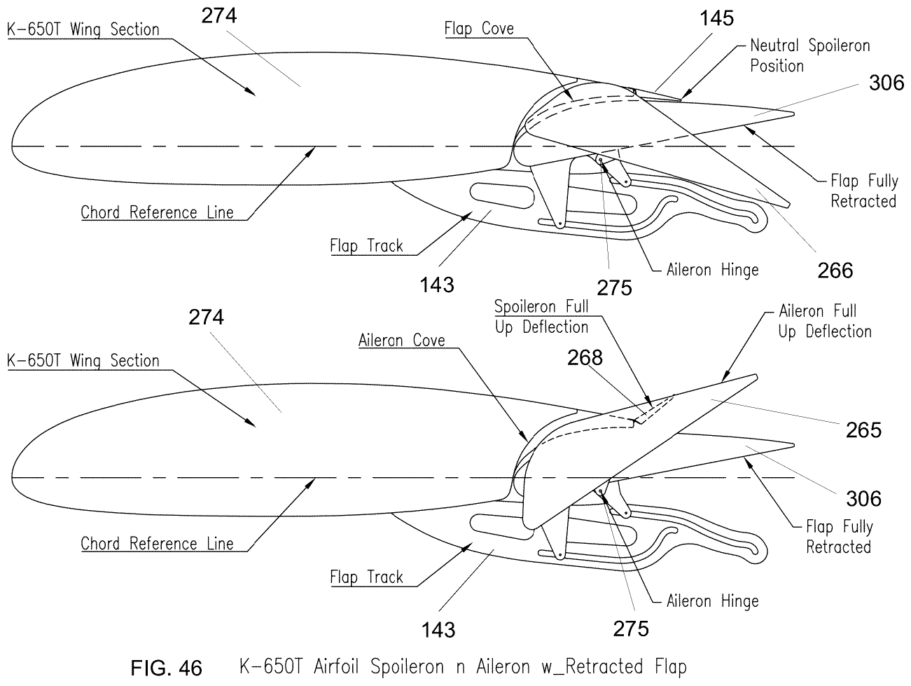

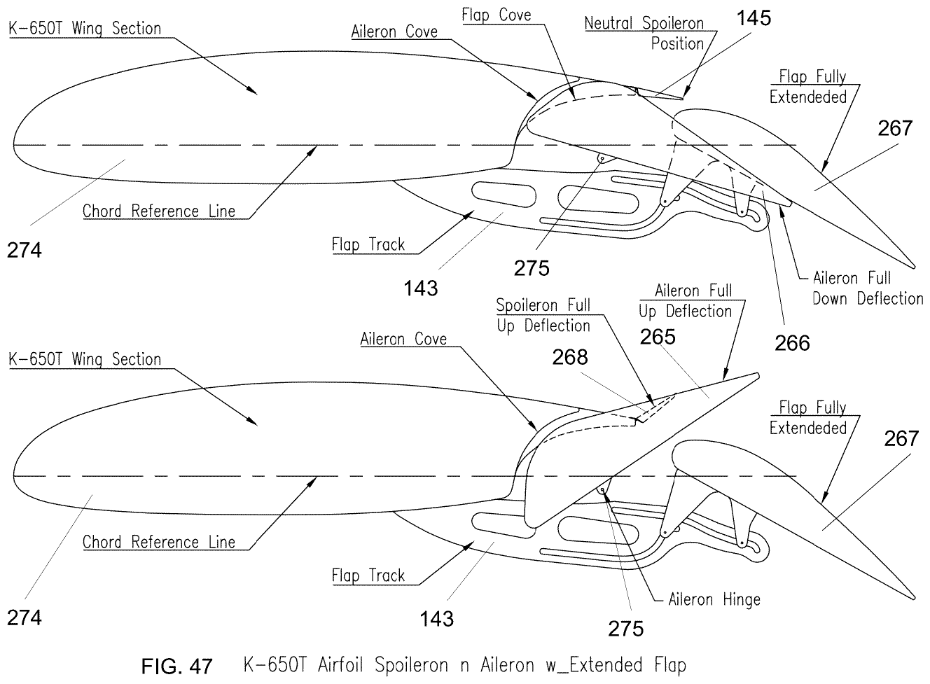

In order to maintain acceptable roll control authority in the low speed realm that the Sherpa models can operate in, it was necessary to combine a large chord Frise type aileron with a spoileron 145 that deploys 268 over the wing flap when retracted 306 or extended 267. FIG. 44 [K-400 Airfoil Spoileron n Aileron w_Retracted Flap], FIG. 45 [K-400 Airfoil Spoileron n Aileron w_Extended Flap], FIG. 46 [K-650T Airfoil Spoileron n Aileron w_Retracted Flap], and FIG. 47 [K-650T Airfoil Spoileron n Aileron w_Extended Flap]. Large chord ailerons can produce unacceptably high hinge moments resulting in high control stick forces throughout the speed range.

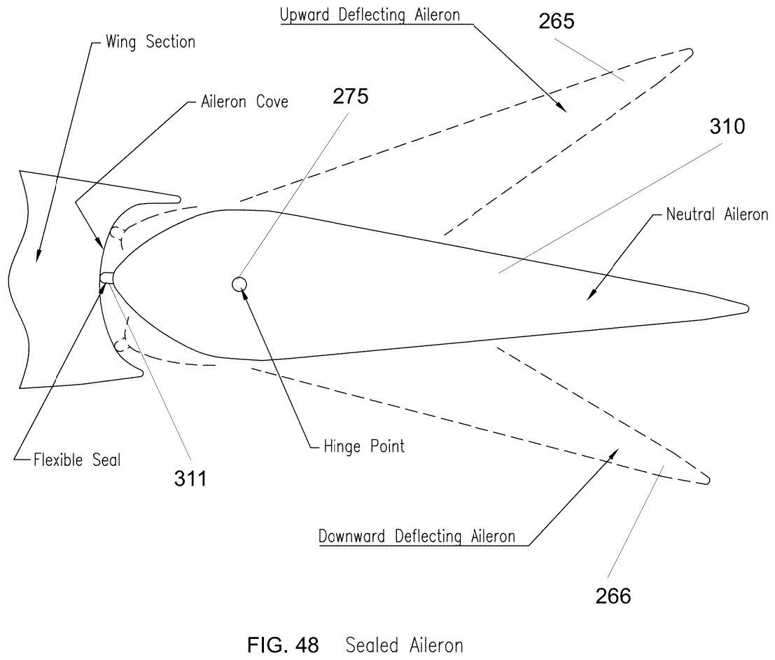

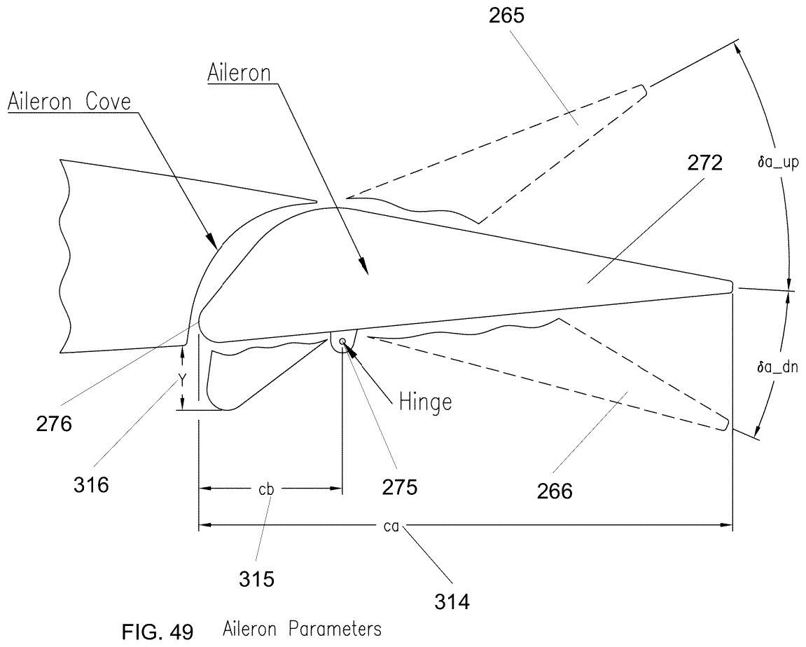

A sealed type aileron 310 with a displaced hinge line 275 that utilized a flexible seal 311 to prevent airflow between the upper and lower surfaces when deflecting the aileron upward 265 or downward 266 was used on the original Sherpa model K-300. It was determined that this type of aileron configuration in combination with the large aileron chord 314 (ca) was developing excessively high hinge moments. To compensate for this effect, it was necessary to develop a Frise type aileron 272 for the K-400 and K-650T with a nose shape 276 and hinge location 275 that would reduce these hinge moments. The horizontal distance from the aileron leading edge to the hinge 315 (cb) with respect to the aileron chord 314 (ca), the aileron nose overhang ratio (cb/ca), was increased from 21% used on the K-300 sealed aileron and K-400 Frise aileron to 31% on the K-650T, providing a larger overhang ratio. FIG. 48 [Sealed Aileron] and FIG. 49 [Aileron Parameters]

Additionally, the vertical location 316 of the aileron hinge 275 (y value) was changed on both the K-400 and K-650T allowing the nose to extend below the wing when the aileron is deflected upward 265. This is done to correct a phenomenon known as adverse yaw. The differential in upward 265 and downward 266 aileron deflection was also changed for this reason. Because the ailerons lose their effectiveness at low speeds when the flaps are deployed, a spoileron 145 is used to assist in controlling roll rate.

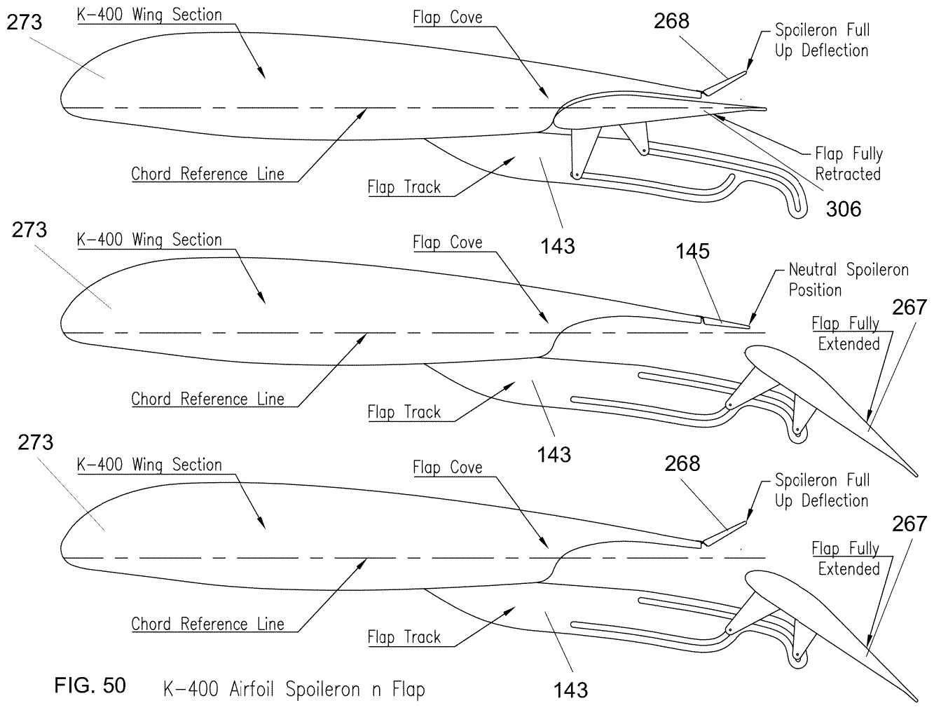

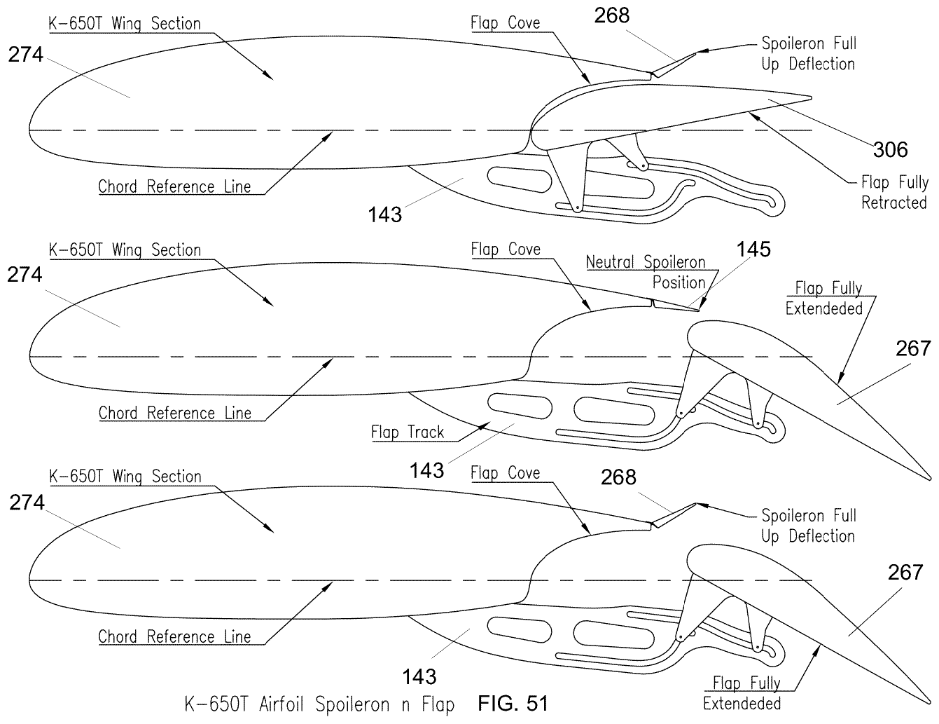

The spoileron is driven in a manner that allows upward deflection 268 when the aileron is deployed upward 265 and remains relatively neutral when the aileron is deployed downward 266. The spoileron is located over the outboard portion of the flap. When the flap is in the retracted position 306 deployment of the spoileron 268 has minimal effect. FIG. 50 [K-400 Airfoil Spoileron n Flap] and FIG. 51 [K-650T Airfoil Spoileron n Flap]

As the flap is deployed the deflected spoileron 268 becomes more effective. Maximum effectiveness occurs when the flap is fully extended 267. In this fully extended position, a strong venturi effect develops that causes high hinge moment on the spoileron 145 when in the neutral position. This effect can cause an undesirable control stick force gradient when the spoileron begins to deploy. Proper venturi velocity has a critical effect on the moment required to initialize the deployment of the spoileron and on the ability of the flap to develop maximum lift.

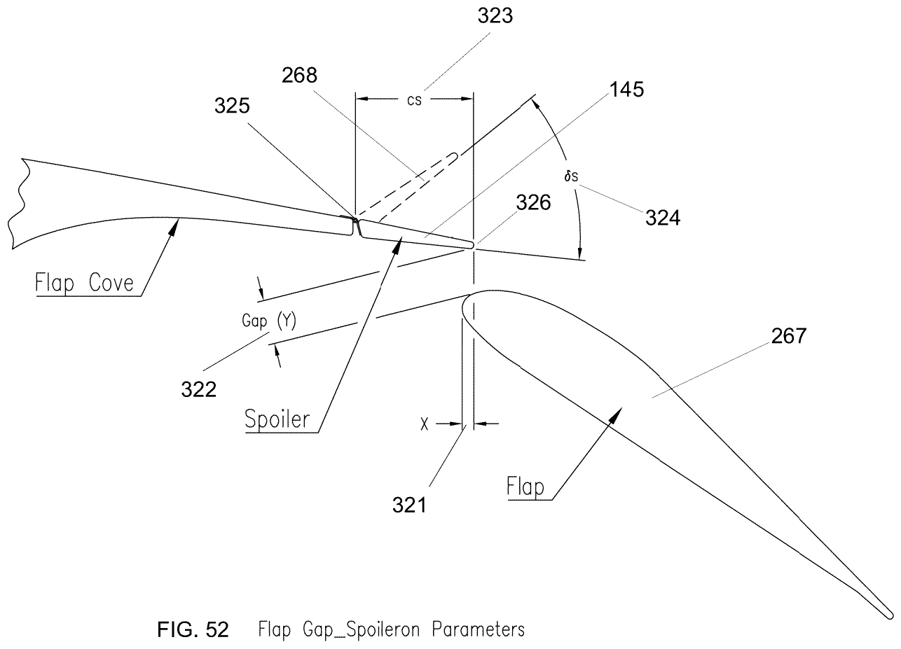

The horizontal distance from the spoileron trailing edge to the fully deflected flap leading edge 321 (x value) and the minimum distance between the spoileron trailing edge and the flap surface 322 (flap gap) measured with the spoileron 145 in the neutral position and the fully deflected flap 267 as well as the spoileron chord 323 are all critical to develop the desired operational parameters for both increased lift and acceptable control stick forces. It was necessary to increase the spoileron span, increase the spoileron deflection 324, and modify the location of the spoileron hinge and flap gap dimension on the K-650T due to the airfoil section change. FIG. 52 [Flap Gap_Spoileron Parameters] and FIG. 49 [Aileron Parameters]

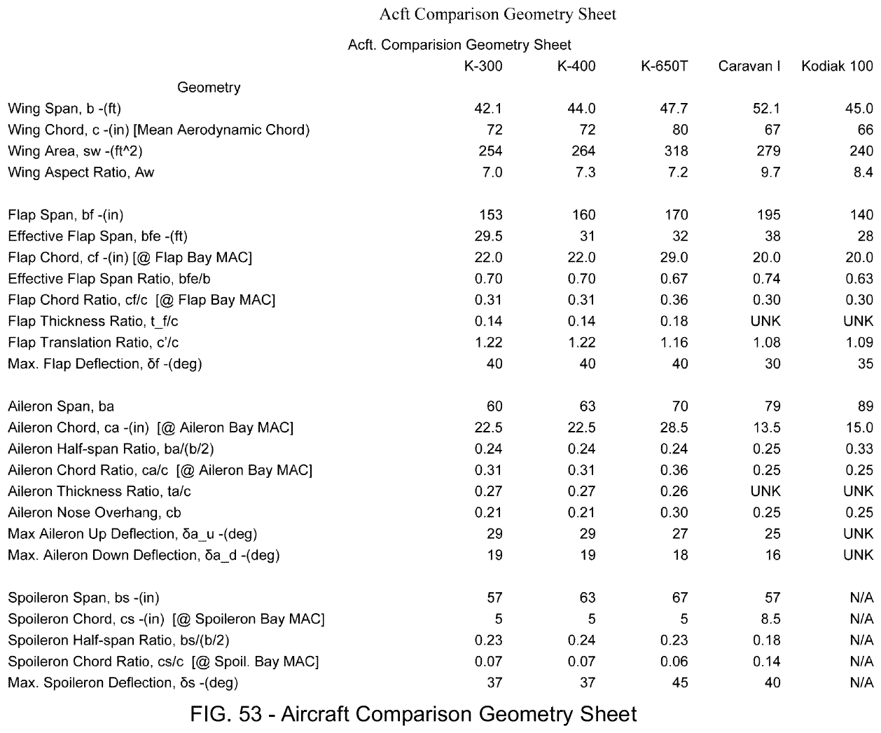

Comparison of the Sherpa Models basic wing geometry to the Cessna Caravan I and Quest/Daher Kodiak 100 Wings is shown in FIG. 53 [Aircraft Comparison Geometry Sheet].

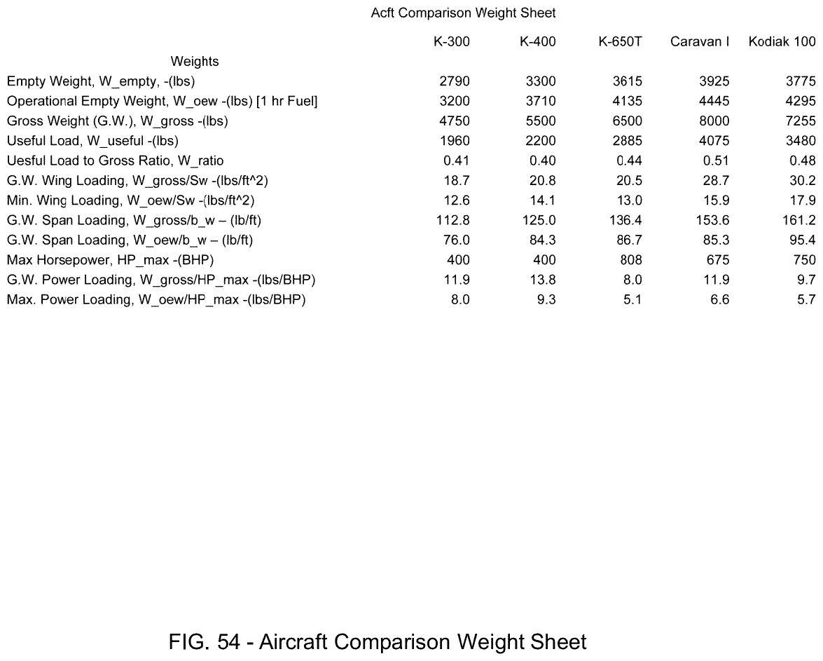

The aircraft performance values listed in the comparison data is based on internal Sherpa data for the K-400 and K-650T models. Values for the Caravan and Kodiak were derived from published pilot operating handbooks and other sources available in the public domain. The various operating weights of the airplanes are shown in FIG. 54 [Aircraft Comparison Weight Sheet].

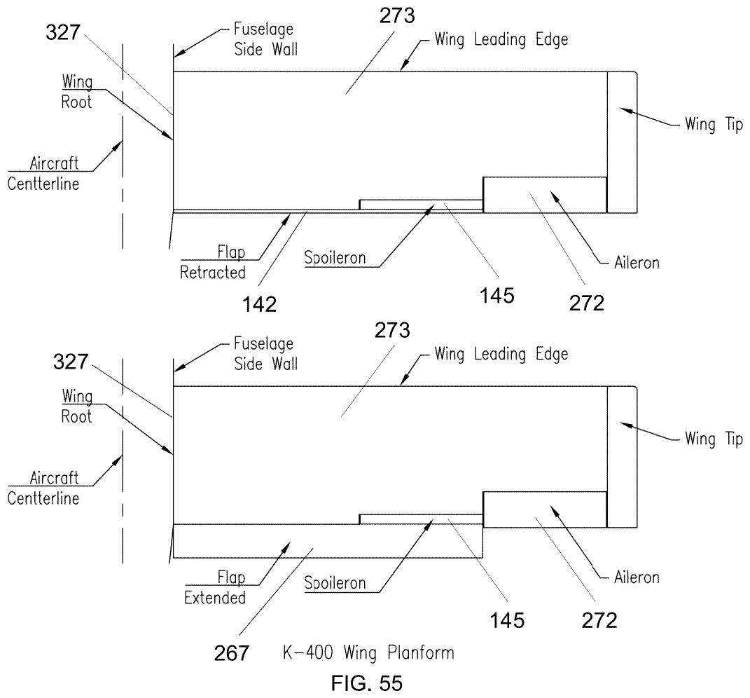

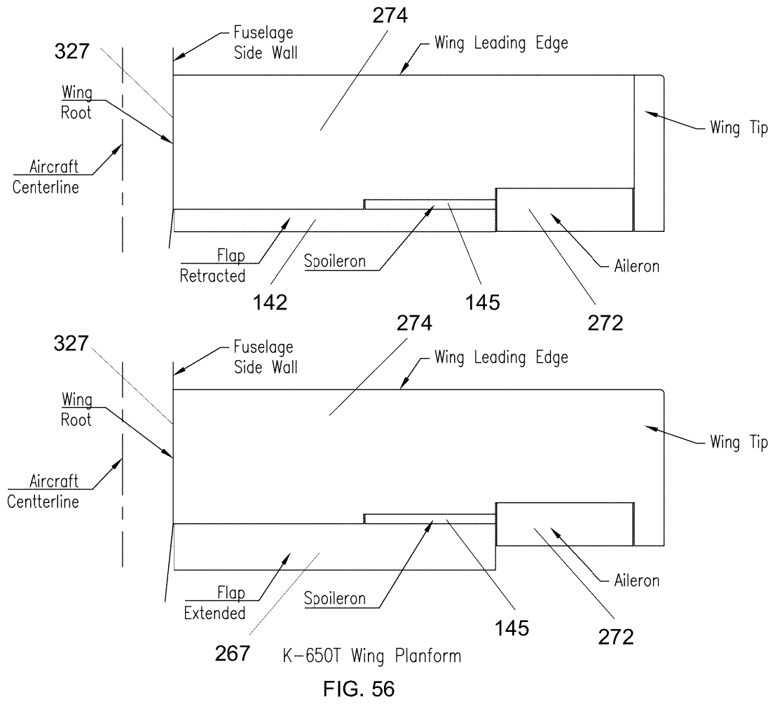

The wing planforms of the Sherpa models on the accompanying drawing, FIG. 55 [K-400 Wing Planform] and FIG. 56 [K-650T Wing Planform], show that the K-400 273 and K-650T 274 use a very similar non-tapering, rectangular wing. This was done in large part to simplify the design and parts inventory. Also, the use of a rectangular wing allows the stall to begin at the wing root 327 and minimal wing twist (washout) is required to protect the wing from tip stalling.

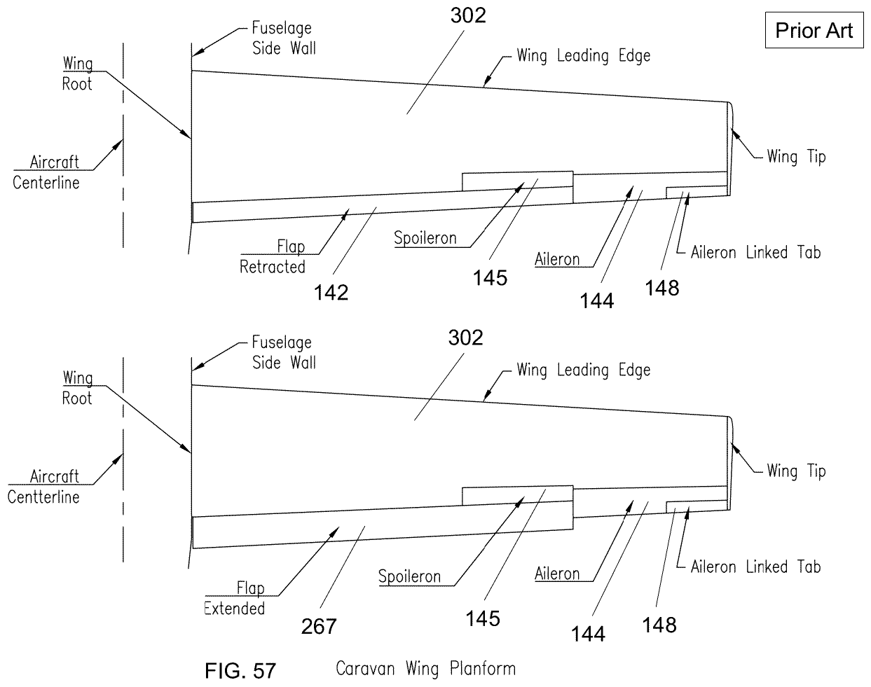

Both models were designed with the similar use of large span Fowler flaps 142 that translate a large percentage of their chord when extended 267. Large chord Frise ailerons 272 and spoilerons 145 over the outboard portions of the wing flap are used for roll control. The Caravan 302 utilizes a tapered wing with an approximate 1.7:1 taper ratio. FIG. 57 [Caravan Wing Planform] It utilizes large span Fowler flaps 142 that moderately translate when fully extended 267. Large chord ailerons 144 and spoilerons 145 over the outboard portions of the wing flap are also used. The large ailerons require the use of a linked tab 148 to reduce hinge moments so the control stick forces would not be excessive.

A significant amount of wing twist is required to protect the wing tip from stalling. While the flap span ratio is similar, it does not translate or deflect nearly as far as the Sherpa flaps. It also uses an aileron/spoileron combination; however, the aileron has a smaller chord ratio.

The spoileron has a larger chord and a smaller span ratio. It should be noted that the aileron incorporates a linked tab 148 to reduce aileron hinge moments. Because the Sherpa can operate over a wider range of AOA, flight testing revealed erratic stick force gradients developed when using this method of hinge moment reduction on the Sherpa Model K-400.

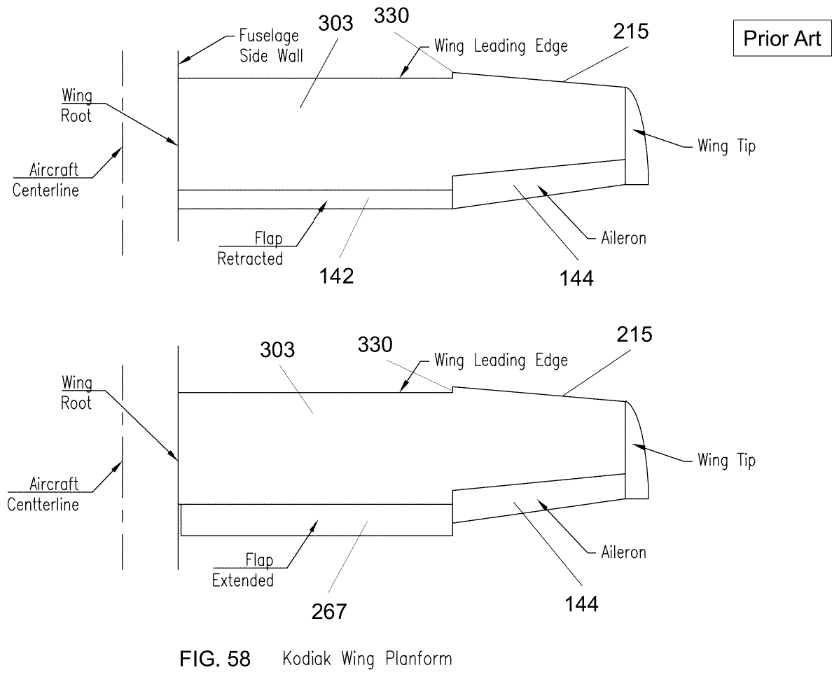

The Kodiak 303 utilizes a rectangular wing plan over the flap bay, then changes to a tapered planform over the outboard portion, FIG. 58 [Kodiak Wing Planform]. To protect the tapered outboard portion of the wing from stalling a discontinuous leading edge 330 is used in conjunction with a small chord nose flap over the outboard tapered wing portion commonly referred to as either a drooped leading edge or a leading edge cuff 215.

The cuff allows the portion of the wing effected by the cuff to operate at higher angles-of-attack, while the discontinuous leading edge acts like an aerodynamic fence reducing spanwise stall propagation. Its flap 142 has a smaller span ratio and the fully extended flap 267 does not translate or deflect as far as the Sherpa flaps. A large span ratio aileron 144 with a smaller chord ratio is used. Because of the shorter flap and longer aileron a spoileron is not used.

To summarize, larger values of effective flap span ratio (bfe/b), chord ratio (cf/c), flap translation (c′/c), and flap deflection (6f) all will equate to higher lift capability and lower extended flap stall speeds. The Caravan has a larger flap span ratio than the Sherpa models, but its flap translation and maximum flap deflection are smaller than the Sherpa models. It also has a significantly smaller flap chord ratio than the K-650T. The Kodiak has a small flap span ratio, smaller flap translation, and smaller maximum flap deflection than the Sherpa models. It also has a significantly smaller flap chord ratio.

Both Sherpa models have significantly larger aileron chord ratios than either the Caravan or the Kodiak. The Kodiak has a larger aileron span ratio than the other models at the expense of losing flap span, which was necessary due to their decision to not use a spoileron to enhance roll control at low speed.

The gross weight stall speeds of the K-650T have been improved over the K-400 in both the flap retracted and extended conditions. In the flaps fully extended condition operating at the aircraft's operational empty weight, the K-650T can fly significantly slower than the K-400 making it capable of preforming even more extreme short takeoffs and landings.

The K-650T can also cruise significantly faster than the K-400. This is due both to the horsepower increase when converting from a reciprocating powerplant to a turbine powerplant and also due to the improvement in drag reduction of the wing. The speed ratio between the minimum flight speed and cruise speed of 3.9 seen in the K-400 is respectable, while the 6.0 ratio of the K-650T is extreme.

The ratio of useful load with respect to aircraft gross weight is not quite as high for the Sherpa models as it is for the other two. The Sherpa was designed to operate in extremely rough off-airport sites. Survivability in the case of landing mishaps and ease of repairability in remote locations with minimal tools were of prime importance. This led to a structure that was not as light as the semi-monocoque structures of the other two aircraft, but a much more durable one.

The Sherpa K-400 was designed with a lower gross weight than the K-650T due to the powerplant choice. The K-650T has a somewhat lower gross weight than the Caravan and Kodiak. An increase in structural component sizes is quite practical and would allow the K-650T to attain a gross weight similar to these other aircraft, and the present invention should not be seen as limited to any specific engine configuration. The wing loading and wingspan loading of the Sherpa models are significantly less than the Caravan and Kodiak.

This allows the Sherpa models to achieve lower flap retracted stall speeds. With the lower power loading of the K-650T and the lower gross weight wingspan loading delivers increased climb performance and higher service ceilings, relatively speaking. Development of the K-400 and an earlier Sherpa model were focused on delivering extreme low speed capabilities built around a lower horsepower, normally aspirated reciprocating powerplant, consequently their cruise speeds were lower.

The cruise speed of the K-650T is similar to both the Caravan and Kodiak. As can be seen from the above explanations, there is no simple answer as to what makes an aircraft excel in a particular flight realm; rather, it is a constellation of design choices that lead to the final result. It is apparent that the choices made in the Sherpa models with regard to the flap design have a large influence on their ability to fly at low speeds while achieving reasonable cruise speeds.

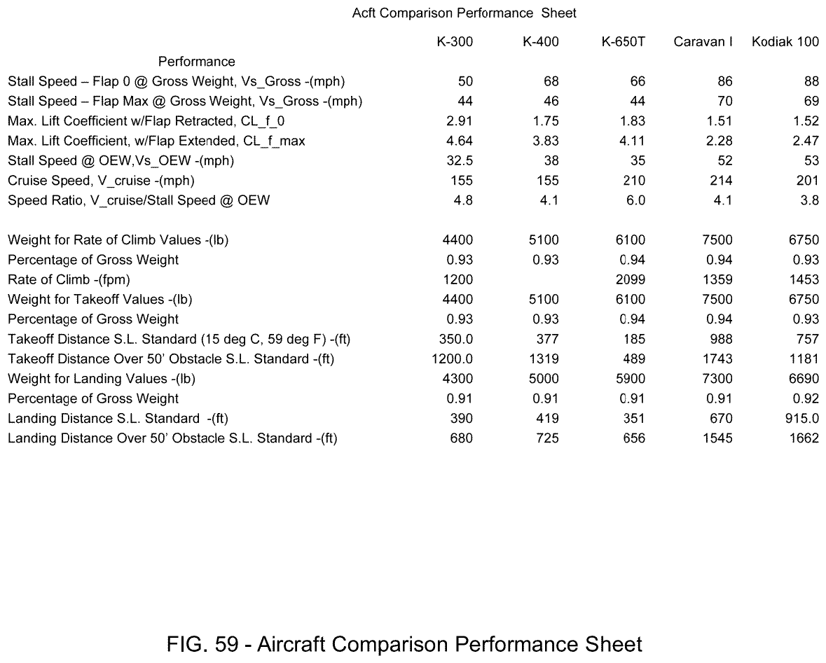

FIG. 59 [Aircraft Comparison Performance Sheet] compares the maximum climb rates, takeoff and landing distances, and distances required to clear a 50 ft. obstacle for the Caravan, Kodiak, and the two Sherpa models. Note that increasing control surface size and adding another size engine to the Model K-650T increasing shaft horsepower by as much as 20%, significantly enhancing the already excellent takeoff and climb performance of this model.

The turbine engine being used on the K-650T has been derated for control authority reasons at low speeds. If a more powerful turbine is used, control authority at low speeds will become an issue that would need to be mitigated. Control authority is the ability to adequately control the aircraft, and in this instance, the ability to control the aircraft directionally due to the high engine torque when aerodynamic controls are operating under low dynamic pressure conditions at low speeds.

During the development of the earlier K-300 Sherpa model, issues arose with the spoileron 145. The system used to deploy the spoileron was not directly attached to the aileron system. When the aileron 144 was moved to the up position 265 a bellcrank arm would engage the spoileron system causing the upward deployment of the spoileron 268.

With the aileron in the down position 266 the bellcrank arm disengages, allowing the spoileron to remain resting against a stop keeping it in the neutral position. Actuation of the spoileron worked reasonably well when the flaps were extended and high velocity air was flowing between the upper surface of the flap and the lower surface of the spoileron, a space known as the flap slot gap or the flap gap 322.

When the flaps are retracted 306 this flow subsides resulting in both spoilerons floating upward a few degrees since only air pressure differential would keep the spoileron against its neutral position stop (deflecting more when operating the wing at high angles of attack). This reduced the efficiency of the wing lift 101 and drag 102 during climb and cruise flight. This phenomenon was corrected by designing a hard link between the spoileron and the controlling system.

An additional unacceptable issue was the excessively high stick forces required to initiate deployment of the spoileron 145 (breakout stick force) when flaps were extended 267. Ideally, the stick should respond to pilot manipulation in a linear or at least somewhat linear fashion when deploying a control surface.

In the original wing design, the stick force gradient was not linear and the configuration of the Fowler flap 142, spoileron 145, and aileron 144 at full flap deployment 267, e.g., for take off, generally resulted in high stick forces, increased stick stiffness and reduced responsiveness of the aircraft to forces applied by the pilot through manipulate of the control stick.

Stick forces were very high to start, requiring the pilot to push very hard on the control stick until the spoileron starts to open, which then significantly reduces the stick force and makes manipulation of the stick much easier for the pilot.

The cause of this issue was determined to be related to the high velocity air flowing through the flap gap 322. The airflow velocity through the flap gap is directly related to the size of the gap. The airflow through the flap gap has a very high velocity and the higher the velocity, the more suction forces produced by the pressure gradient pull down on the spoileron, making it harder to open.

Developing the present invention required identifying flap gap size 322, fully deflected flap leading edge location 321, and configuration that maintained as much lift 101 as possible, i.e., with the flaps fully extended 267, without requiring the air velocity through the flap gap 322 to be so fast that when the pilot attempts to move the stick off the center line it produces an abrupt change in the stick force, creating the sensation of a barrier or wall and making it difficult to get the spoileron to deploy.

When the spoileron 145 is in the neutral position, the flap gap 322 extends from the trailing edge of the spoileron to the upper surface of the flap 267. The initial gap size was designed to achieve maximum lift from the flap. A gap size was found that adequately reduced the airflow velocity to allow proper deployment of the spoileron, while resulting in minimal loss of flap lift performance. FIG. 52 [Flap Gap_Spoileron Parameters]

These improvements were incorporated into the design of the K-300, K-400 and K-650T, though specific dimensions were altered due to size and geometry differences between the earlier Sherpa model and the newer models. The present invention of the Sherpa airplane achieves a consistently smooth stick force gradient, providing a relatively smooth transition as the spoileron deploys 268, i.e., as soon as spoileron opens up, the stick forces increase only gradually.

This aspect is critical, especially at full flap deployment 267 when the gap size 322 between the top surface of the flap and the trailing edge of the spoileron 145 is most crucial.

It took time and effort to discover the range of workable flap extension locations so that the initial spoileron deployment wouldn't create excessive breakout stick forces when attempting to roll the airplane. So, the size of that gap 322 between the spoileron and the leading edge or nose of the flap is also a critical component of the present invention, especially in full flap deployment 267.

In simplified terms, when the flap is fully extended 267, both the location of the nose of the flap 321 and the gap size 322 are important to developing maximum lift 101, while only the gap size 322 is important to initial spoileron actuation forces. The location of the spoileron hinge 325 with regard to the spoileron trailing edge 326 is important to the overall moment (directly related to stick force) of the spoileron.

Ultimately, the solution provided by the present invention includes the location or position of the point where the spoileron attaches or connects to the trailing edge of the wing 325, how it pivots around or hinges about that attachment point 324, the size of the flap gap 322, and the range of various enabling configurations (i.e., locations and placements on the wing) of the ailerons 144, flaps 142, and spoilerons 145, and specifically, such that initial deployment of the spoileron does not create excessive breakout stick forces while initiating a rolling maneuver.

Once the issue of breakout stick force was resolved it was determined that the roll control stick forces in the earlier Sherpa model were higher than ideal, but acceptable for a proof of concept airplane. A mass balanced, sealed aileron type 310 that utilized a flexible seal 311 to prevent airflow between the lower and upper surfaces, FIG. 48 [Sealed Aileron], was used in this earlier Sherpa model which was determined to be the cause of the higher than expected stick forces.

All Sherpa models used differential aileron displacement as a means to counter adverse yaw. Differential aileron displacement occurs when the upward deflecting aileron 265 deflects to a greater angle than the downward deflecting aileron 266. Since the air pressure above the wing is lower than below the wing in most conditions, the upward deflecting aileron 265 requires larger deflection to produce similar total drag as the downward deflecting aileron 266.

The roll control stick forces in the K-400 were determined to be unacceptable when using this type of aileron partly due to the increase in size and weight of the aircraft, increased size of the aileron, increased size of the spoileron, and also because of a change that was made in the control system. To address this issue the aileron type was changed to a Frise type 272. This type of aileron uses a displaced hinge line 275 similar to that used in the sealed aileron design, but located near the lower surface of the wing.

Rather than sealing 311 the airflow between the lower and upper surfaces of the wing at the leading edge of the aileron, a Frise aileron 272 utilizes a leading edge that protrudes into the airflow beneath the wing when the aileron deflects upward 265, while remaining within the contours of the wing when deflecting downward 266.

This arrangement accomplishes two objectives. First, when the leading edge 276 (nose) of the upward rotating aileron drops below the lower wing surface the airflow beneath the wing pushes against it creating drag and helping to relieve stick force requirements. Second, the increased drag produced on this aileron creates a yawing moment that assists the differential aileron displacement in relieving the adverse yaw when initiating a banking turn.

Because the amount of leading edge exposed to the airstream and the timing of that exposure, in addition to the amount of differential aileron displacement, is critical to developing the desired stick forces. The initial hinge support structure and location of the aileron actuator was design to allow variations in the locations of both hinge and actuator attachment. Various differentials and hinge locations where tried until the desired ones were found.

Once the proper hinge and actuator attachment locations were found the support structure was secured in place.

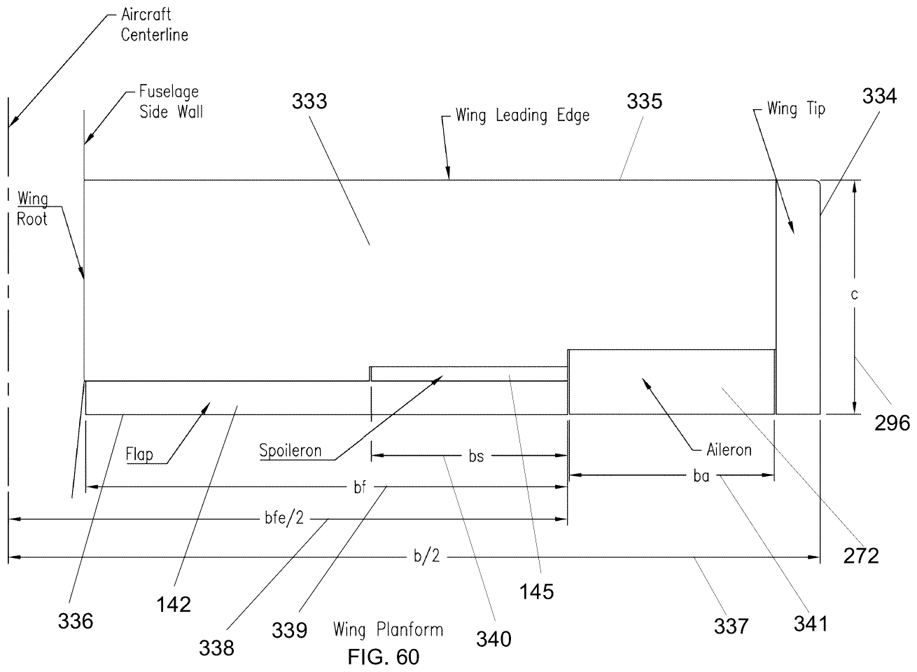

The basic wing planform 333 of the K-400 and K-650T are similar as depicted in FIG. 60 [Wing Planform]. The following measurements and ratios are with regard to the Sherpa K-400 wing 273, flaps 142, spoilerons 145, and ailerons 272. Ratios are presented in terms of a base feature, such as 1.00c=100% of the chord measurement.

Measured as the distance from the wing leading edge to trailing edge, the wing chord 296 (c) is 72 in.

Measured as the distance from one wing tip 334 to the other, the wingspan (b) is 44.0 ft.

Measured as the projected area of the planform and bounded by the leading 335 and trailing edges 336 of the wings and the wing tips 334, the wing area (sw) is 264 sq. ft.

Measured in percentage of wing chord 296 the flap chord 298 (cf) ratio is 0.31c.

Measured in percentage of wingspan (b, or twice the semi-span b/2 337) the effective flap span (bfe or twice the effective flap semi-span 338) is 0.67b.

Measured in percentage of wing semi-span 337 (b/2) the flap span 339 (bf) ratio is 0.60(b/2).

Measured in percentage of wing chord 296 (c) the flap trailing edge translation 295 (c′) ratio is 1.22c.

Measured in percentage of flap chord 298 (cf) the flap leading edge translation 297 (c_trans) ratio is 0.90cf.

Minimum distance between the trailing edge lower surface of the spoileron 145 when in the neutral position and the upper surface of the flap when fully deflected 267, the flap gap 322(Yf) ratio with respect to the wing chord 296 is 0.025c.

With the Fowler flap in the fully retracted position 306 the deflection of the flap 293 (6f) determined by the angle between the flap chord reference line 294 and the wing cord reference line 120 is 0 degrees.

The maximum deflection of the Fowler flap 293 (6f) determined by the angle between the flap chord reference line 294 with the flap fully retracted 306 verses fully deflected 267 is 40 degrees.

The maximum distance that the leading edge of the fully deflected flap 267 is forward of the spoileron trailing edge 326 with respect to the wing chord 296 (c) and measured parallel to the wing chord reference line 120, flap leading edge displacement 321 (Xf), ratio is 0.0066c.

Measured in percentage of wing semi-span 337 the spoileron span 340 (bs) ratio is 0.24(b/2).

Measured in percentage of wing chord 296 (c) the spoileron chord 323 (cs) ratio is 0.0675c.

Maximum deflection of the spoileron 268 (6s) is 37 degrees.

Measured in percentage of wing semi-span 337 (b/2) the aileron span 341 (ba) ratio is 0.24(b/2).

Measured in percentage of wing chord 296 (c) the aileron chord 314 (ca) ratio is 0.31c.

The aileron hinge 275 location measured from the aileron leading edge 315 (aileron nose overhang, cb) with respect to the aileron chord 314, aileron hinge location ratio is 0.31ca.

Maximum deflection of the upward traveling aileron 265 (δa_up) is 29 degrees.

Maximum deflection of the downward traveling aileron 266 (δa_dn) is 19 degrees.

The distanced the upward deflecting aileron nose protrudes below the wing section 316 measured in percentage of the aileron chord 314 and perpendicular to the wing chord reference line 120, maximum aileron nose protrusion ratio, (Ya) is 0.12ca.

The following measurements and ratios are with regard to the Sherpa K-650T wing 274, flaps 142, spoilerons 145, and ailerons 272. Ratios are presented in terms of a base feature, such as 1.00c=100% of the chord measurement.

Measured as the distance from the wing leading edge to trailing edge, the wing chord 296 (c) is 80 in.

Measured as the distance from one wing tip 334 to the other, the wingspan (b) is 47.7 ft.

Measured as the projected area of the planform and bounded by the leading 335 and trailing edges 336 of the wings and the wing tips 334, the wing area (sw) is 318 sq. ft.

Measured in percentage of wing chord 296 the flap chord 298 (cf) ratio is 0.36c.

Measured in percentage of wingspan (b or twice the semi-span b/2 337) the effective flap span (bfe or twice the effective flap semi-span 338) is 0.70b.

Measured in percentage of wing semi-span 337 (b/2) the flap span 339 (bf) ratio is 0.59 (b/2).

Measured in percentage of wing chord 296 (c) the flap trailing edge translation 295 (c′) ratio is 1.16c.

Measured in percentage of flap chord 298 (cf) the flap leading edge translation 297 (c_trans) ratio is 0.56cf.

Minimum distance between the trailing edge lower surface of the spoileron 145 when in the neutral position and the upper surface of the flap when fully deflected 267, the flap gap 322 (Yf) ratio with respect to the wing chord 296 is 0.013c.

With the Fowler flap in the fully retracted position 306 the deflection of the flap 293 (6f) determined by the angle between the flap chord reference line 294 and the wing cord reference line 120 is referred to as a reflected flap angle and is −10 degrees (upward deflection).

The maximum deflection of the Fowler flap 293 (6f) determined by the angle between the flap chord reference line 294 with the flap fully retracted 306 verses fully deflected 267 is 40 degrees of total deflection.

The maximum distance that the leading edge of the fully deflected flap 267 is forward of the spoileron trailing edge 326 with respect to the wing chord 296 (c) and measured parallel to the wing chord reference line 120, flap leading edge displacement 321 (Xf), ratio is 0.0151c.

Measured in percentage of wing semi-span 337 the spoileron span 340 (bs) ratio is 0.24(b/2).

Measured in percentage of wing chord 296 (c) the spoileron chord 323 (cs) ratio is is 0.0609c.

Maximum deflection of the spoileron 268 (6s) is 39 degrees.

Measured in percentage of wing semi-span 337 (b/2) the aileron span 341 (ba) ratio is 0.25(b/2).

Measured in percentage of wing chord 296 (c) the aileron chord 314 (ca) ratio is 0.35c.

The aileron hinge 275 location measured from the aileron leading edge 315 (aileron nose overhang, cb) with respect to the aileron chord 314, aileron hinge location ratio is 0.31ca.

Maximum deflection of the upward traveling aileron 265 (δa_up) is 27 degrees.

Maximum deflection of the downward traveling aileron 266 (δa_dn) is 18 degrees.

The distanced the upward deflecting aileron nose protrudes below the wing section 316 measured in percentage of the aileron chord 314 and perpendicular to the wing chord reference line 120, maximum aileron nose protrusion ratio, (Ya) is 0.13ca.

A Fowler flap was chosen for use on the earlier Sherpa model and the K-400 due to its ability to achieve the performance goals for extremely short field operation, while not adding excessive complexity. The translation of flap forward and aftward on the wing section of the present invention, or the amount that the flap slides back and forth, is substantially greater than any other light aircraft of which the inventors are aware. This means that the flap of the present invention deploys much farther aft than on any other small/light airplanes.

Flap tracks, rollers, flap actuator push tubes and associated torque tube drive system are the only mechanisms used to deploy flaps to specific positions using translation. Larger aircraft like commercial jets use much different and more complex mechanisms. It is the final position of the flap that is most important, and in Fowler flaps that final position is achieved using both translation (i.e., forward and aftward) and rotation (i.e., upwards and downwards).

In addition, the flap track is external to the wing section of the present invention, and this is also a very unusual design aspect because it is typically beneficial to keep the flap track internal to the wing section to enable higher speeds and also to protect the flap track from the elements without the need of fairings.

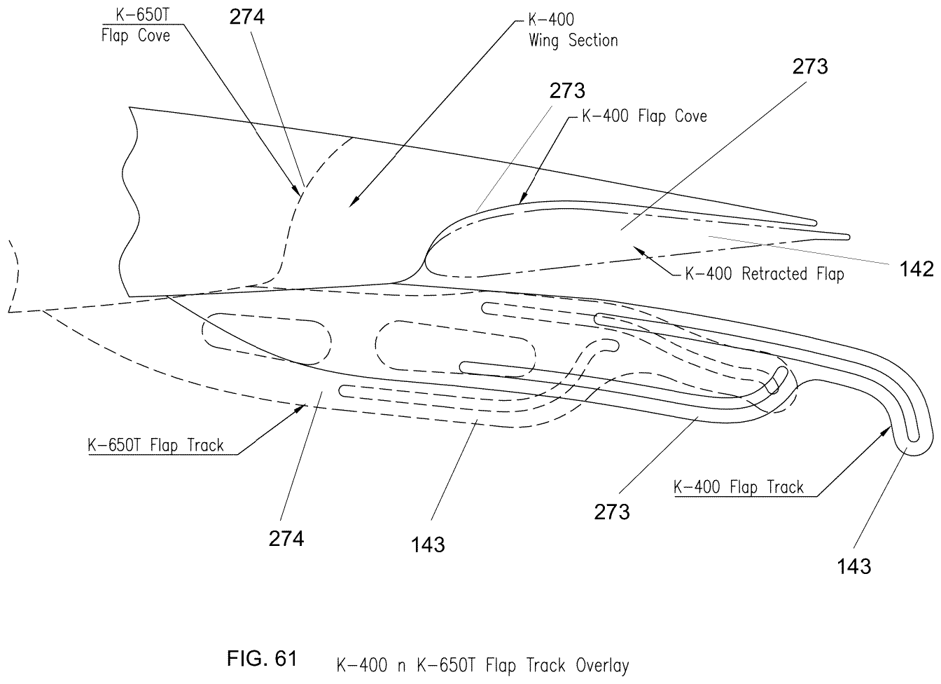

However, the fact that the flap 142 of the present invention translates so far aftward necessitated development of the unique flap tracks 143 for both the K-400 273 and K-650T 274 external to the wing section, FIG. 61 [K-400 n K-650T Flap Track Overlay], which allows the design of the flap track component to be simple, strong, and resistant to degradation by the elements when fairings are attached. The priorities of reducing drag and protecting the flap track without the use of fairings results in the need to limit flap translation so that the flap track mechanism may fit entirely within the wing section. For this reason, nearly all light airplanes that include a Fowler flap integrate the flap track interior to the wing section.

A handful of light airplanes other than the Sherpa models include flap tracks that extend to the exterior of the wing section. However, the flap track 143 of the present invention is the only external flap track of which the inventors are aware that extends aftward, beyond the trailing edge 336 of the wing section. This allows the flap leading edge to extend near the trailing aftward edge of the wing. In contemporary small/light airplanes that include an external flap track, the flap leading edge itself typically only extends halfway towards the trailing aftward edge of the wing.

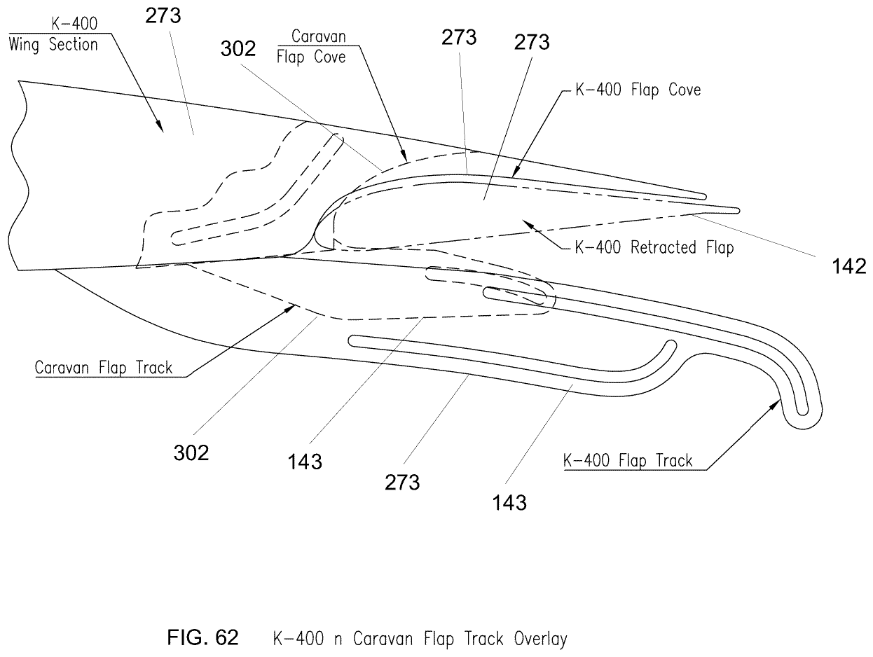

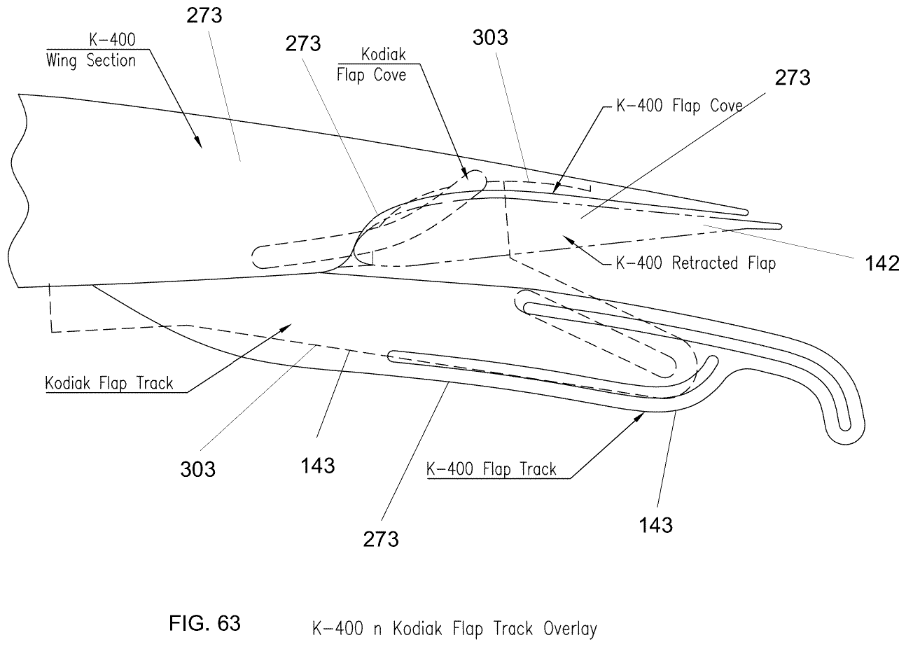

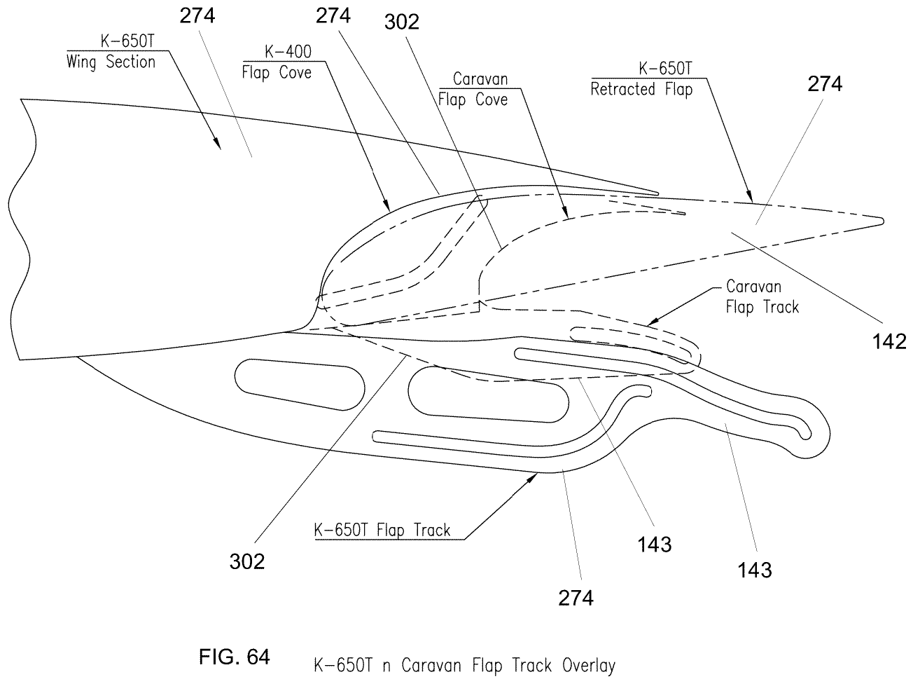

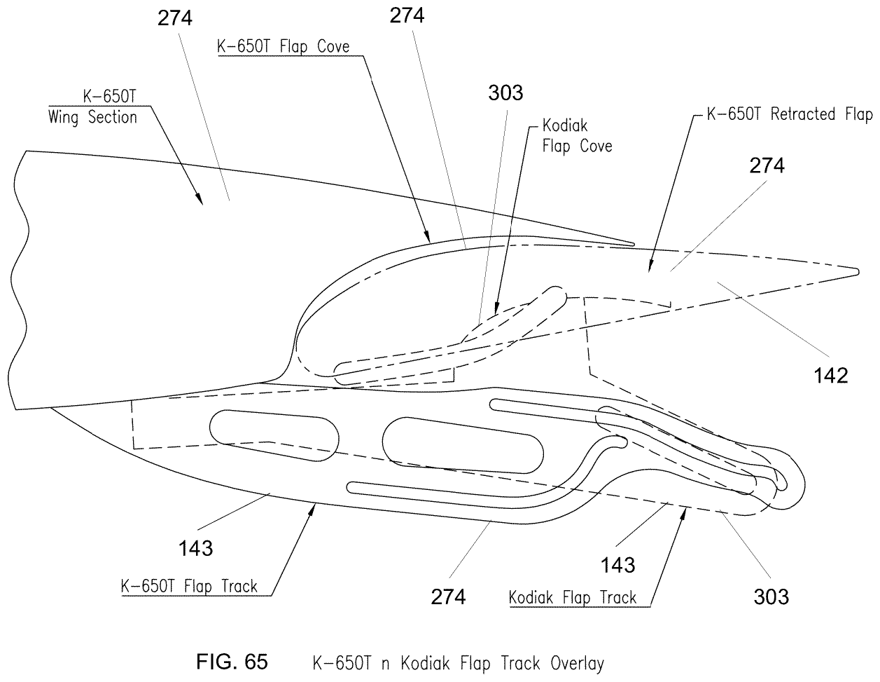

The Caravan 302 and the Kodiak 303 are examples of other light airplane with at least partially external flap tracks 143. However, their flap tracks do not hang down anywhere near close to the extent that the flap track of the present invention protrudes down and aftward. FIG. 62 [K-400 n Caravan Flap Track Overlay], FIG. 63 [K-400 n Kodiak Flap Track Overlay], FIG. 64 [K-650T n Caravan Flap Track Overlay], and FIG. 65 [K-650T n Kodiak Flap Track Overlay]

Unlike the Sherpa Model K-400 273, neither the Caravan 302 nor the Kodiak 303 flap leading edges extend all the way to the wing trailing edge 336 as defined by either the aileron trailing edge or the trailing edge of the flap prior to extension.

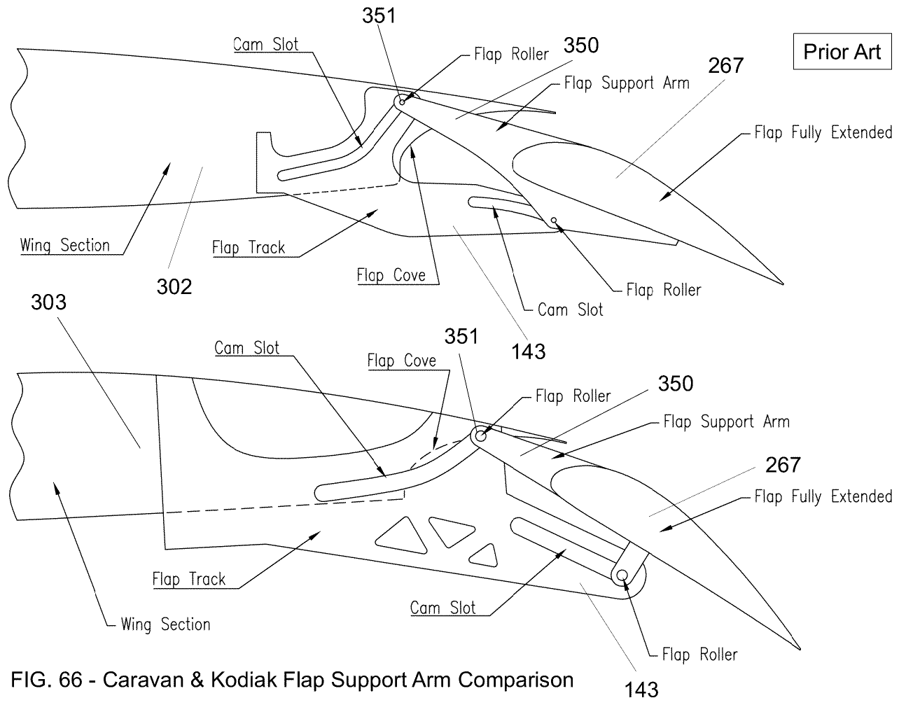

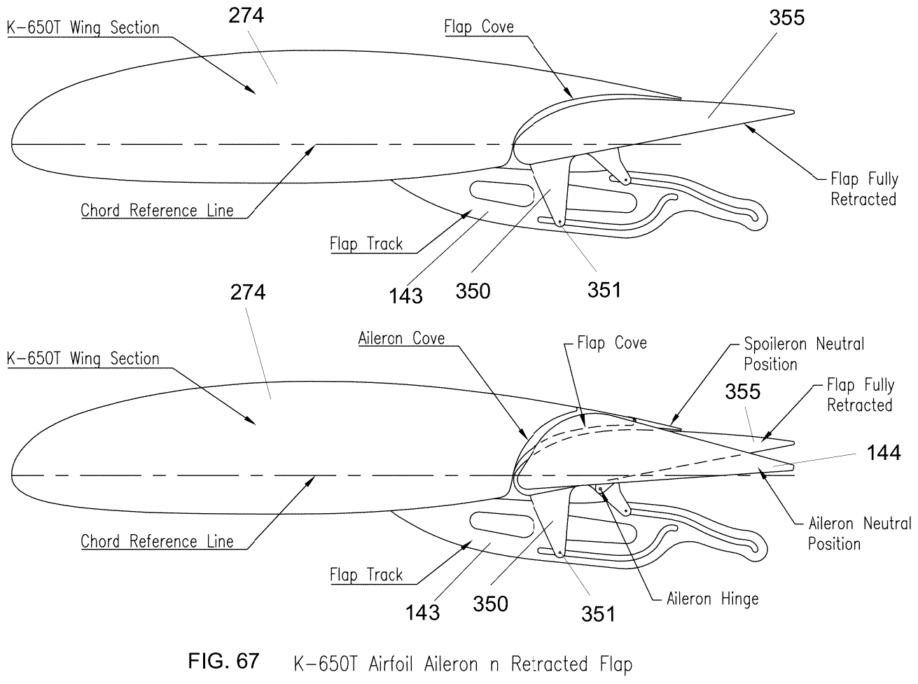

Flap Comparison drawings shown in FIG. 66 [Caravan & Kodiak Flap Support Arm Comparison], depicts a support arm 350 extending forward of the flap leading edge on both the Caravan 302 and Kodiak 303 with the flap fully extended 267. This is the support arm that holds the forward flap roller 351 that rides in the forward flap track cam 301 shown in the Flap comparison drawing. Using this arrangement limits the amount of flap translation that can be obtained. The support arm 350 holding the forward flap roller 351 extends downward from the flap leading edge on the Sherpa model K-400 273 and K-650T 274 allowing the retracted flap 306 to translate further aft when fully extended. FIG. 67 [K-650T Airfoil Aileron n Retracted Hap]

For flaps, the angle of deflection is calculated from its normal retracted position. So, for the present invention, the zero or fully retracted flap position on the K-650T 274 is actually in what is referred to as a reflexed 355 position, which is the same as a negative deflection with respect to the airfoil section and aileron 144 when in the neutral position.

Information presented in the USAF Stability and Control Datcom and NACA wind tunnel data, as well as our experience during flight tests, show that the Fowler flap does not work well past 40 degrees deflection and a maximum deflection of 40 degrees for the Fowler flap of the present invention is fairly standard.

Deflection of more than 40 degrees will cause airflow separation on the upper surface of the flap greatly increasing drag and decreasing lift. This separation will also create issues with the ability of the horizontal tail to maintain balance of the airplane.

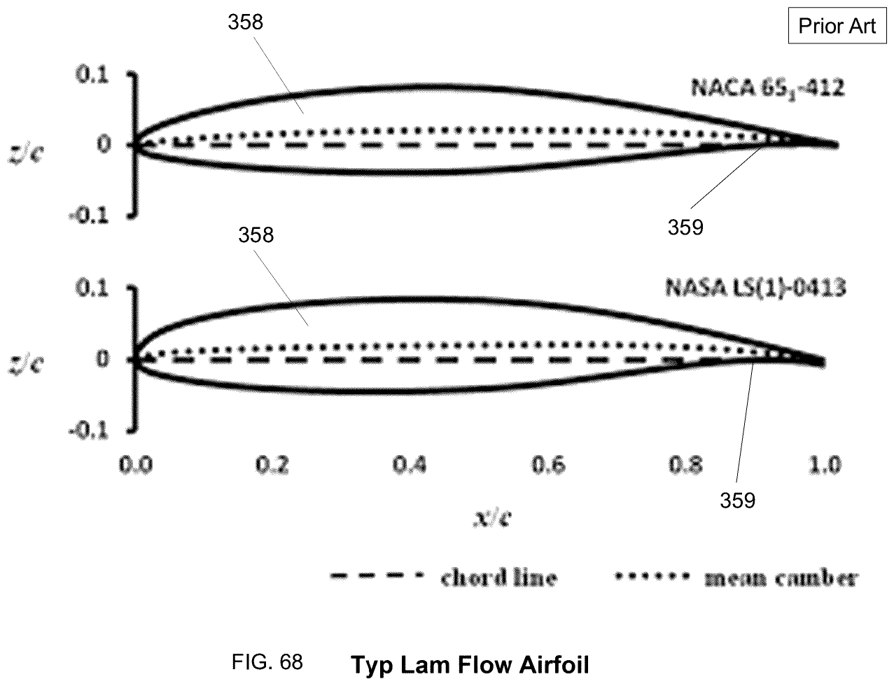

The lower aft surface of most laminar flow 358 and supercritical airfoil sections includes a concave shape 359 near the aftward end of the section referred to as an “under cusp”, since the cusp is located on the lower (bottom) surface. FIG. 68 [Typ Lam Flow Airfoil] Occasionally, there is a cusp located on the top aft portion of these airfoil sections. The airfoil section chosen for use on the K-650T initially included an under cusp 359, which was removed in the area of the wing where the aileron exists as it would create undesirably high hinge moments.

It was also found during flight tests that this cusp 359 was creating undesirable flow conditions when the flap was deflected. Removing the cusp from the flap created issues with pressure recovery on the aft top side of the wing that caused an increase in drag. To improve the pressure recovery the flap was placed in a reflexed 355 position for cruise flight. Because the airfoil section used on the K-400 was not laminar flow, it did not have any cusp and the flap did not need to be reflexed.

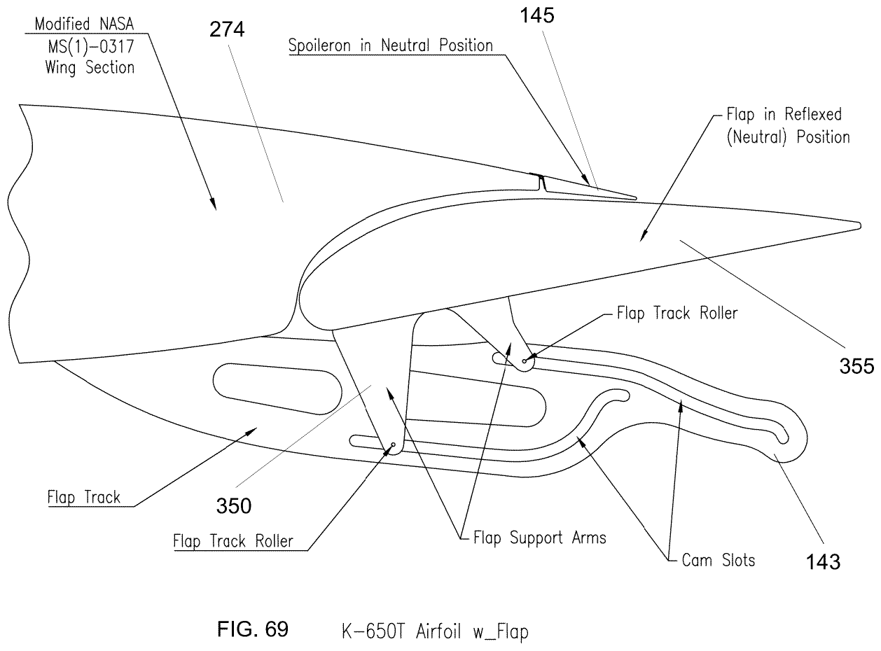

As shown in FIG. 39 [NASA MS(1)-0317 Original vs Modified Airfoil] and FIG. 69 [K-650T Airfoil w_Flap], the aft portion of the original airfoil section 187 ends below the trailing edge of the modified airfoil trailing edge 290, so that the reflexed flap 355 is lifted up at the trailing edge, slightly.

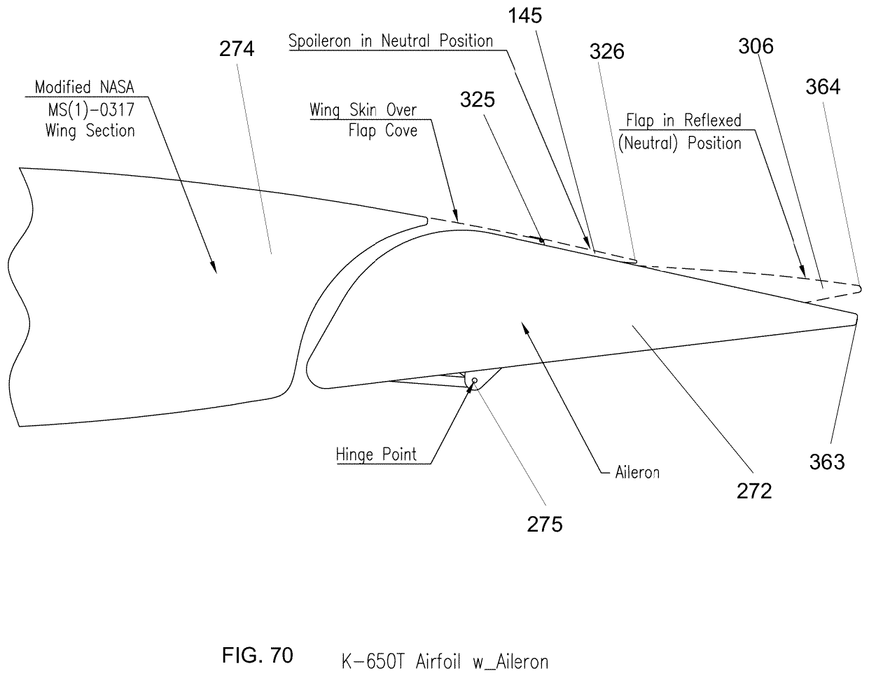

There are also aerodynamic reasons for that change of the flap normal position to a reflex 355 position, technically a negative deflection for the flap, as a starting point. FIG. 70 [K-650T Airfoil w_Aileron] depicts the Frise aileron 272 and spoileron 145 in the neutral position and the flap in the fully retracted position 306. It also depicts the location of the aileron hinge 275 and the spoileron hinge 325 and shows the difference between where the trailing edge of the aileron 363 is (coincident with the airfoil section), where the spoileron 326 trailing edge is, and the trailing edge of where the flap 364 is, with the flap reflexed 355 (up a little bit at the trailing edge).

As shown in FIG. 53 [Aircraft Comparison Geometry Sheet] the design of the present invention gives the Sherpa the highest CL-Max, maximum coefficient of lift, resulting in the lowest speeds of any similar competitor airplanes in the market by a minimum 15 mph, of which the inventors are aware. This number is weight dependent. This means the Sherpa airplane can lift off at slower speeds than any other (comparable) airplane.

The Sherpa design generates a higher CL-Max than other STOL airplanes, which results in lower approach, landing and stall speeds. This is accomplished via the specifics of the wing section and flap design and, in combination with the spoileron design, allowing the airplane to be controllable at such low speeds, in contrast to other STOL airplanes.

The Sherpa uses a bigger flap and more roll control authority, enabling the to land in the 35 miles per hour range. The flap track cams 301 trace a unique design to enable the specific translation/sliding and pivoting/deflection of the Fowler flap employed in the present invention.

The Fowler flap 142 of the present invention has a larger chord ratio than conventional Fowler flaps, and it extends approximately 70% of the wingspan. The actual flap span is 60% of the span, but the flow over the 10% that comprises the fuselage is highly influenced by the flap, making the effective flap span ratio about 70%. For conventional airplanes, the effect of the flap typically extends over only over 50% of the wingspan, sometimes less, e.g., the Piper PA-18 Super Cub uses a flap that effects only 30% of the wingspan.

With the flap covering such a large portion of the wing in the present invention, the extent of the aileron 272 is consequently reduced and more restricted in size than normal, which reduces roll control authority especially at low speeds. The spoileron 145 was added to increase roll control authority especially in the flight realm when the flaps are fully extended 267 and speeds are very slow. Others have handled this several ways that are quite different than the present invention.

For the K-400, FIG. 53 [Aircraft Comparison Geometry Sheet] shows the flap leading edge translates aftward about 90% of the distance of the flap chord, from the leading edge to the trailing edge, from its fully retracted 306 position to its fully deployed 267 position increasing the wing chord to 122%, whereas a flap leading edge translation for a typical light aircraft is usually about 35% increasing the wing chord to only 105%.

The Model K-650T 274 flap leading edge translates 56% of its flap chord, significantly more than most light aircraft. Due to the shape of the modified NASA MS(1)-0317 airfoil section 190 afterbody the amount of translation is limited. The combination of this airfoil section allowing the use of a thicker flap with a larger chord and its inherent high lift capability overcome the somewhat shorter translation than that used on the Model K-400 273.

Early airfoil sections used underchambered (concave) bottoms to create high lift not yet understanding that this configuration lead to high drag and high pitching moments. Soon after, airfoil sections with flat bottoms and curved tops where used to generate high lift with lower drag, however, they still exhibited high pitching moments.

Sections with the same upper and lower surface Y ordinate magnitudes at a given X ordinate location (airfoil coordinates) are known as symmetrical airfoil sections, meaning that the mean camber line is zero. Symmetrical airfoil sections do not create lift at zero AOA. Both “standard” and laminar 358 airfoil sections can be made symmetrical. Flat bottom and under cambered airfoil sections have camber by definition and cannot be symmetrical in nature, nor can they be laminar since their lower surfaces cannot be tailored to the required shape to achieve laminar flow. An airfoil section with positive camber will generate lift when at zero AOA.

The top and bottom surfaces are the same (same upper and lower surface ordinates) only on airfoil sections with zero mean chamber and are referred to as symmetrical airfoils which generally generate lower lift and drag. The mean line or camber line is the locus of the mid-points between the upper and lower surfaces when measured perpendicular to the camber line. Some aerobatic airplanes utilize symmetrical airfoils section because they work well for inverted flight. Many modern light airplanes utilize airfoil sections modified from symmetrical airfoils sections that have greater curvature on the top than the bottom, creating a theoretical mean chamber line, producing higher lift.

The location of maximum thickness of a laminar flow airfoil sections usually occurs further aft than on other airfoils. They are also characterized by the usual distinctive concave lower surface, or both upper and lower surfaces when the mean camber line is zero, near the aft portion of the section and are typically used in faster aircraft. Most airfoil sections exhibit some form of laminar airflow, especially at low angles of attack where the airflow of many airfoil sections is generally laminar from the leading edge to the point of maximum thickness (flat bottom and under cambered sections excluded).

Essentially, NACA 4 digit airfoil sections were derived using thickness distributions of earlier flat bottom airfoil sections modified with various amounts of mean camber. The NACA 5-digit airfoil section shapes were a little more complex in an attempt to reduce the pitching moment about the aerodynamic center.

The last group of airfoil sections NACA developed were various laminar flow sections referred to as 6-series sections. These airfoil sections were designed with high speed flight in mind, but also work well in some lower speed applications. The NASA MS(1)-0317 187 airfoil section was one of the last airfoil sections NASA designed. It was designed for medium sized commuter airplanes that required use of more complex high-lift devices and would cruise in the mach 0.3 to 0.4 range (300 to 400 mph at 30,000 ft) and are considered to be medium speed sections with an “MS” designation.

At some point aft of the maximum airfoil section thickness, the flow transitions to turbulent. A laminar flow section 358 postpones the transition from smooth to turbulent flow to a point further aft. Laminar flow sections have varying degrees of success in achieving laminar flow to points as far back as 90% of the chord. The angles of attack that can be achieved while maintaining this flow also varies, but is usually confined to lower AOA seen during cruise flight.

Maximum thickness occurs at 30% chord for the modified 5-digit NACA 43015 214 airfoil section used on the K-400, as shown in FIG. 25 [Modified NACA 43015 Airfoil n w_Cuff], and 37.5% chord for the modified MS(1)-0317 190 airfoil section used on the K-650T, as shown in FIG. 20 [Modified NASA MS(1)-0317 Airfoil]. The modified NACA 43015 section 214 used on the K-400 has a thinner aft section and works well with a somewhat thinner thickness ratio flap (t/cf) which allows the flap to extend much farther aft. The modified MS(1)-0317 190 airfoil sections used on the K-650T requires a thicker flap to achieve proper airflow around the flap when fully extended, restricting how far back the flap can translate.

Regarding laminar flow, it is not a requirement for the Sherpa K-650T 274 airfoil section, and there are varying degrees of laminar flow airfoil sections available. Some require a very close manufacturing tolerance, and this is an important consideration with respect to the anticipated operating environment of very short and unimproved airstrips. Taking off from a muddy field could cause mud to be thrown on top of the wing completely negating the laminar effect of that portion of the wing. Even dust or moisture could cause issues with some airfoil sections, e.g., the original Rutan Quickie with a forward wing that would create excessive drag when flying into rain, or the effects of frost on a wing causing greatly reduced lift and increased drag.

The modified NASA MS(1)-0317 190 used on the K-650T is a laminar flow airfoil 358 section that effectively reduces drag at low AOA (cruise flight); though beneficial, that is not the main reason for choosing this section. When considering cruise speed, drag reduction is typically the first area of interest since reducing drag by a factor of two will increase speed by about 40%, while doubling the horse power will only increase speed by about 25%. The use of this airfoil section further benefits the Sherpa as demonstrated by its maximum cruise speed of 210 mph.

The NASA MS(1)-0317 187 airfoil section was reshaped to create a hybrid airfoil section, which is a key aspect of the invention enabling the difference between cruise speed and minimum landing speed to achieve a ratio six to one (6:1) (O.E.W. landing speed of 35 mph and maximum cruise of 210 mph). FIG. 20 [Modified NASA MS(1)-0317 Airfoil] This is a greater ratio than most business and commercial jets can achieve.

In addition to modifying the back 290 of the NASA MS(1)-0317 airfoil section used in the Sherpa K-650T 274 to accommodate the larger than normal Fowler flap and attendant considerations, its forward portion 289 was modified to simulate the inclusion of a slightly deflected leading edge flap, which effectively changed the camber line to enable the airfoil section to operate at a higher angle of attack 118 before stalling. FIG. 39 [NASA MS(1)-0317 Original vs Modified Airfoil].

This leading edge modification 288 and 289, extending from the leading edge to about the 20% chord location, causes the air to act very similar to as if it were flowing over an airfoil section that has a leading edge flap, making a more curved airflow field around the wing and enabling the higher AOA 118 before stall. The “turned down leading edge” increases the camber of the forward portion of the airfoil section, postponing upper surface separation and allowing the wing to achieve a higher AOA, and therefore greater lift. The effectiveness of a leading edge nose flap is partially dependent on the chord of the flap with respect to the chord of the airfoil section, as shown in FIG. 38 [Nose Flap Chord Max Lift Effectiveness] that depicts a more rapid decrease in effectiveness once the leading edge flap chord ratio exceeds 0.30 or 30% 283.

The present invention approached this from the perspective of momentum to achieve a greater AOA with the “turned down leading edge”, which pushes down a greater amount/volume of air, enabling the Sherpa K-650T to maximize both lift 101 and drag 102 in the landing configuration and providing the extreme STOL capabilities.

In addition to the aerodynamic benefits of the 80 inch chord modified MS(1)-0317 section 190 used on the K-650 274, as opposed to the 72 inch chord modified NACA 43015 section 214 used on the K-400 273, the difference in cross sectional area allows the accommodation of an additional nearly 200 gallons of fuel. For example, the K-400 wing can carry up to 150 gallons while the turbine K-650T can carry up to 348 gallons. This increased fuel capacity was necessary to accommodate the greater use of fuel required by the turbine engine.

There is a type of vortex generation system 202 affixed to the leading edge portion of the original Caravan I 302 flap presumably due to correct an issue with a phenomenon in fluids referred to as hysteresis (a type of lagging). In this context the phenomenon is caused by airflow separating from the upper surface of a flap and not reattaching until an extreme change in airflow is made.

This condition usually appears when a wing is stalled with a Fowler flap fully extended 267, causing the air over the flap to completely separate 125 and requiring an extreme change in angle of attack 118 (pitch angle) before the airflow will reattach to the flap, spawning a very dangerous situation. This condition can usually be solved by adding VGs 202 to the upper leading edge of the flap to introduce high energy air into the flap gap or by increasing the size of the gap.

The original K-300 also experienced this phenomenon prior to modifying the flap track which required changing the size of the flap gap 322. VGs were also added to the upper surface of the flap as well as to the upper surface of the wing leading edge eliminating the hysteresis issue and providing exceptional lift. There were, however, additional issue that the VGs created such as a cruise drag penalty that accompanied the lift improvement, ground operators need to use extra care not to damage any VGs while servicing the airplane, and wing covers were require when operating from facilities without hangar space during the winter since deicing the wing proved difficult.

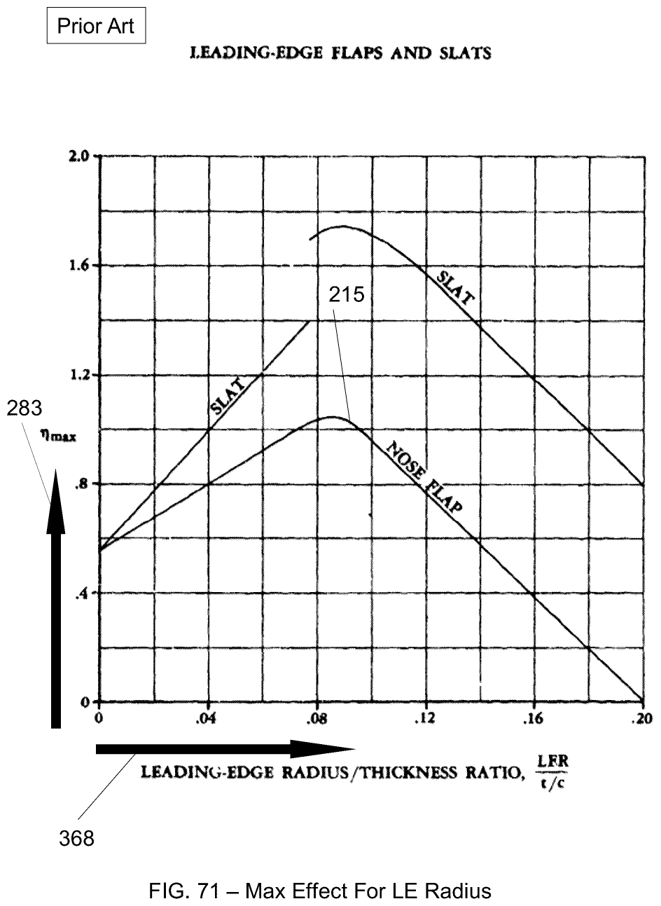

The K-400 273 wing was modified with the attachment of a leading edge cuff 215 (small chord fixed leading edge flap) shown in FIG. 25 [Modified NACA 43015 Airfoil n w_Cuff]. A leading edge cuff's effectiveness 283 is partially dependent on the chord of the cuff with respect to the chord of the airfoil section, as shown in FIG. 38 [Nose Flap Chord Max Lift Effectiveness] that depicts a rapid increase in effectiveness 284 forward of 0.10 (10%). This is one of the reasons the chord of the cuff 215 used on the K-400 was only about 1 inch (1.5%). Its effectiveness is also dependent on the ratio of leading edge radius with respect to the section thickness ratio (LER/(t/c) 368 shown in FIG. 71 [Max Effect For LE Radius], which reaches a maximum just beyond 0.08. The cuff radius on the K-400 was chosen to maximize this value.

Increasing the gap size to alleviate the high initial spoileron loads also resolved the hysteresis issue, so VGs 202 were no longer required to be on the upper surface of the flaps and they were eliminated from the K-400 design. VGs were eliminated from the upper surface of the wing leading edge and a leading edge cuff was attached. The cuff 215 did not improve the lift to nearly the same extent as the VGs when flaps were extended but resolved the higher drag and servicing issues.

Also, many airfoil sections are not capable of interacting with the Fowler flap in the same way aerodynamically. Many other designs do not utilize a horizontal tail or trim system capable of reacting to the significant downwash angle changes and pitching moments presented by use of such a large translating flap. The type of horizontal tail used on the Sherpa models, discussed earlier, was chosen for its ability to work in the high downwash environment.

Most airplanes have effective flap span ratios of about 30% to 50% so that adequate roll control can be accomplished with a simple aileron system. The Sherpa models have effective flap span ratios of about 70% (b_fe/b, where b_fe extends from outboard to outboard edge of the flaps) and use a spoileron in conjunction with a large chord aileron to achieve the required roll control authority. The Kodiak has an effective flap span ratios of about 63% and uses only an aileron, while the Caravan has a ratio of 74% and also uses a spoileron in conjunction with a large chord aileron.

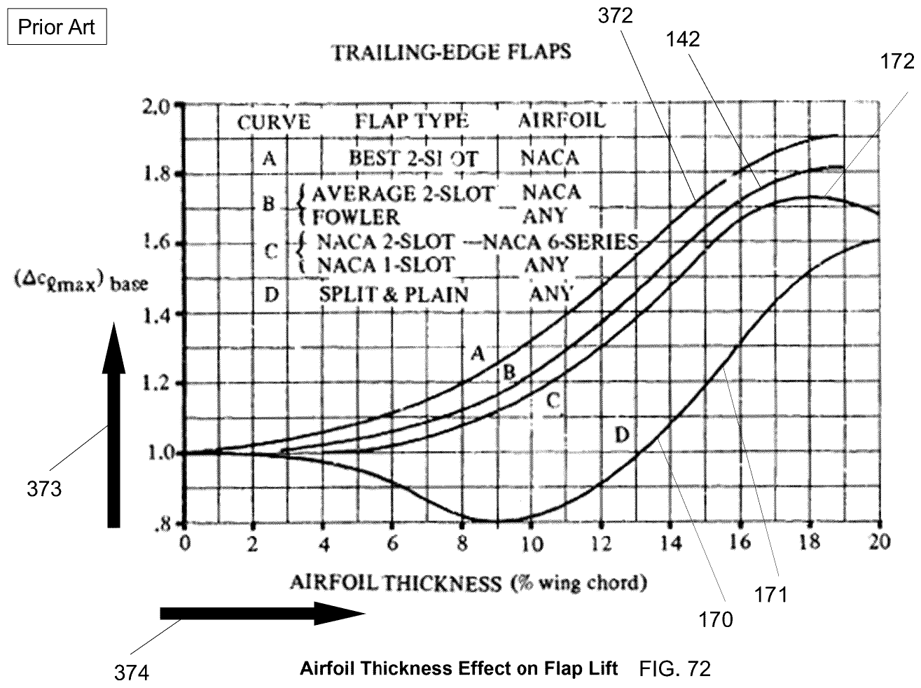

Effectiveness of airfoil thickness on the trailing edge of a flap is shown in FIG. 72 [Airfoil Thickness Effect on Flap Lift], for split flaps 170, plain flaps 171, slotted flaps 172, Fowler flaps 142, and multi-element translating flaps 372 where a Fowler flap is depicted as the most effective single element flap and implies maximum effectiveness 373 of this flap occurring at an airfoil section thickness ratio 374 of 0.19. Due to additional considerations, such as maximum attainable lift, drag, and pitching moment, the thicknesses ratio of the airfoil sections used on the K-400 is 0.15 (15%) and 0.17 (17%) on the K-650T, while the Caravan ratio averages about 0.15 (15%) over the flap portion of its wingspan. Though official data is not available, the Kodiak appears to also use about a 0.15 (15%) thickness ratio over the flap portion of its wingspan.

There are a variety of reasons most designs do not achieve the lift capabilities of the Sherpa. It is in part because the airfoil sections chosen cannot develop as high of a lift coefficient, but it is also due to the afterbody of these sections not providing adequate room for the structure required for large translating flap. Afterbody typically refers to the last 30% or 40% of the airfoil section (i.e., extending from the 60% to 100% of the airfoil section ordinate (“x” or length coordinate).

When using Fowler flaps 142, the aft wing spar reacts a large load due to the magnitude and aft offset of the air load present at the flap when fully translated. Airfoils with thinner afterbodies do not have adequate depth to house a weight efficient aft spar capable of reacting loads from a large chord, large translating flap. This restricts the size of flap chord and translation that can be used based on structural reasons. Many airplanes using plain 171, single slotted 172, and Fowler 142 flaps have trailing edge flap chord ratios that do not exceed 20% of the wing chord (cf/c). Due to the thicker afterbody of the airfoil sections used on the K-400 a 31% flap chord ratio was possible, while the even thicker afterbody of the K-650T allows the use of a 36% flap chord ratio.

The basic airfoil sections used on the K-300 (without VGs) and K-400 (without a leading edge cuff) are modified NACA 43015 sections 214 that have a maximum 2-dimensional (section) lift coefficient of about 1.6 and for the modified NASA MS(1)-0317 190 chosen for the K-650T a value of 1.78, while the Caravan uses a NACA 23000 series section with an average thickness of about 15% (NACA 23015) developing a maximum coefficient of about 1.6.

Maximum wing section lift coefficients calculated from flight data of the K-300 after vortex generators 202 were applied to the wing increased significantly to about 2.9. Coefficients based on flight data for the K-400 after a leading edge cuff 215 was applied to the wing produced a slightly increased value of 1.75 and a value of 1.83 for the modified NASA MS(1)-0317 used on the K-650T after modification, while the Caravan and Kodiak values are calculated at 1.51 and 1.52, respectively.

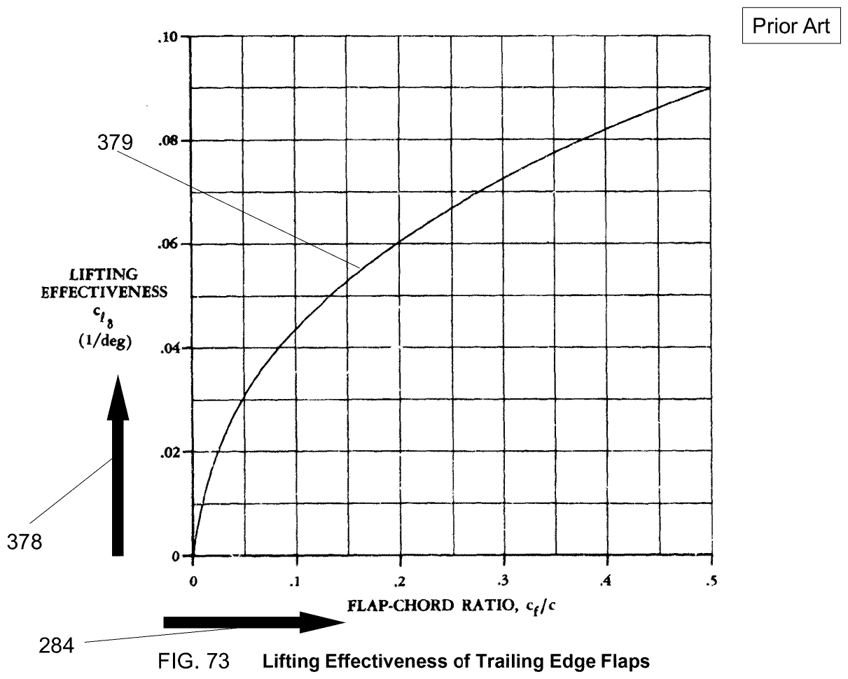

Lift effectiveness 378 with respect to the chord ratio 379 (cf/c) of a generic trailing edge flap 380 can be found in FIG. 73 [Lifting Effectiveness of Trailing Edge Flaps], inferring that the flap chord ratios between 0.30 and 0.35 are most effective. The flap chord ratio 379 (cf/c) used on the K-400 273 is 0.31, which is similar to both the Caravan 302 and Kodiak 303 ratio of 0.30 implying an effectiveness factor 378 of about 0.072 and 0.071, respectively, while the K-650T 274 uses a larger chord flap with a ratio 379 of 0.36 implying a factor of 0.078. The model K-650T is able to use the larger ratio of 0.36 due to the deeper afterbody shape of the MS(1)-0317 airfoil section 190 providing increased effectiveness over the other airplanes.

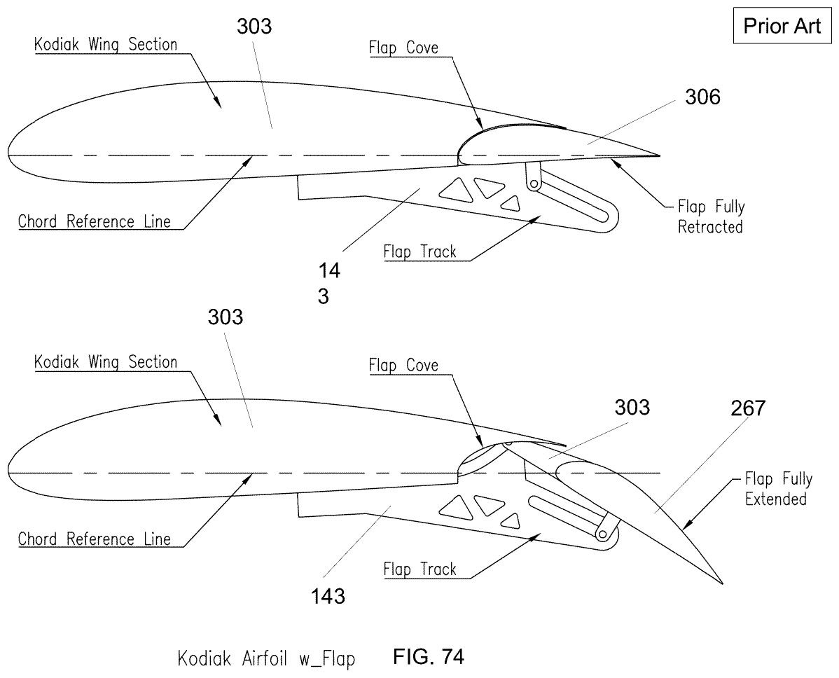

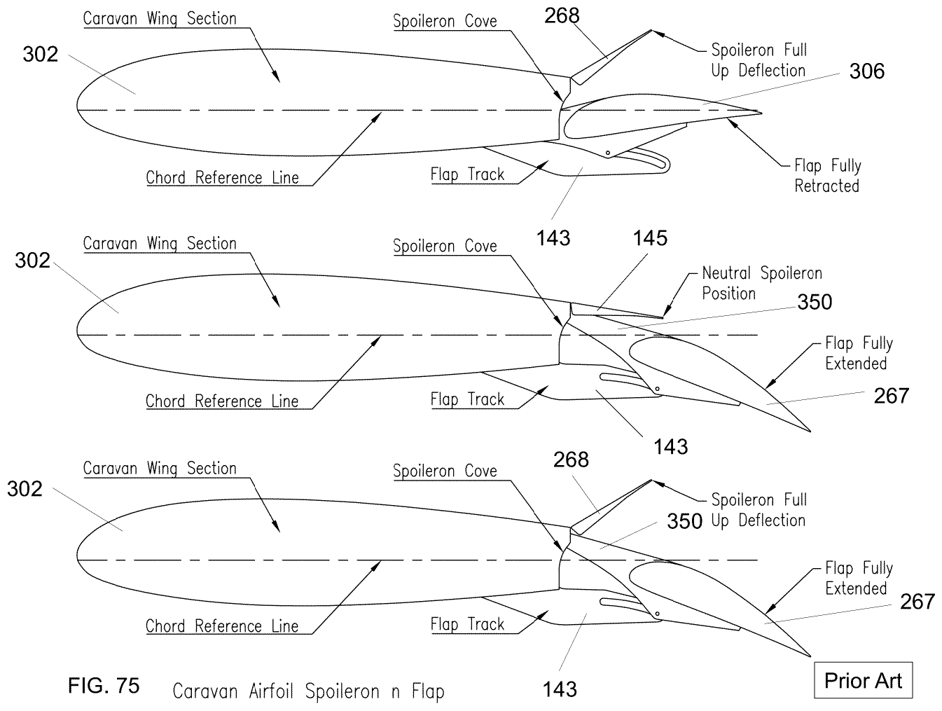

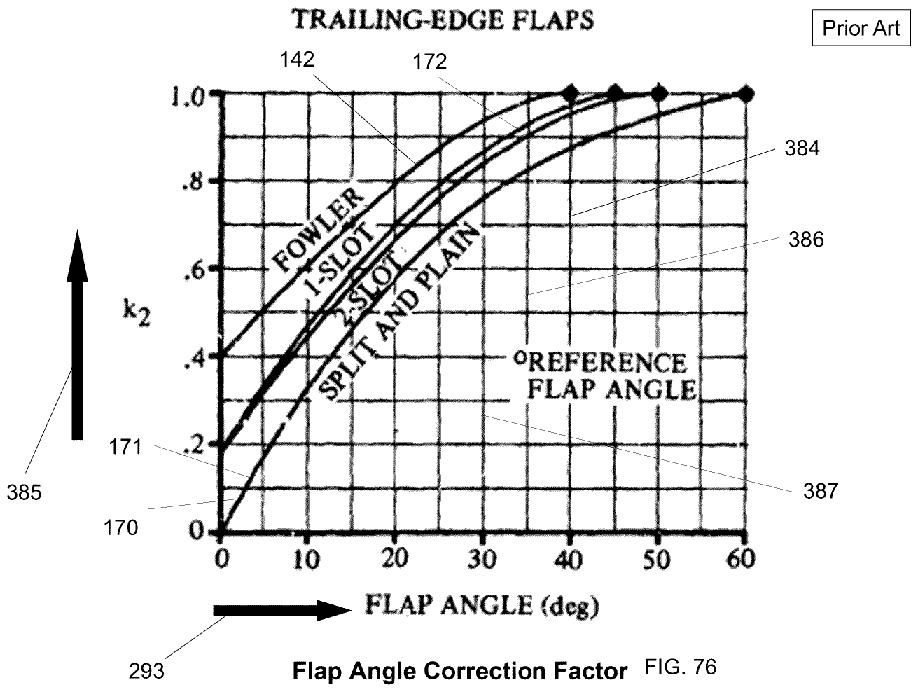

The maximum total flap deflection 293 used on all Sherpa models is 40 degrees, while the Kodiak 303 flap when fully extended 267 uses 35 degrees, FIG. 74 [Kodiak Airfoil w_Flap] and the Caravan 302 flap when fully extended 267 uses only 30 degrees, FIG. 75 [Caravan Airfoil Spoileron n Flap]. The graph shown in FIG. 76 [Flap Angle Correction Factor] implies that a deflection angle 293 of 40 degrees 384 provides the maximum lift correction factor 385 available (100%) from a Fowler flap 142, with 35 degrees 386 deflection providing 98% of the maximum value and 30 degrees 387 only 94%.

The translation action of a Fowler flap has the basic effect of increasing wing area. Conventional light airplanes that use Fowler flaps typically operate with 15% to 25% flap chord ratios 379 (cf/c) and leading edge translations 297 (c_trans/cf) of about only 30% to 40%, because larger chords and translation displacement creates geometry issues with the cams 301 of the flap track and structure. Since most light aircraft are concerned with high cruise speeds it is necessary to keep the flap tracks within the contours of the wing for drag reduction.

This restriction limits the geometry of the cam slots that the flap rollers travel on and can be illustrated using a typical smaller model Cessna flap and flap track. It can be seen in FIG. 41 [Flap Track Comparison] that the forward cam slot 301 is limited by the necessity to remain below the upper skin, while the aft cam slot cannot extend beyond the flap spar. They use different airfoil sections and it is impossible for them to achieve higher C/L with the sections they use.

The Caravan 302 has a small portion of flap track 143 exposed below the wing, whereas the Sherpa Models K-400 273 and K-650T 274 flap track 143 is mostly external to the wing where the majority of the track is exposed below the wing and, in the case of the K-400, extends beyond the trailing edge of the wing. The Kodiak 303 also has some flap track 143 exposed below its wing. In addition, the geometries of the various components in the Caravan and Kodiak flap designs prevent the possibility of translating the flap as far back as the Sherpa wing flap because the flap track slots 301 would interfere with each other.

Whereas, the modified K-400 wing airfoil section 214 is based on a five-digit series airfoil section, a number of light airplanes are based on flat bottom airfoil section (Clark Y and USA 35B) and four digit NACA series sections. The K-400 273 Fowler flap trailing edge 364 translates aftward to 122% of the wing chord distance (c′/c), while the leading edge translates aftward 90% of its total flap chord (c_tran/cf).

The K-650T 274 wing is based on a laminar flow airfoil section with a trailing edge Fowler flap 142 that translates aftward to 116% of the wing chord distance (c′/c), while the leading edge translates aftward 56% of its total flap chord (c_tran/cf).

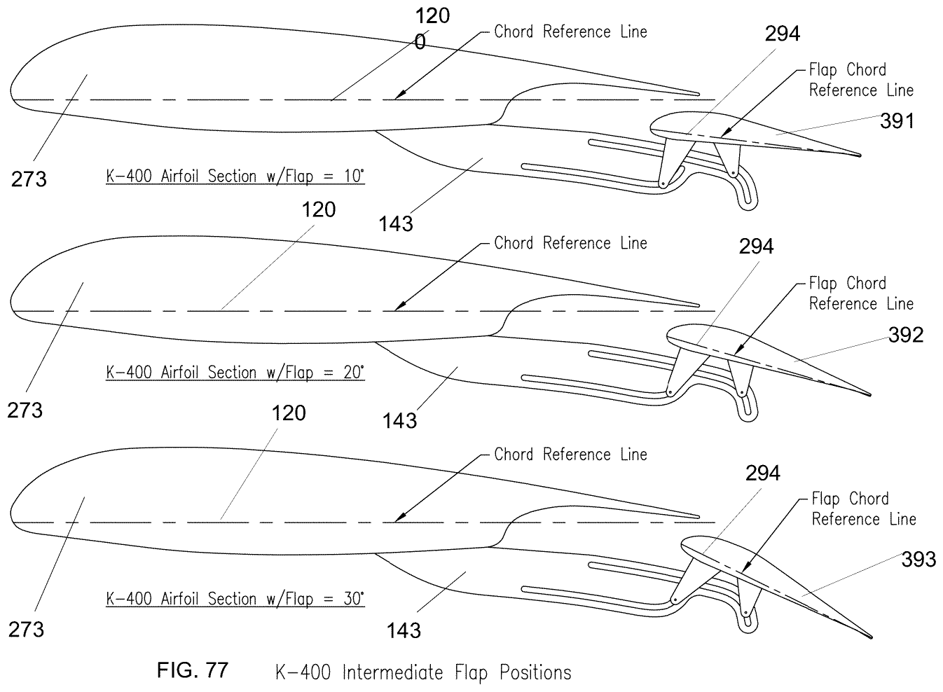

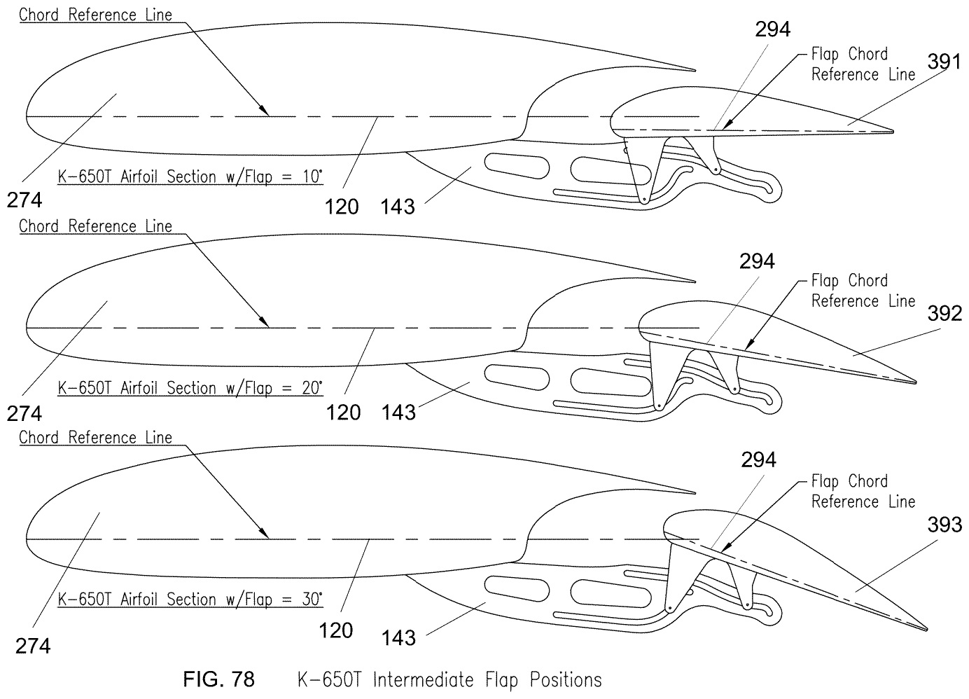

The K-400 flap translates 70% of its chord (c_tran/cf) to achieve 10 degrees of deflection 391, 77% to achieve 20 degrees of deflection 392, 83% to achieve 30 degrees of deflection 393, FIG. 77 [K-400 Intermediate Flap Positions], and 90% to achieve its 40 degrees full deflection 267, while the K-650T flap translates 30% of its chord to achieve 10 degrees of deflection 391, 40% to achieve 20 degrees of deflection 392, 48% to achieve 30 degrees of deflection 393, FIG. 78 [K-650T Intermediate Flap Positions], and 56% to achieve its 40 degrees full deflection 267. The Caravan travels about 25% to achieve 10 degrees of deflection and 35% to achieve its full deflection 267 of 30 degrees, making its deflection approximately proportional to its translation. The Kodiak is somewhat similar in its initial deflection to the Caravan in that the flap translates about 20% to achieve 10 degrees of deflection, then 48% to achieve its full deflection 267 of 35 degrees.

Sherpa models were designed with maximum lift being one of the more important aspects, though, the drag produced by the fully deflected flap is embraced and put to good use during extreme short field landing. The Caravan and Kodiak do not leverage drag in the same ways or to the same extent as a Sherpa nor are the intended operations for these airplanes the same. Typically, high drag during landing is not considered to be a desirable feature in most light airplanes in part because they do not have enough excess power available to overcome some of the adverse effects of this drag.

The present invention leverages this greater drag created by a fully deflected 267 (40 degrees) Fowler flap as a benefit to enable the pilot to more accurately control their approach to landing and prevent the airplane from floating as it enters ground effect. When the Sherpa is done flying and ready to land, it's absolutely done flying, no potential for bouncing back up into the air.

Similar airplanes with lower lift, lower drag, and less horsepower cannot be slowed down as much, nor can they fly as consistent of an approach profile, execute precision landings and touching down within less than 5 ft. to 10 ft. of either side of a target point, or land on an airstrip of only 110-foot to 150-foot. For instance, such precise landing performance is not available in the Caravan or Kodiak. The Caravan was designed to be more like other light aircraft of the Cessna line making it a smooth transition for pilots flying the different types of airplanes in their product line.

For intended operations of the Sherpa, managing high drag during landing with proper application of power is the key component enabling the Sherpa to execute extreme spot landings, i.e., the Sherpa can consistently land (touch down) within 5 ft. to 10 ft. of a target. That is because the airplane can be flown very accurately on approach to landing due to the high drag experienced when the flaps are fully extended allowing immediate contact with the ground as soon as the pilot positions the throttle to idle or reverse thrust, depending on type of powerplant.

High drag of the fully extended flaps 267 enables the Sherpa to fly a consistent profile at very low speed at a high power setting, allowing the main wheels to contact the ground consistently within a 5 to 10 foot zone, without floating or bouncing back into the air and allowing brakes to be rapidly applied. To achieve the above, the Sherpa airplane is flown in the extreme region on the back side of the power curve 158 just above the speed for point C 163, as shown in FIG. 11 [Power Curve].

This touchdown precision is very unusual for aircraft that are not VTOL (Vertical Takeoff and Landing). When flying near airplane operating empty weight (OEW), landings can be made as short as 130 ft in the K-400 and 110 ft in the K-650T. FIG. 59 [Aircraft Comparison Performance Sheet] Operating at 90% maximum landing weight the K-400 can land in 420 ft and the K-650T in 350 ft; that is 63% and 52% the distance required for landing a Caravan, respectively, or 46% and 38% the distance required by the Kodiak, respectively. Again, it is the ability of the K-650T to fly slower than the K-400 while having more power to overcome a lot of drag, the improved airfoil section, a larger wing, a thicker wing with more chord, (80 inches versus 72 inches), and a longer wingspan (47.7 ft verses 44 ft). It should be noted that the Sherpa Models were designed to takeoff in less distance than needed for landing at equivalent weights, allowing the airplane to takeoff from any field that it can land in.

The pressure exerted on a surface moving through the air is referred to as dynamic pressure and is a square function, meaning that if the speed of the object is doubled the pressure exerted on the surface is four times as great. Both lift and drag are related to dynamic pressure; therefore, if an airplane increases its speed by a factor of two (double or 2×) both the lift and drag will increase by a factor of four (quadruple or 4×). To fly at a constant speed the thrust of the airplane must equal the drag the airplane is producing.

Multiplying the thrust required by the speed (velocity) being traveled will yield the amount of power needed to maintain that speed. In short, this means that the power requirement is a cube function of speed; therefore, if an airplane increases its speed by a factor of two (2×) the power required to maintain that speed will increase by a factor of eight (8×). Other aspects must be factored in to establish the actual values, especially when operating at very low or very high speeds, though these general relationships work as a good approximation within the flight regime (envelop) of most light aircraft.

Progressing from the K-300 5-place to the K-400 8-place also entailed an increase in wing area from 252 to 264 sq. ft., widening the fuselage by 8 inches to allow side-by-side seating for the pilot and copilot (or passenger), lengthening the fuselage by about 1.5 ft, increasing the gross weight from 4750 lbs. to 5500 lbs., and initially changing from a normally aspirated engine capable of producing 400 HP at sea level to a certified experimental twin turbocharged engine provided by Lycoming Engines capable of producing 450 HP up to 16,000 ft.

After the engine manufacturer halted the certification program of this engine due to lack of orders, only one K-400 was fitted with the turbocharged engine while subsequent models would use the original normally aspirated 400 HP engine. All K-400 performance values herein are based on this 400 HP normally aspirated reciprocating engine.

The Sherpa K-400 referenced herein utilizes a 400 HP normally aspirated reciprocating engine, while the Sherpa K-650T, Kodiak, and Caravan have turbine power plants in the range of 700 to 800 shaft horsepower.

Power loading, that is the ratio of weight to horsepower (W/HP) and can be thought of as how much weight must one horsepower transport (the lower the number the better the performance), is a means by which basic performance of airplanes can be compared. One of the reasons that helps the K-400 perform well is that it has a gross weight power loading of about 12:1, while most reciprocating (normally aspirated and turbocharged) single engine airplanes have power loading's in the range between 12:1 to 15:1. The turbine powered K-650T has a gross weight power loading of 8:1, while the Kodiak loading is about 10:1 and the Caravan is 12:1. FIG. 59

### [Aircraft Comparison Performance Sheet]

Note that the K-400 with a normally aspirated reciprocating engine has a loading about equal to the turbine powered Caravan, and the turbine powered K-650T is much lower (better) than all of these. The exceptional power loading of the K-650T is one of the reasons that it can operate so well at low speed with increased drag. In addition to the exceptional power loading of the K-650T, it also benefits from the greater thrust being generated at low speed due to the slower turning, larger diameter propeller.

The excellent power loading of the Sherpa models allows takeoffs to be performed with flaps fully extended (at lower altitudes), thus the airplanes can become airborne at lower speeds thereby reducing the required takeoff distance. When flying near OEW, takeoffs can be made as short as 110 ft in the K-400 and 90 ft in the K-650T. Operating near 95% maximum takeoff weight the K-400 can become airborne in 380 ft and the K-650T in 190 ft; that is 40% and 20% of the distance required for takeoff of a Caravan, respectively, or 50% and 25% of the distance required by the Kodiak, respectively.

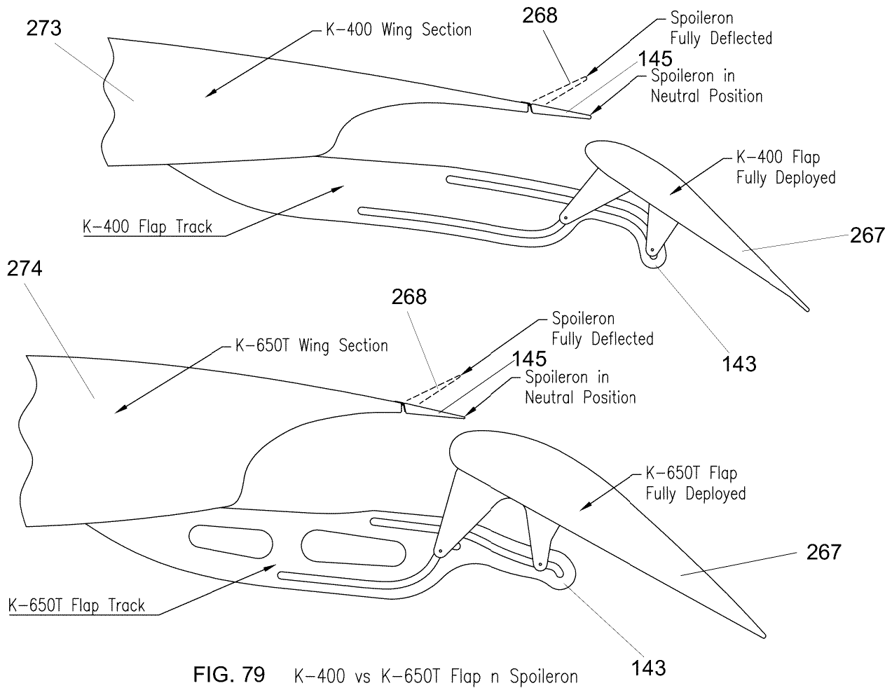

Because the Sherpa models all utilize a large span Fowler flap that translates significantly when fully extended 267, a relatively short span Frise type ailerons 272 is used in combination with a spoileron 145 located over the flap that deploys upward 268 with upward aileron deflection 265. FIG. 45 [K-400 Airfoil Spoileron n Aileron w_Extended Hap], FIG. 47 [K-650T Airfoil Spoileron n Aileron w_Extended Hap] and FIG. 79 [K-400 vs K-650T Flap n Spoileron] Though the K-650T 274 is designed for true off airport STOL performance, not many other airplanes in this class can cruise as fast.

The ratio of the cruise speed of an airplane to its lowest stall speed (for light airplanes, typically flying at operational empty weight) is a comparison useful in evaluating the performance of an airplane. Normally aspirated single engine airplanes typically see values between 2:1 and 3:1, while turbocharged single engine and slower turboprop airplanes values are around 4:1.

High speed multi-engine commuter turbo-prop airplanes can see values as high as 5:1. The data depicted in the Aircraft Comparison Data spread sheets in FIG. 59 [Aircraft Comparison Performance Sheet] show this ratio to be around 4:1 for the normally aspirated Sherpa K-400 273, turboprop Kodiak 303, and turboprop Caravan 302, while being around 6:1 for the turboprop Sherpa K-650T 274.

The gross weight of the K-300 is 4750 lbs, the K-400 was originally designed to a GW of 5,000 lbs. but was increased to 5,500 prior to flying the first proof of concept airplane, and the K-650T has a GW of 6500 lbs; a 1,750 lbs difference from the original K-300 airplane. FIG. 54 [Aircraft Comparison Weight Sheet] When operating at GW the minimum touchdown speeds are 50 mph, 68 mph, and 66 mph, respectively.

Landing in the most extreme conditions is normally performed near OEW. The OEW of the K-300 is 3,200 lbs, while the K-400 is 3,710 lbs, and the K-650T is 4,135 lbs—a 935 lbs difference from the original K-300 airplane. So, when operating in extreme conditions the minimum touchdown speeds are 32.5 mph, 40 mph, and 35 mph, respectively.

Flight test data shows that the original K-300 5-place (a slightly smaller and lighter airplane) when fitted with vortex generators on the upper surface of the wing leading edge was able to achieve a touchdown speed of 32.5 mph when flown at OEW. Even though the K-650T is the larger and heavier of the models, it can achieve a touchdown speed of 35 mph, while the K-400 touches down at 40 mph at OEW.

These touchdown speeds are significantly slower than current competitors. Even though the K-650T is heavier at OEW than the K-400 273 (4135 lbs. to 3710 lbs.), the K-650T 274 can touch down 5 mph slower (35 vs 40). This shows that the ability to fly the most weight at the lowest speed (weight/speed ratio) is greatest with the K-650T.

When at gross weight the Caravan 302 and Kodiak 303 land at around 70 mph with flaps fully extended, while the Sherpa lands around 45 at GW with flaps fully extended, or about 35% slower. In this same configuration (flaps fully extended) operating at OEW, the Caravan and Kodiak land a little faster than 50 mph, while the K-400 lands at 40 mph and the K-650T lands at 35 mph, or about 20% and 30% slower, respectively.

All Sherpa models can become airborne at speeds slightly less than their landing (touchdown) speeds due to the thrust from the propeller operating at high power creating a “Jet flap” effect on the inner portion of the Fowler flap resulting in increased lift.

The cruise speeds of the Sherpa models are well within a productive range of typical STOL airplane missions using either reciprocating or turbine powerplants. With a ratio of cruise speed to minimum landing speed being about 4:1, the K-400 with its reciprocating engine is on equal ground as the turbine powered Kodiak and Caravan. For the K-650T, having a 6:1 ratio gives it the ability to fly slower and cruise faster than its competitors.

Also, the climb rate of the K-400 273 at 1,000 feet per minute (fpm) approached that of the Caravan 302, while the K-650T 274 exceeds that of the Kodiak 303 by about 25%, being nearly 2,100 fpm. double that of most other conventional STOL airplanes. These high initial climb rates equate to spending less time during one of the most dangerous flight transitions; takeoff to cruise climb altitude.

When operating at altitude the cruising speed of the K-400 is 155 mph, respectable for a STOL airplane powered by a normally aspirated 400 HP engine; while the cruising speed of the K-650T is much higher at 210 mph due to its higher powered turbine powerplant. Cruising speeds of the turbine powered Kodiak and Caravan are 201 and 214 mph, respectively. The K-650T can cruise 6% faster than the Kodiak and only 2% slower than the Caravan.

The performance differences between the K-400 and the K-650T are mostly due to the larger wing, change of airfoil section, flap geometry used, and addition of a more powerful, turbine powerplant. There are, of course, several differences in the detailed designs of the fuselage, tail, wing, including the aileron and spoileron, all of which make the performance increases possible.

Like all STOL airplanes, the Sherpa models compromise somewhat on cruise speed to attain lower landing speeds even though that doesn't seem to be the case with the K-650T 274. Being powered by a reciprocating engine, the K-400 273 uses less horsepower than either the Kodiak 303 or the Caravan 302, which are in a similar power range as the Sherpa K-650T, and still performs exceptionally well.

The lower speeds of the Sherpa models are attained by the massive lift generated by their high lift airfoil sections combined with the incorporation of the large Fowler flap, while the immense thrust produce by their large propellers allow the leverage to use high drag to their advantage when on final approach and landing at very short fields. Neither the Kodiak nor the Caravan have this capability. Being able to land at very low speeds and, even more foundational, the enhanced low-speed handling and precise control enable the Sherpa's ability to land accurately and precisely at such low speeds.

When beginning the design of an airplane the most important items to consider are the anticipated weight, size, size of powerplant to be used, and wing geometry needed to achieve the desired mission statement. The mission statement of the Sherpa was do develop an airplane capable of operating off-airport, e.g., from extremely short and rough unimproved airstrips, carrying a significant load, cruising at reasonable speeds, and being repaired in remote locations with minimum tools. To achieve the mission statement goals required several iterations in nearly all aspects of the design. This requires a process where continual iterations need to be made as the design progresses.

The Sherpa wing is one of the most important airplane components that allow it to achieve exceptional performance. Regardless of which airfoil section is chosen, the wing planform 333 type, span (b), chord 296 (c), and area (sw) can be the difference between a good preforming airplane and one that exhibits poor performance. A basic rectangular wing was chosen due to its ease of construction, which results in easier repairability, smaller parts inventory, and preferable stall characteristics over that of a tapered wing. The K-300, K-400 273, and K-650T 274 models share many proportional similarities in the geometric design of the wings and wing components.

The wingspans were selected in part to enable operations in locations where landing strips are small, or even non-existent, and to fit in smaller sized hangars more common at small airports. The effects of wingspan on climb performance were also a consideration. A wingspan of 42.1 ft., 44.0 ft and 47.7 ft. were selected for the K-300, K-400, and K-650T, respectively. FIG. 53 [Aircraft Comparison Geometry Sheet] Parallel to considering the wing geometry the basic sizes of the fuselage as well as the horizontal and vertical tail sizes needed to be considered.

Wing chord dimensions were also a consideration when choosing the wingspans as the two are interrelated. It was necessary to size the wing chord large enough to create the appropriate wing area needed to achieve very low stall speeds without being excessive. Too large of a chord can cause increased length requirements of the fuselage in order to maintain proper pitch stability resulting in unacceptable landing strip size requirements. Wing chords 296 of 72 in. were selected for the K-300 and K-400 273, respectively, while 80 in. was used on the K-650T 274 resulting in wing areas of 254 sq. ft., 264 sq. ft., and 318 sq. ft. respectively.

Once the basic geometry of the wing has been selected it becomes time to determine the type of high-lift devices, if any, to be used in coordination with the selection of an airfoil section. Due to the visibility requirements when landing in extremely short field situations the use of leading edge devices were declined due to their need to achieve high angles of attack (reducing visibility) to produce a useful increase in lift as well as their added complexity. To achieve this objective and produce very high lift, the present invention employs a larger than normal Fowler flap that incorporates a considerable amount of translation, as specified elsewhere, herein.

A large amount of wind tunnel data was produced and publicly available regarding the use of Fowler flaps in conjunction with the NACA 23000 series airfoil sections. The selection of the modified NACA 43015 section 214 was chosen for use on the earlier Sherpa models due to its slightly higher lift capability and thicker afterbody allowing for the use of a taller spar more capably of reacting high loads developed by Fowler flaps.

Its similarity to the NACA 23000 series as well as its established use on other aircraft which gave credibility to its performance capabilities were also considered. Because the selection of a turbine powerplant for use in the K-650T 274 it was necessary to risk modification of a relatively new and unproven modified NASA MS(1)-0317 190 airfoil section. This decision proved to be a very beneficial component in providing the increased performance of this model.

With the airfoils having been selected, the details of the flap chord size, translation, and deflection needed to be selected. Due to limitations of where the aft wing spar could be located, a flap chord ratio of 0.31 (cf/c) for the K-300 and K-400 273 models, and 0.36 (cf/c) for the K-650T 274 model were implemented. It was further decided that a maximum recommended deflection of 40 degrees would be used.

Translation of the flap leading edge for the K-300 and K-400 were set to 0.90 (c_trans/cf) and 0.56 (c_trans/cf) for the K-650T. The location of the leading edge of the flap with regard to the trailing edge, and the minimum gap distance between the flap cove and the flap upper surface is very important to the ability of a Fowler flap to produce maximum lift. Flight tests showed that the initial selection of the gap size had to be refined for considerations related to spoileron deployment rather than solely maximum lift generation.

A tradeoff had to be made between the flap span ratio, i.e., required to produce the desired lift, and the aileron span ratio, i.e., needed to properly control the airplane about the roll axis. To maintain high lift and adequate roll control, the use of a spoileron over the outboard portion of the flap was incorporated into the design.

Consequently, the effective flap span ratio of the K-300 and K-400 273 was selected as 0.70 (bfe/bw), and 0.67 (bfe/bw) for the K-650T 274, while the aileron half-span ratio was selected as 0.24 (ba/(b/2)) for all models. A spoileron half-span ratios of about 0.23 (bs/(b/2)), and spoileron chord ratio of about 0.07 (cs/c), with a maximum deflection of about 38 degrees (ds), was further selected for all models.

To achieve the unique capabilities of the Sherpa models, larger chord ailerons with a shorter aileron span ratio than those used on most airplanes were employed. Once again, due to the aft spar locations the chord ratios were limited to 0.31 (ca/c) for the K-300 and K-400, while the K-650 ratio was 0.36 (ca/c). To achieve the desired roll authority, spoilerons were selected to operate in conjunction with the ailerons. Due to the increase in roll control forces due to spoileron deflection and the need to reduce the adverse yaw effect, Frise type ailerons were used.

Frise type ailerons use a displaced hinge to counter these effects. The amount of displacement ratio of the hinge behind the aileron leading edge was set to 0.21 (cb/ca) for the K-300 and K-400, while the K-650T used a ratio of 0.30 (cb/ca). Differential aileron deflections were also used to counter adverse yaw with all models using approximately 30 degrees (da_up) upward deflection and about 20 degrees downward (da_up) deflection.

Most light airplanes use a fixed horizontal stabilizer 146 in conjunction with an elevator 147 and trim tab 151 where the stabilizer is locked in a fixed position, usually optimized for cruise flight. FIG. 28 [Fixed Horz Stabilizer] Due to the large pitching moments and downwash that are produced when using a large Fowler flap with a considerable amount of translation, this type of horizontal tail would not provide an adequate balancing force. Instead, the present invention as embodied in all Sherpa models utilizes a variable incidence horizontal stabilizer 261 that pivots just forward of the elevator hinge line 259 allowing the leading edge to move up and down by the actuation of a jackscrew 260. FIG. 33 [H-Tail w_Jackscrew]

This allows the angle of the stabilizer to adjust more optimally to the relative wind when operating under high downwash conditions that occur when the Fowler flaps are at maximum translation and deflection. This arrangement also allows for higher tail balancing loads to be produced while reducing the likelihood of a dangerous tail stall.

The airplane can also be trimmed to reduce pilot loads when flying in various configurations and at various airspeeds using this type of tail. An added benefit is that when trimmed for cruise flight the horizontal tail will be operating in the most efficient position, reducing tail drag to a minimum. This type of tail design allows the lift capability of the Sherpa wing to be maximized, making the airplane much more effective during STOL operations.

The normally aspirated 400 HP reciprocating engine used on the K-300 and K-400 273 models was chosen for ease of maintenance and reduced operating cost when compared to a turbine. With the increased weight of the K-650T 274 design a larger powerplant was needed. Since there were no available reliable reciprocating engines capable of developing the HP needed for this model, a turbine engine was selected to provide the required HP. Though the operating expenses of a turbine are higher, it provides a benefit in producing twice the horsepower at about the same weight as the reciprocating engines being used. With greater horsepower came higher expenses and heavier fuel load, though the takeoff, cruise and landing performances were all improved.

At lower elevation airports the shortest takeoffs are performed with flaps fully extended, allowing the airplane to become airborne at lower speeds. The exceptional power loading available allows for operation in this configuration during takeoff with the high thrust interacting with the wing and flap similar to that of a blown (or jet) flap.

This also provides high initial climb rates to quickly transition through one of the most dangerous flight regimes. The cruise speeds of the K-300 and K-400 273 models are very respectable when compared to their slow flight capabilities. And while the K-650T 274 cruise speed is also respectable, its speed ratio to slow flight speed is exceptional.

Due to the large fuel capacity of the Sherpa models they offer respectable range and the ability to spend extensive amounts of time loitering in cruise configuration as well as when configured for slow flight. At both cruise and slow flight speeds the Sherpa exhibits good maneuverability. The large ailerons combined with the spoileron provide excellent roll authority while operating at low speed and during landing approaches.

Having ample power available allows the final phase of the landing approach to be flown very slowly and the drag being produced in this configuration allows the targeting of a very narrow (short) touchdown area. The large tires, slow touchdown speed, and good braking ability combine to make very short landings on unimproved surfaces possible.

In the preceding description, various aspects of claimed subject matter may have been described. For purposes of explanation, specific numbers, systems, or configurations may have been set forth to provide a thorough understanding of claimed subject matter. However, it should be apparent to one skilled in the art having the benefit of this disclosure that claimed subject matter may be practiced without those specific details. In other instances, features that would be understood by one of ordinary skill in the art were omitted or simplified so as not to obscure claimed subject matter.

A variety of modifications and variations are possible in light of the above teachings without departing from the scope and spirit of the invention, which is limited only by the following claims. It will be appreciated by persons skilled in the art that the present invention is not limited to what has been particularly shown and described herein.

Furthermore, those skilled in the art will recognize that boundaries between the functionality of the systems, components, operations described above are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

Thus, it is to be understood that the architectures depicted herein are merely exemplary, and that in fact many other architectures can be implemented which achieve the same functionality. In an abstract, but still definite sense, any arrangement of components designed to achieve the same functionality is effectively “associated” such that the desired functionality is achieved.

Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

In addition, the invention is not limited to physical devices or units implemented in non-programmable hardware but can also be applied in programmable devices or units able to perform the desired device functions by operating in accordance with suitable program code. Furthermore, the devices may be physically distributed over any number of apparatuses, while functionally operating as a single device.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way.

Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

The numerous and varied embodiments of the invention have been disclosed in order to enable one to understand the makings and workings of the invention. These embodiments should not however be considered the only possible embodiments of the invention or even several of a few possible embodiments of the invention as those skilled in the art will realize that many variations and modifications of the invention are possible in light of the above teachings. It is therefore to be understood that within the scope of the appended claims the invention may be practiced otherwise than as has been described.

While certain features have been illustrated or described herein, many modifications, substitutions, or equivalents may not occur to those skilled in the art. It is, therefore, to be understood that the appended claims are intended to cover all such modifications or changes as fall within the true spirit of the claimed subject matter. Thus, it will be apparent from the foregoing that, while particular forms of the invention have been illustrated and described, various modifications can be made without parting from the spirit and scope of the invention.

The claimed invention may be expressed in alternative arrangements while still maintaining the spirit of its original purpose and fundamental features. The described embodiments explain but do not limit the invention to the selected exemplary embodiments. Details concerning the invention are covered in the appended claims rather than the previous description. Additional information in the claims concerning the present invention are to be realized to the extent of their own capacity.

Various modifications and variations of the described invention will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using no more than routine experimentation, many equivalents to the specific embodiments of the invention described herein. Such equivalents are intended to be encompassed by the following claims.

What is claimed is:

1. An airplane comprising:
a fuselage, having a nose and a tail;
a wing comprising port and starboard wing sections, wherein each wing section further comprises a structure integrating aerodynamic elements, including:
a wing section body, having a top surface and a bottom surface, a leading edge and a trailing edge, and a wing section span, or a distance between a wing section tip and a wing section root connected to the fuselage body, and a flap cove;
a Fowler flap, having a leading edge and a trailing edge, as well as a span and an effective span;
flap tracks, wherein the flap tracks are external to the wing section body and extend aftward beyond the trailing edge of the wing section, and wherein the flap tracks are configured to enable the Fowler flap to rotate and deflect at an angle inclined compared to the top surface of the wing section body and to translate, or extend aftward out of the flap cove towards the tail and retract forward into the flap cove towards the nose, and wherein a flap gap or slot between the Fowler flap and the flap cove remains constant from an inboard end of the spoileron to an inboard end of the Fowler flap throughout all deployed positions;
a Frise aileron having an aileron hinge, a leading edge and a trailing edge, a span, and a mass balance, wherein the Frise aileron is located outboard of the Fowler flap; and
a spoileron, having a leading edge and a trailing edge, and a span, wherein the spoileron is located over the leading edge of the Fowler flap when the flap is in the fully extended position.

2. The airplane of claim 1, wherein a fully retracted position of the Fowler flap puts the Fowler flap into a reflexed position, inclined with a negative angle of deflection compared to the top surface of the wing section body.

3. The airplane of claim 2, wherein the negative angle of deflection for the fully retracted Fowler flap is between minus (−) 1 degree and minus (−) 15 degrees.

4. The airplane of claim 3, wherein the negative angle of deflection for the fully retracted Fowler flap is minus (−) 10 degrees.

5. The airplane of claim 1, wherein the angle of deflection for the fully retracted Fowler flap is zero degrees.

6. The airplane of claim 1, wherein the Frise aileron has a nose overhang ratio, i.e., a distance between the aileron leading edge and the aileron hinge compared to a distance between the aileron leading edge and aileron trailing edge, of at least 21%.

7. The airplane of claim 6, wherein the nose overhang ratio is at least 31%.

8. The airplane of claim 1, wherein the airplane is configured to be capable of executing a precision landing to touch down within 10 feet of a target point, over not more than 130 feet of airstrip or runway, when flown at an airplane operating empty weight.

9. The airplane of claim 8, wherein the precision landing includes the capability of touching down within 10 feet of a target point, over not more than 110 feet of airstrip or runway, when flown at the airplane operating empty weight.

10. The airplane of claim 1, having a cruise speed to lowest stall speed ratio of equal to or more than 6:1.

11. The airplane of claim 1, having a cruise speed to lowest stall speed ratio of equal to or more than 4.1:1.

12. The airplane of claim 1, wherein the tail is equipped with a variable incidence horizontal stabilizer that pivots just forward of an elevator hinge line allowing a leading edge of the elevator to move up and down by the actuation of a jackscrew.

13. The airplane of claim 12, wherein the tail is further equipped with a linked (boost) tab attached to the trailing edge of the elevator that deflects in the opposite direction of the elevator when the elevator is actuated with respect to the horizontal stabilizer.

14. The airplane of claim 1, wherein the airplane is further configured to experience an increase in angle of attack for a wing stall with flaps fully extended as compared to wing stalls with flaps fully retracted.

15. The airplane of claim 14, wherein the airplane is further configured to experience wing stall at a wing angle of attack of 17°, plus or minus one degree (1°), with the Fowler flaps fully retracted, and wherein the airplane is further configured to experience wing stall at a wing angle of attack of 19°, plus or minus one degree (10), with the Fowler flaps fully extended.

16. The airplane of claim 14, wherein the airplane is further configured to experience wing stall at a wing angle of attack of 23°, plus or minus one degree (10), with the Fowler flaps fully retracted, and wherein the airplane is further configured to experience wing stall at a wing angle of attack of 25°, plus or minus one degree (10), with the Fowler flaps fully extended.

17. The airplane of claim 1, wherein the effective span of the Fowler flap is at least 67% of the wing section span.

18. The airplane of claim 17, wherein the effective span of the Fowler flap is at least 70% of the wing section span.

19. The airplane of claim 1, wherein the wing incorporates a leading edge cuff.
